(19) United States
(12) Patent Application Publication
(10) Pub. No.: US 2026/0075232 A1
(43) Pub. Date: Mar. 12, 2026

(54) ENCODING/DECODING METHOD, CODE STREAM, ENCODER, DECODER, AND STORAGE MEDIUM

(71) Applicant: GUANGDONG OPPO MOBILE TELECOMMUNICATIONS CORP., LTD., Dongguan (CN)

(72) Inventors: Yanzhuo MA, Dongguan (CN); Junyan HUO, Dongguan (CN); Fuzheng YANG, Dongguan (CN); Hongli ZHANG, Dongguan (CN); Ming LI, Dongguan (CN)

(21) Appl. No.: 19/386,621

(22) Filed: Nov. 12, 2025

Related U.S. Application Data
(63) Continuation of application No. PCT/CN2023/095107, filed on May 18, 2023.

(51) Int. Cl. H04N 19/51; H04N 19/105; H04N 19/137; H04N 19/176

(52) U.S. Cl. CPC H04N 19/51; H04N 19/105; H04N 19/137; H04N 19/176

(57) ABSTRACT

An encoding/decoding method, a code stream, an encoder, a decoder, and a storage medium are provided. The decoding method includes that: a first template for a current block is determined, and a preset search region is determined according to the first template; a search in the preset search region is performed according to a first parameter for the current block, and a block vector of the current block is determined, the first parameter is used for controlling the searching process; and prediction values of the current block are determined according to the block vector of the current block.

### CROSS-REFERENCE TO RELATED APPLICATION

This is a continuation application of International Patent Application No. PCT/CN2023/095107, filed on May 18, 2023, the contents of which are hereby incorporated by reference in their entirety.

### BACKGROUND

In Intra Template Matching Prediction (Intra TMP) technologies, a template of a coding block is used to search for a matching template with a minimum cost relative to the template of the coding block in a predefined search range of a current picture based on a preset cost function, and a best matching reconstructed block corresponding to the matching template is used as a prediction block for a current coding block.

However, common search strategies often have a problem of high computational complexity, thereby reducing efficiency and performance of encoding and decoding.

### SUMMARY

Embodiments of the disclosure relate to the technical field of video encoding and decoding, and in particular to an encoding method, a decoding method, a bitstream, an encoder, a decoder, and a storage medium.

Technical solutions of the embodiments of the disclosure may be implemented as follows.

According to a first aspect, an embodiment of the disclosure provides a method for decoding, the method is applied to a decoder, and the method includes the following operations.

A first template for a current block is determined, and a preset search region is determined based on the first template.

A search in the preset search region is performed based on a first parameter for the current block, a block vector for the current block is determined, here the first parameter is used for controlling a process of the search.

Prediction values for the current block are determined based on the block vector for the current block.

According to a second aspect, an embodiment of the disclosure provides a method for encoding, the method is applied to an encoder, and the method includes the following operations.

A first template for a current block is determined, and a preset search region is determined based on the first template.

A search in the preset search region is performed based on a first parameter for the current block, a block vector for the current block is determined, here the first parameter is used for controlling a process of the search.

Prediction values for the current block are determined based on the block vector for the current block.

According to a third aspect, an embodiment of the disclosure provides a non-transitory computer-readable storage medium, the computer-readable storage medium has stored thereon a computer program and a bitstream. The computer program, when executed by a first processor, enables the first processor to perform the steps of the encoding method as described in second aspect to generate the bitstream.

### BRIEF DESCRIPTION OF THE DRAWINGS

FIG. 1 is a schematic diagram of prediction in Intra TMP.

FIG. 2 is a schematic diagram of a prediction process based on an Intra TMP technology.

FIG. 3 is a schematic diagram of template types in the Intra TMP technology.

FIG. 4 is a schematic diagram of a search process based on the Intra TMP technology.

FIG. 5 is a schematic diagram of definition of parameters for a current block and a template of the current block.

FIG. 6 is a schematic diagram of a search region for a template.

FIG. 7 is a first schematic diagram of partitioning of different sub-regions of a search region.

FIG. 8 is a first schematic diagram of a process of determining a search region.

FIG. 9 is a schematic diagram of a search process.

FIG. 10A is a schematic block diagram of a composition of an encoder.

FIG. 10B is a schematic block diagram of a composition of a decoder.

FIG. 11 is a schematic diagram of a network architecture of an encoding and decoding system.

FIG. 12 is a schematic flowchart of a method for decoding according to an embodiment of the disclosure.

FIG. 13 is a first schematic diagram of at least one search region.

FIG. 14 is a second schematic diagram of at least one search region.

FIG. 15 is a schematic flowchart of a method for encoding according to an embodiment of the disclosure.

FIG. 16 is a schematic diagram of a composition structure of an encoder.

FIG. 17 is a schematic diagram of a hardware structure of an encoder.

FIG. 18 is a schematic diagram of a composition structure of a decoder.

FIG. 19 is a schematic diagram of a hardware structure of a decoder.

FIG. 20 is a schematic diagram of a composition structure of an encoding and decoding system.

### DETAILED DESCRIPTION

In order to understand characteristics and technical contents of embodiments of the disclosure more thoroughly, implementations of the embodiments of the disclosure will be described in detail below in conjunction with the accompanying drawings. The accompanying drawings are only for the purpose of reference and explanation, and are not intended to limit the embodiments of the disclosure.

Unless otherwise defined, all technical and scientific terms used here have the same meanings as those commonly understood by technicians in the technical field to which the disclosure belongs. The terms used here are only for the purpose of describing the embodiments of the disclosure, and are not intended to limit the disclosure.

In the following descriptions, reference is made to “some embodiments” which describe a subset of all possible embodiments; however, it may be understood that “some embodiments” may be the same or different subsets of all possible embodiments, and may be combined with each other without conflict. It should also be pointed out that terms “first\second\third” involved in the embodiments of the disclosure are only intended to distinguish similar objects and do not represent a specific order of the objects. It may be understood that “first\second\third” may be interchanged in a specific order or priority order where permitted, such that the embodiments of the disclosure described here may be implemented in an order other than that illustrated or described herein.

Prior to further detailed description of the embodiments of the present disclosure, nouns and terms involved in the embodiments of the disclosure are described first. The nouns and terms involved in the embodiments of the disclosure are applicable to the following explanations:
Coding Block (CB);
Block Matching (BM);
Coding Unit (CU);
Block Vector (BV);
Sum of Absolute Differences (SAD);
Sum of Absolute Transformed Differences (SATD);
Mean Square Error (MSE);
Sum of Squared Differences (SSD);
Mean Absolute Deviation (MAD);
Mean Square Differences (MSD);
Normalized Correlation Coefficient (NCC);
H.266/Versatile Video Coding (VVC);
VVC Test Model (VTM);
Intra Template Matching Prediction (Intra TMP);
Enhanced Compression Model (ECM).

It may be understood that in a video picture, a coding block is usually represented by using a first colour component, a second colour component, and a third colour component. The three colour components are a luma component, a blue chroma component, and a red chroma component respectively. Specifically, the luma component is usually represented by a symbol Y, the blue chroma component is usually represented by a symbol Cb or U, and the red chroma component is usually represented by a symbol Cr or V. In this way, the video picture may be represented in a YCbCr format or a YUV format.

It may also be understood that the Intra TMP is a special intra prediction mode. Each of an encoder and a decoder uses a template (T) of a coding block to search for a matching template (T_BEST) with a minimum cost relative to the template of the coding block in a predefined search range of a current picture based on a preset cost function. An offset of a best matching template relative to a template of a current coding block is a best block vector (BV_BEST). Then, a reconstructed block (Ref Block) corresponding to the matching template is used as a prediction block for the current coding block (Cur Block). The template of the coding block usually is selected from a neighbouring reconstructed region of the current coding block.

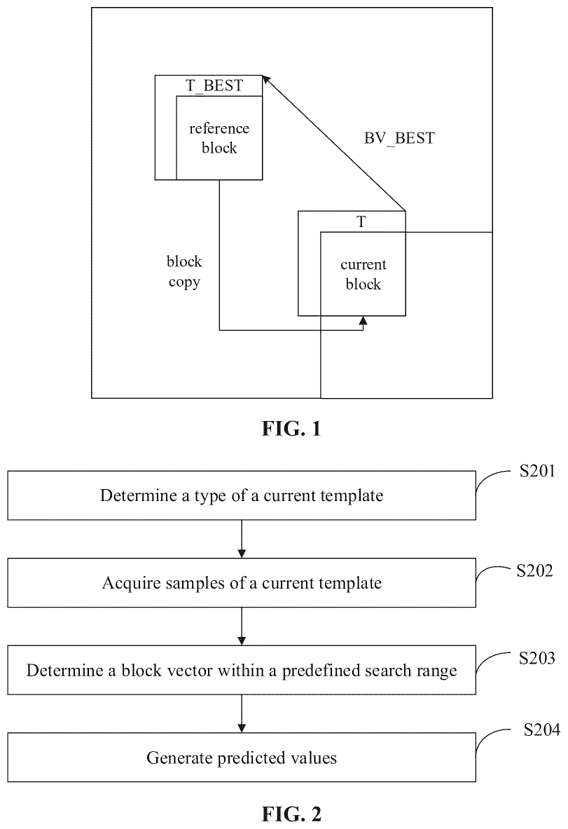

Exemplarily, taking a neighbouring reconstructed region of a current block as an example, FIG. 1 is a schematic diagram of prediction in Intra TMP. As shown in FIG. 1, a region filled with diagonal lines represents a reconstructed region, a block filled with grid lines is the current block, and a neighbouring region of the current block is a first template (T); a block filled with vertical lines is a reference block, and a neighbouring region of the reference block is a second template (that is, a best matching template T_BEST); an offset of the second template relative to the first template is a best block vector (BV_BEST), and at this time, block copy for the reference block may be block copied as a prediction block for the current block.

In the embodiments of the disclosure, the preset cost function may be SAD, SATD, MSE, SSD, MAD, MSD, NCC or the like, which is not specifically limited here.

For example, taking SAD as an example, the cost function at this time is shown as follows:

$$SAD ( {T}_{i} ) = {\sum }_{m = 0}^{M - 1} \vert {T}_{i , m} - {T}_{m} \vert , m = 0 , 1 , … , M - 1 \qquad ( 1 )$$

Here Tⱼ is a template in a search process, and M represents the number of samples in the template.

A prediction process in an Intra TMP technology in the related art will be introduced in detail below.

Inputs for the Intra TMP: a position (xTbCmp, yTbCmp) of the current block, a width nTbW of the current block, and a height nTbH of the current block.

Output of the Intra TMP: prediction values predSamples[x][y] of the current block, here x=0 . . . nTbW−1, y=0 . . . nTbH−1.

Specifically, the prediction process in the Intra TMP technology may be divided into four operations as follows: determining a type of a current template, acquiring reconstructed samples of the current template, determining a block vector within a predefined search range, and generating prediction values. In this way, prediction values for the current block may be obtained through the above process. It should be noted that the Intra TMP technology may be used for predicting a luma component or a chroma component, which is not specifically limited here.

With reference to FIG. 2, FIG. 2 is a schematic diagram of a prediction process based on an Intra TMP technology. As shown in FIG. 2, the process may include the following operations S201 to S204.

In operation S201, a type of a current template is determined.

It should be noted that in the Intra TMP technology, neighbouring reconstructed samples of the current block are used as a template to search for a matching template in a predefined search region. Here the neighbouring reconstructed samples may be top reference samples, top-left reference samples, top-right reference samples, left reference samples, and bottom-left reference samples of the current block, etc. Therefore, template types may be classified and a corresponding template type may be determined according to available based on ty of the neighbouring reconstructed samples.

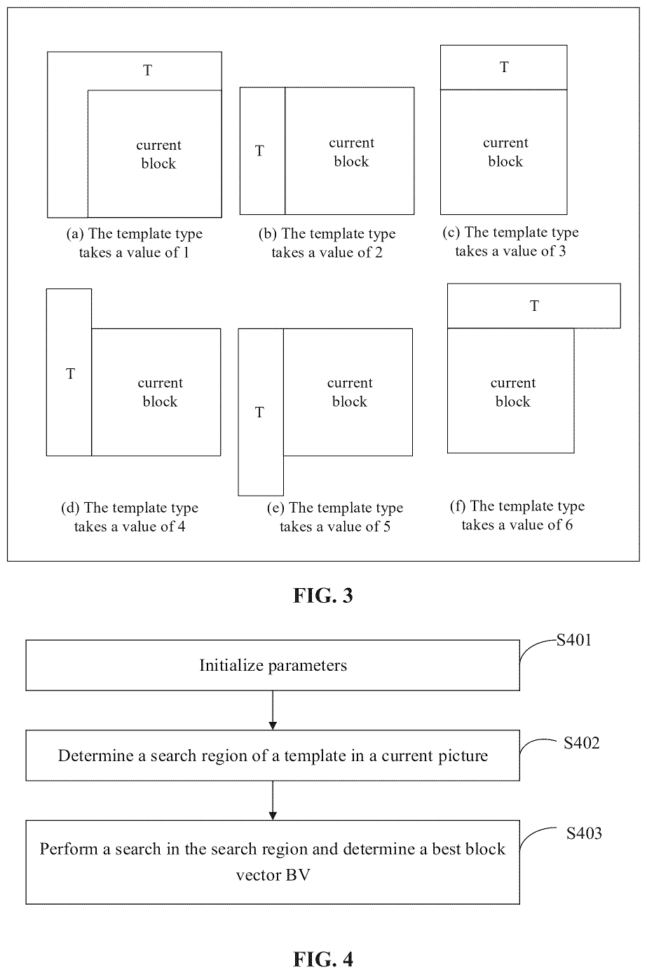

It should also be noted that the template type may be represented by refTemplateType, and FIG. 3 is a schematic diagram of template types in the Intra TMP technology. As shown in FIG. 3, a block filled with grid lines is the current block, a neighbouring region of the current block is a template T, and six template types are shown here.

Exemplarily, the six template types are shown as follows.

When the top-left reference samples, the top reference samples and the left reference samples are all available, refTemplateType has a value of 1, and the template shape is shown in (a) of FIG. 3.

When only the left reference samples are available, refTemplateType has a value of 2, and the template shape is shown in (b) of FIG. 3.

When only the top reference samples are available, refTemplateType has a value of 3, and the template shape is shown in (c) of FIG. 3.

When only the left reference samples and the top-left reference samples are available, refTemplateType has a value of 4, and the template shape is shown in (d) of FIG. 3.

When only the left reference samples and the bottom-left reference samples are available, refTemplateType has a value of 5, and the template shape is shown in (e) of FIG. 3.

When only the top reference samples and the top-right reference samples are available, refTemplateType has a value of 6, and the template shape is shown in (f) in FIG. 3.

In operation S202, samples of a current template are acquired.

It should be noted that the template in the Intra TMP technology may consist of reconstructed samples of one or more regions of the top region, top-right region, left region, bottom-left region and top-left region of the current block. Furthermore, a template size may be preset. For example, when a left template is acquired, a template width templateW_size may be set to 4; and when a top template is acquired, a template height templateH_size may be set to 4.

It should also be noted that it may determine to acquire which part of reconstructed samples based on the value of refTemplateType. Exemplarily, when refTemplateType has a value of 1, reconstructed samples at the left side, the top-left side and the top side of the current block are acquired. Alternatively, when refTemplateType has a value of 2, only reconstructed samples in left four columns of the current block are acquired. Alternatively, when refTemplateType has a value of 3, only reconstructed samples in top four rows of the current block are acquired.

In operation S203, a block vector is determined in a predefined search range.

It should be noted that the search process in the Intra TMP technology mainly includes: an initialization process, determining a search region for the template in a current picture, and searching in the search region to determine a best block vector.

It should also be noted that when searching for a best matching template in the search region, a search strategy of performing a coarse search followed by a fine search may be used, or only the fine search may be performed, or only the coarse search may be performed, which is not specifically limited here.

In the embodiments of the disclosure, the coarse search here may specifically be as follows. A best coarse matching template is determined in the search region with a first preset step size (such as 2), or the best coarse matching template is determined in the search region by using a downsampling template (such as a downsampling factor of 2).

In the embodiments of the disclosure, the fine search here may specifically be as follows. A best fine matching template is determined in the search region with a second preset step size (such as 1), or the best fine matching template is determined near the best coarse matching template after completing the coarse search.

With reference to FIG. 4, FIG. 4 is a schematic diagram of a search process based on the Intra TMP technology according to an embodiment of the disclosure. As shown in FIG. 4, the process may include the following operations S401 to S403.

In operation S401, parameters are initialized.

It should be noted that taking an L-shaped template as an example, uiPatchWidth is initialized to nTbW+templateW_size, and uiPatchHeight is initialized to nTbH+templateH_size. Here templateW_size and templateH_size may be fixed constants, or may be dynamically adjusted based on the size of the current block. Furthermore, templateW_size may be equal or unequal to templateH_size. For example, templateW_size=4, templateH_size=4; when the width of the current block is greater than 8, templateW_size=4 is set; when the width of the current block is less than or equal to 8, templateW_size=2 is set; when the height of the current block is greater than 8, templateH_size=4 is set; when the height of the current block is less than or equal to 8, templateH_size=2 is set.

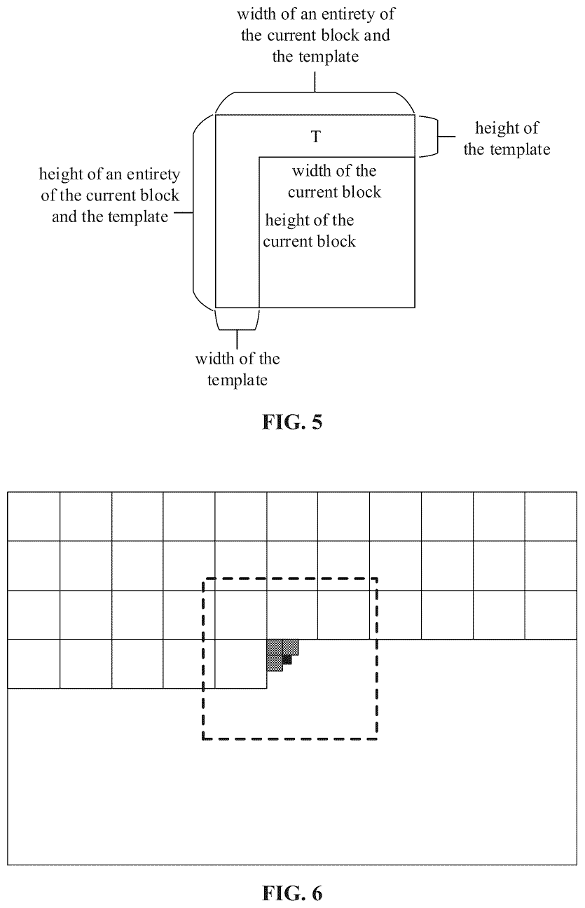

Exemplarily, FIG. 5 shows a schematic diagram of definition of parameters for a current block and a template of the current block. As shown in FIG. 5, specific meanings of the parameters are as follows: nTbW and nTbH represent a size of the current block, templateW_size and templateH_size represent a template size, and uiPatchWidth and uiPatchHeight represent a size of a block including the current block and the template of the current block.

Further, a cost threshold between templates that is represented by diffThreshold, is initialized. For example, when the cost function is SAD, the threshold may be as follows: diffThreshold=((1<<bitDepth)>>2)×(uiPatchHeight×uiPatchWidth−nTbH×nTbW). When a bit depth bitDepth of the picture is 10, diffThreshold represents that a distortion threshold of each sample point in the region of the template is 256.

Further, positions (ctbRsX and ctbRsY) of a Coding Tree Block (CTB) where the current block CB is located, are initialized.

Further, position offsets (offsetLCBY=yTbCmp−ctbRsY and offsetLCBX=xTbCmp−ctbRsX) of the current block CB in the current CTB are initialized.

Further, iTemplateSizeH=templateH_size, iTemplateSizeW=templateW_size are initialized.

Further, iBvShift is initialized, here iBvShift is a precision of the BV. For example, the precision of the BV may be an integer sample precision, and iBvShift is 0 at this time. Alternatively, the precision of the BV may be a sub-sample precision, for example, when iBvShift is 1, it represents a ½ sample precision; and when iBvShift is 2, it represents a ¼ sample precision, which is not specifically limited here.

Further, a preset search range for the template is initialized, and the preset search range for the template may be set to a fixed size, or the search range may be dynamically adjusted based on the size of the coding block. For example, searchRangeWidth=TMP_SEARCH_RANGE_MULT_FACTOR×nTbW, searchRangeHeight=TMP_SEARCH_RANGE_MULT_FACTOR×nTbH; here value of TMP_SEARCH_RANGE_MULT_FACTOR may be a preset value, for example, it is set to 5.

In operation S402, a search region for a template in a current picture is determined

It should be noted that in the Intra TMP technology, a search region is a reconstructed part of the current picture and is limited by the size of the search range. FIG. 6 is a schematic diagram of a search region for a template. As shown in FIG. 6, a background region filled with dark colour is a reconstructed region, a background block filled with black is the current block, and a dashed box is a window of the search range. Therefore, in the Intra TMP technology, the search region is not larger than an overlapping part between the reconstructed region represented by dark background and a region marked by the dashed box.

It may be seen that the search region for the template of the current block may be a reconstructed part of the CTB where the current block is located, or may be other reconstructed regions of the CTB. The search region here is actually a set of all search points. Since the shape of this region may not be often represented by a single rectangular region, during specific implementation, search may also be performed in multiple rectangular regions, and then a final best matching block and a best block vector may be obtained based on search results from different regions.

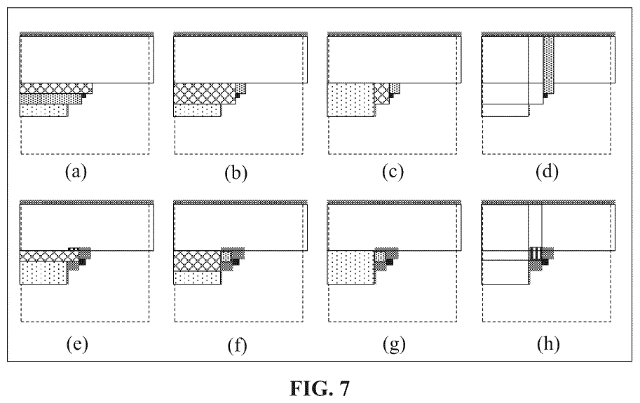

Exemplarily, with reference to FIG. 7, FIG. 7 is a schematic diagram of partitioning of different sub-regions of a search region. As shown in FIG. 7, eight different partition modes of sub-regions are shown here. A background block filled with black is the current block; all of five partition modes (a), (b), (c), (d) and (f) partition the search region into four search sub-regions, and all of three partition modes (e), (g) and (h) partition the search region into three search sub-regions, here each of different filling patterns represents a respective one of search sub-regions.

In FIG. 7, (a), (b), (c) and (d) consider all available search ranges, and (e), (f), (g) and (h) do not search a directly top region and a directly left region of the current block.

Exemplarily, assuming that different search sub-regions are distinguished and represented by regionId, considering that samples of the template of the current block need to be obtained from a reconstructed region of the picture and samples of the reconstructed block corresponding to the template also need to be obtained from the reconstructed region, then it needs to further determine positions that may be searched in search sub-regions represented by different regionId, based on the position (xTbCmp, yTbCmp) of the current block, the size (nTbW, nTbH) of the current block, the size (picWidth, picHeight) of the current picture, the size (CtbSizeW, CtbSizeH) of the CTB where the current block is located, the preset search range (searchRangeWidth, searchRangeHeight) for the template and the position offset (offsetLCBY, offsetLCBX) of the current block in the current CTB, thereby determining the block vector BV. Specifically, iVerMin and iVerMax represent an absolute coordinate position that may be searched at least in a vertical direction and an absolute coordinate position that may be searched at most in the vertical direction respectively, and iHorMin and iHorMax represent an absolute coordinate position that may be searched at least in a horizontal direction and an absolute coordinate position that may be searched at most in the horizontal direction respectively. Values of iVerMin, iVerMax, iHorMin and iHorMax are different in search regions represented by different regionId.

Taking (f) in FIG. 7 as an example, the search region is partitioned into four search sub-regions, of which implementations are as follows.

When regionId is equal to 0, iVerMin, iVerMax, iHorMin and iHorMax may be calculated as follows:

$${iHorMax}_{0} = min ( ( xTbCmp + searchRangeWidth ) << iBvShift , ( ( picWidth - nTbW ) << iBvShift ) ) ; \\ {iHorMin}_{0} = min ( ( iTemplateSizeW ) << iBvShift , ( xTbCmp - searchRangeWidth ) << iBvShift ) ) ; \\ {iVerMax}_{0} = ( yTbCmp - nTbH - offsetLCBY ) << iBvShift ; \\ {iVerMin}_{0} = max ( ( iTemplateSizeH ) << iBvShift ) ; ( ( yTbCmp - searchRangeHeight ) << iBvShift ) ) .$$

When regionId is equal to 1, iVerMin, iVerMax, iHorMin and iHorMax may be calculated as follows:

$${iHorMin}_{1} = max ( ( iTemplateSizeW ) << iBvShift , ( xTbCmp - searchRangeWidth ) << iBvShift ) ; \\ {iHorMax}_{1} = ( xTbCmp - offsetLCBX - nTbW ) << iBvShift ; \\ {iVerMin}_{1} = ( yTbCmp + 1 ) << iBvShift ; \\ {iVerMax}_{1} = min ( ( picHeight - nTbH ) << iBvShift , ( yTbCmp - offsetLCBY + CtbSizeH - nTbH ) << iBvShift ) .$$

When regionId is equal to 2, iVerMin, iVerMax, iHorMin and iHorMax may be calculated as follows:

$${iHorMax}_{2} = ( xTbCmp - offsetLCBX - nTbW ) << iBvShift ; \\ {iHorMin}_{2} = max ( ( iTemplateSizeW ) << iBvShift , ( xTbCmp - searchRangeWidth ) << iBvShift ) ; \\ {iVerMin}_{2} = max ( ( iTemplateSizeH ) << iBvShift , ( yTbCmp - nTbH - offsetLCBY ) << iBvShift ) ; \\ {iVerMax}_{2} = ( yTbCmp ) << iBvShift .$$

When regionId is equal to 3, iVerMin, iVerMax, iHorMin and iHorMax may be calculated as follows:

$${iHorMin}_{3} = max ( ( iTemplateSizeW ) << iBvShift , ( xTbCmp - offsetLCBX - nTbW + 1 ) << iBvShift ) ; \\ {iHowMax}_{3} = ( xTbCmp - nTbW ) << iBvShift ; \\ {iVerMin}_{3} = max ( ( ( iTemplateSizeH ) << iBvShift ) , ( yTbCmp - offsetLCBY - nTbH + 1 ) << iBvShift ; \\ {iVerMax}_{3} = ( yTbCmp - nTbH ) << iBvShift .$$

In an actual application, iHorMin_{regionId}, iHorMax_{regionId}, iVerMin_{regionId} and iVerMax_{regionId} here represent a left edge, a right edge, a top edge and a bottom edge of each of different search sub-regions, respectively.

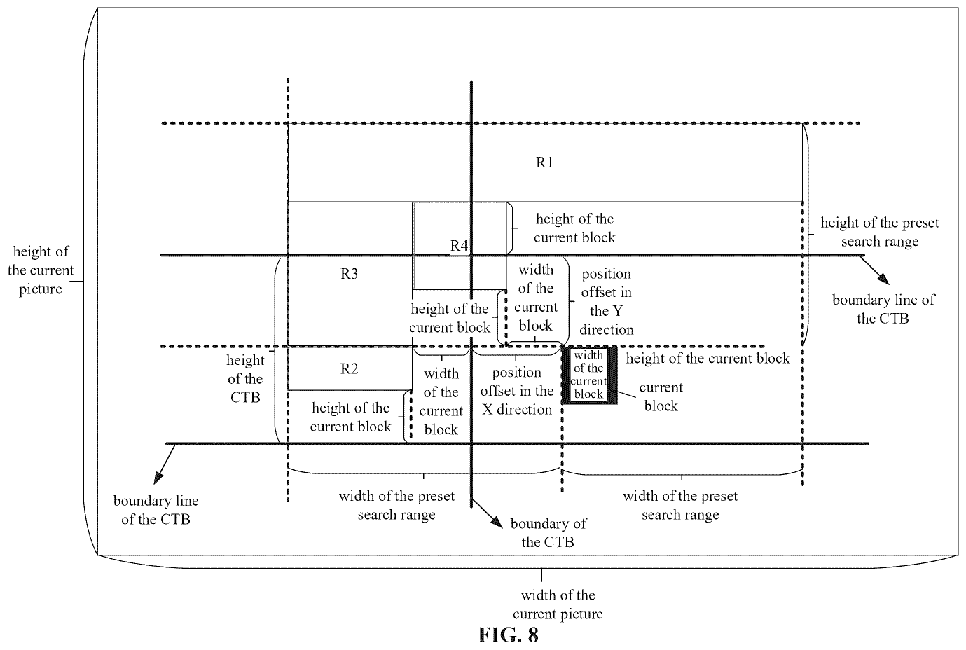

In order to intuitively describe different search sub-regions corresponding to different regionId, with reference to FIG. 8, FIG. 8 shows a schematic diagram of a specific process of determining a search region. As shown in FIG. 8, R1, R2, R3 and R4 represent four different search sub-regions. It should be noted that FIG. 8 is represented by sample ranges aligned to the top-left sample of each block.

In operation S403, search is performed in the search region to determine a best block vector BV.

It should be noted that bvXMins and bvXMaxs represent a minimum offset and a maximum offset of the block vector in the horizontal direction respectively; bvYMins and bvYMaxs represent a minimum offset and a maximum offset of the block vector in the vertical direction respectively.

bvXMins_{regionId}, bvXMaxs_{regionId}, bvYMins_{regionId} and bvYMaxs_{regionId} may be calculated by using iVerMin_{regionId}, iVerMax_{regionId}, iHorMin_{regionId} and iHorMax_{regionId} determined in the operation S402:

$${bvXMins}_{regionId} = {iHorMin}_{regionId} - xTbCmp ; \\ {bvXMaxs}_{regionId} = {iHorMax}_{regionId} - xTbCmp ; \\ {bvYMins}_{regionId} = {iVerMin}_{regionId} - yTbCmp ; \\ {bvYMaxs}_{regionId} = {iVerMax}_{regionId} - yTbCmp .$$

bvXMins_{regionId}, bvXMaxs_{regionId}, bvYMins_{regionId} and bvYMaxs_{regionId} determine a range of horizontal and vertical offsets of the search point relative to the current block, that is, a range of the block vector BV.

It should also be noted that through each search point (iPosHor, iPosVer) in each search region, that is, each block vector BV (which consists of a horizontal component and a vertical component: (pX, pY), where pX=iPosHor−xTbCmp, pY=iPosVer−yTbCmp, pX is between bvXMins and bvXMaxs, and pY is between bvYMins and bvYMaxs), a matching reconstructed block for the current block may be found in the reconstructed region, and neighbouring reconstructed samples of the matching reconstructed block are used as the matching template (that is, the second template mentioned above). Therefore, a matching cost value between a neighbouring template of the current block and a neighbouring template of the matching reconstructed block may be calculated and denoted by pDiff.

Further, all search points in all search ranges (regionId=0, 1, 2, 3) are traversed, a search point with a minimum matching cost value pDiff is obtained by comparison, a matching cost value corresponding to this search point is denoted as pDiff_BEST, a block vector BV corresponding to this search point is denoted as a best block vector BV_BEST (pX_BEST, pY_BEST), and a matching template corresponding to this search point is a best matching template T_BEST.

In a possible implementation, if the search strategy is to perform only a coarse search, specific implementation is as follows.

In each region, within a search range where pX is between bvXMins_{regionId} and bvXMaxs_{regionId} and pY is between bvYMins_{regionId} and bvYMaxs_{regionId}, the coarse search is performed with a step size greater than 1. For example, the coarse search is performed with a step size of 2, a best matching cost value obtained through template matching is recorded as pDiff_BEST, and a block vector BV corresponding to the best matching cost value is denoted as a best block vector BV_BEST (pX_BEST, pY_BEST).

In another possible implementation, if the search strategy is to perform only a fine search, specific implementation is as follows.

In each region, within a search range where pX is between bvXMins_{regionId} and bvXMaxs_{regionId} and pY is between bvYMins_{regionId} and bvYMaxs_{regionId}, for example, the fine search is performed with a step size of 1, a best matching cost value obtained through template matching is recorded as pDiff_BEST, and a block vector BV corresponding to the best matching cost value is denoted as a best block vector BV_BEST (pX_BEST, pY_BEST).

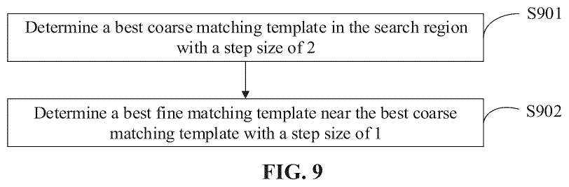

In another possible implementation, if the search strategy is to perform the coarse search followed by the fine search is performed; FIG. 9 is a schematic diagram of a search process. As shown in FIG. 9, the specific process is as follows.

In operation S901, a best coarse matching template is determined in the search region with a step size of 2.

In operation S902, a best fine matching template is determined near the best coarse matching template with a step size of 1.

It should be noted that for the operation S901, during the coarse search stage:

in each region, within a search range where pX is between bvXMins_{regionId} and bvXMaxs_{regionId} and pY is between bvYMins_{regionId} and bvYMaxs_{regionId}, the coarse search is performed with a step size greater than 1. For example, the coarse search is performed with a step size of 2, a best matching cost obtained through template matching is recorded as pDiff1_BEST, a block vector BV corresponding to the best matching cost is denoted as a best block vector BV1_BEST (pX1_BEST, pY1_BEST), and a search region where a best matching search point is located is bestRegionId.

It should also be noted that for the operation S902, during a fine search stage:

a further search is performed near the best block vector BV1_BEST obtained by the coarse search. Specifically, a refined search range TmpRefineRange is determined first, the refined search range may be in a fixed size or related to the size of the current block, for example, it may be set to min(nTbW, nTbH)/2. Then, a position of a best matching reconstructed block obtained by the coarse search is calculated as a reference position of a fine search region: BestPosX=xTbCmp+pX1_BEST, BestPosY=yTbCmp+pY1_BEST.

According to the value of bestRegionId, calculated values of iVerMinbest_{RegionId}, iVerMaxbest_{RegionId}, iHorMinbest_{RegionId} and iHorMaxbest_{RegionId} are obtained first, and then new search range defined by iVerMin_{refine}, iVerMax_{refine}, iHorMin_{refine} and iHorMax^{refine} is acquired based on the position of a best matching block obtained by the coarse search. The acquisition method is as follows:

$${iHorMin}_{refine} = max ( {iHorMin}_{bestRegionId} , BestPosX - TmpRefineRange ) ; \\ {iHorMax}_{refine} = max ( {iHorMax}_{bestRegionId} , BestPosX + TmpRefineRange ) ; \\ {iVerMin}_{refine} = max ( {iVerMin}_{bestRegionId} , BestPosY - TmpRefineRange ) ; \\ {iVerMax}_{refine} = max ( {iVerMax}_{bestRegionId} , BestPosY + TmpRefineRange ) .$$

Then, for the adjusted block vector BV, bvXMins, bvXMaxs, bvYMins and bvYMaxs may be calculated by iVerMin_{refine}, iVerMax_{refine}, iHorMin_{refine} and iHorMax_{refine} as follows:

$$bvXMins = {iHorMin}_{refine} - xTbCmp ; \\ bvXMaxs = {iHorMax}_{refine} - xTbCmp ; \\ bvYMins = {iVerMin}_{refine} - yTbCmp ; \\ bvYMaxs = {iVerMax}_{refine} - yTbCmp .$$

In this way, the fine search is performed within a block vector range where pX is between bvXMins_{refine} and bvXMaxs_{refine} and pY is between bvYMins_{refine} and bvYMaxs_{refine}. For example, the search is performed with a step size of 1, a best matching cost obtained through template matching is recorded as pDiff_BEST, a block vector BV corresponding to the best matching cost is denoted as a best block vector BV_BEST (pX_BEST, pY_BEST).

After completing the above operations, the best block vector BV_BEST (pX_BEST, pY_BEST) may be obtained, here pX_BEST and pY_BEST are offsets of the best matching template relative to the template of the current block in the horizontal direction and in the vertical direction respectively, and are also offsets of the best matching reconstructed block relative to the current block in the horizontal direction and in the vertical direction respectively.

In operation S204, prediction values are generated.

Here, generation of the prediction values may be achieved by using simple translation copy. Specific operations are as follows.

$$For x = 0 … nTbH - 1 , y = 0 … nTbH - 1 : predSamples [ x ] [ y ] = recSamples [ x + pX\_BEST ] [ y + pY\_BEST ] \qquad ( 2 )$$

Here recSamples represents reconstructed samples of the current picture.

It may be understood that in an Intra TMP mode, in addition to the above basic copying method for acquiring the prediction values, a method for acquiring the prediction values by performing filtering and fusing by using corresponding positions of multiple BVs, as well as a method for prediction by fusing with a normal Intra mode may be used.

Exemplarily, in a region search process at a decoding side, after acquiring a BV candidate list through template matching, the first N candidates (such as N=3) may be selected from the BV candidate list to perform weighted fusion. This method may be referred to as an Intra TMP Fusion mode.

Exemplarily, after acquiring a best BV, multiple points around the BV may be selected, and the weighted fusion is performed on prediction values for the multiple points, to obtain the prediction values. This method may be referred to as an Intra TMP FLM mode.

Exemplarily, after acquiring a best BV, prediction values acquired by using the BV and prediction values obtained in the normal Intra mode are weighted and combined to obtain final prediction values. The normal Intra mode may be a Planar mode or a directional mode, etc. The directional mode may be derived from Template-based Intra Mode Derivation (TIMD), or may be obtained by locating in an Intra candidate table by using an Index transmitted in a bitstream. This method may be referred to as an Intra TMP Combined Inter and Intra Prediction (CIIP) mode.

In short, according to the Intra TMP technology in the related art, a template of a current block is used to search for a matching template with a minimum cost relative to the template of the current block in a predefined search range of a current picture based on a preset cost function, and then a best matching reconstructed block (Ref Block) corresponding to the matching template is used as a prediction block for the current block (Cur Block). The template of the current block may usually be selected from a neighbouring reconstructed region of the current block.

However, during actual implementation, the search strategy needs to traverse all search points in the search region, which has high computational complexity.

In summary, common search strategies often have a problem of high computational complexity, thereby reducing the efficiency and performance of encoding and decoding.

In order to solve the above problem, the embodiments of the disclosure provide a method for encoding, a method for decoding, a bitstream, an encoder, a decoder, and a storage medium. When a prediction mode for a current block is an intra template matching-based prediction mode, both the encoder and the decoder determine a first template for the current block, and determine a preset search region based on the first template; perform a search in the preset search region based on a first parameter for the current block, and determine a block vector for the current block, here the first parameter is used for controlling a process of the search; and determine prediction values for the current block based on the block vector for the current block. It can be seen that in the embodiment of the disclosure, based on an Intra TMP mode, the search process can be controlled by using a predetermined first parameter such as a matching cost threshold, such that it may choose to terminate the search process early or continue the search process based on the first parameter. That is, according to the method for encoding and the method for decoding proposed in the embodiments of the disclosure, a problem of high computational complexity caused by traversing all search points in the search region can be solved by introducing the first parameter used for controlling the process of the search, such that the efficiency and performance of encoding and decoding can be improved.

The embodiments of the disclosure will be described in detail below with reference to the drawings.

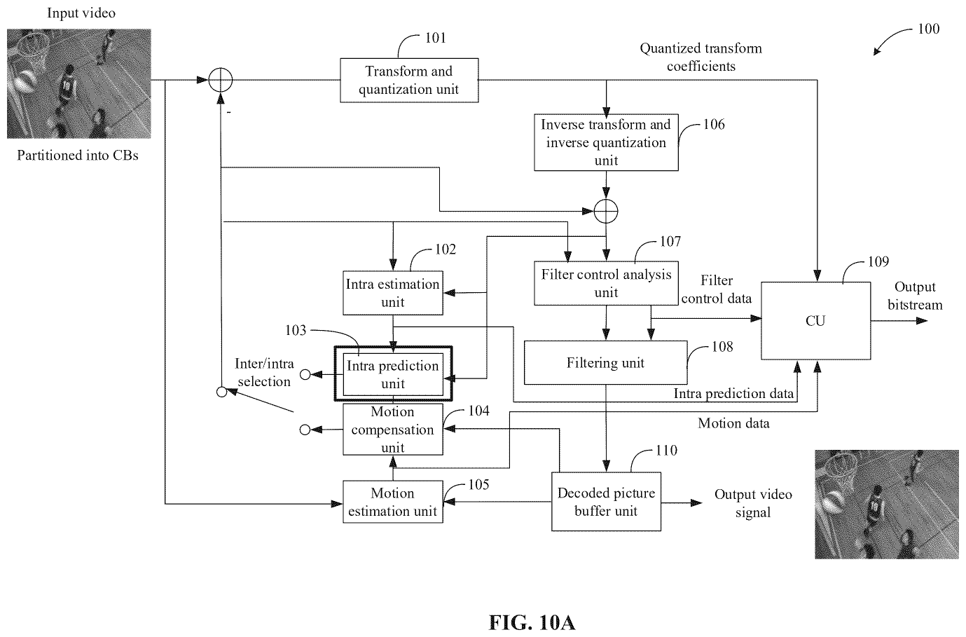

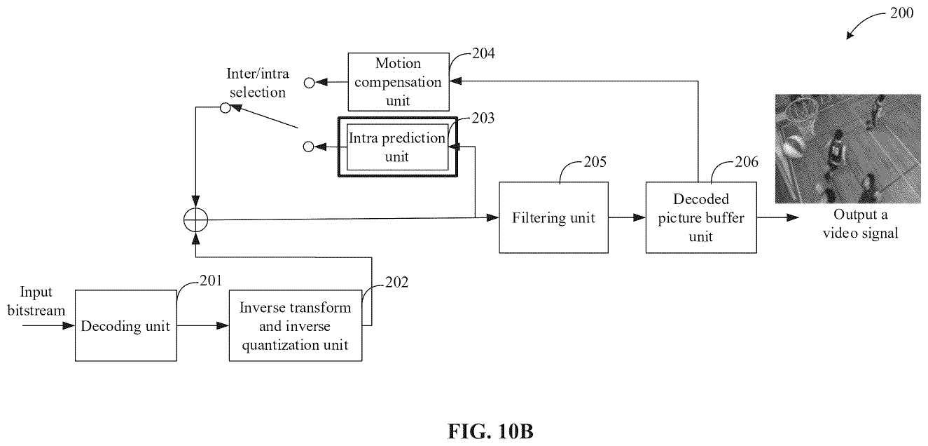

With reference to FIG. 10A, a schematic block diagram of a composition of an encoder according to an embodiment of the disclosure is shown. As shown in FIG. 10A, the encoder (specifically, a “video encoder”) 100 may include a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, a coding unit 109, and a decoded picture buffer unit 110, etc. The filtering unit 108 may implement de-blocking filtering and Sample Adaptive Offset (SAO) filtering, and the coding unit 109 may implement header information encoding and Context-based Adaptive Binary Arithmetic Coding (CABAC). For an input original video signal, a video coding block may be obtained through partition of a Coding Tree Unit (CTU), and then residual sample information obtained after intra or inter prediction is processed through the transform and quantization unit 101 to perform the transformation of the video coding block, which includes transforming the residual information from a sample domain to a transform domain, and quantizing the obtained transform coefficients, to further reduce a bit rate. The intra estimation unit 102 and the intra prediction unit 103 are configured to perform intra prediction on the video coding block. Specifically, the intra estimation unit 102 and the intra prediction unit 103 are configured to determine an intra prediction mode to be used to encode the video coding block. The motion compensation unit 104 and the motion estimation unit 105 are configured to perform inter prediction encoding of the received video coding block relative to one or more blocks in one or more reference pictures, to provide temporal prediction information. Motion estimation performed by the motion estimation unit 105 is a process of generating a Motion Vector (MV), the motion vector may be used to estimate motion of the video coding block. Then motion compensation is performed by the motion compensation unit 104 based on the motion vector determined by the motion estimation unit 105. After determining the intra prediction mode, the intra prediction unit 103 is further configured to provide the selected intra prediction data to the coding unit 109, and the motion estimation unit 105 also sends the calculated motion vector data to the coding unit 109. Furthermore, the inverse transform and inverse quantization unit 106 is configured to reconstruct the video coding block and reconstruct a residual block in the sample domain, blocking artifacts are removed from the reconstructed residual block by the filter control analysis unit 107 and the filtering unit 108, and then the reconstructed residual block is added to a prediction block in a picture of the decoded picture buffer unit 110, to generate a reconstructed video coding block. The coding unit 109 is configured to encode various encoding parameters and quantized transform coefficients. In a CABAC-based encoding algorithm, a context content may be based on neighbouring coding blocks, and may be used to encode information indicating the determined intra prediction mode and output a bitstream of the video signal. The decoded picture buffer unit 110 is configured to store the reconstructed video coding block for reference of prediction. As encoding of the video picture proceeds, new reconstructed video coding blocks may be generated continuously, and these reconstructed video coding blocks may be stored in the decoded picture buffer unit 110.

With reference to FIG. 10B, a schematic block diagram of a composition of a decoder according to an embodiment of the disclosure is shown. As shown in FIG. 10B, the decoder (specifically, a “video decoder”) 200 includes a decoding unit 201, an inverse transform and inverse quantization unit 202, an intra prediction unit 203, a motion compensation unit 204, a filtering unit 205, and a decoded picture buffer unit 206, etc. The decoding unit 201 may implement header information decoding and CABAC decoding, and the filtering unit 205 may implement de-blocking filtering and SAO filtering. After the input video signal is encoded in FIG. 10A, a bitstream of the video signal is output. The bitstream is input to the decoder 200, and passes through the decoding unit 201 first to obtain the decoded transform coefficients. The transform coefficients are processed by the inverse transform and inverse quantization unit 202, to generate a residual block in the sample domain. The intra prediction unit 203 may be configured to generate prediction data for a current video coding block based on the determined intra prediction mode and data from a previously decoded block of the current frame or picture. The motion compensation unit 204 is configured to determine prediction information for the video coding block by analyzing the motion vector and other associated syntax elements, and use the prediction information to generate a prediction block for the video coding block being decoded. A decoded video block is formed by summing the residual block from the inverse transform and inverse quantization unit 202 and the corresponding prediction block generated by the intra prediction unit 203 or the motion compensation unit 204. The decoded video signal passes through the filtering unit 205 to remove blocking artifacts therefrom, which can improve video quality. Then the decoded video block is stored in the decoded picture buffer unit 206, the decoded picture buffer unit 206 stores reference pictures used for subsequent intra prediction or motion compensation, and is also used for outputting the video signal, that is, the restored original video signal is obtained.

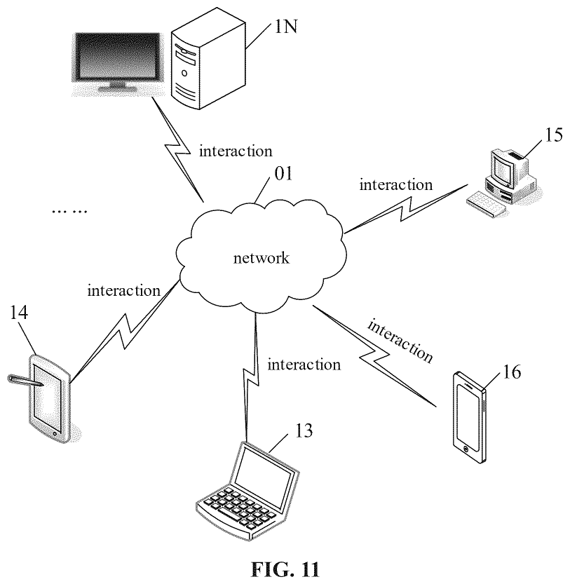

Further, an embodiment of the disclosure further provides a network architecture of an encoding and decoding system including an encoder and a decoder, here FIG. 11 shows a schematic diagram of a network architecture of an encoding and decoding system according to an embodiment of the disclosure. As shown in FIG. 11, the network architecture includes one or more electronic devices 13 to 1N and a communication network 01. Here, the electronic devices 13 to 1N may perform video interaction through the communication network 01. The electronic devices may be various types of devices with video encoding and decoding functions during implementation. For example, the electronic devices may include a smart phone, a tablet computer, a personal computer, a personal digital assistant, a navigator, a digital phone, a video phone, a television, a sensor device, a server, or the like, which is not specifically limited in the embodiments of the disclosure. Here, the decoder or the encoder described in the embodiments of the disclosure may be the above electronic devices.

It should be noted that methods of the embodiments of the disclosure are mainly applied to the intra prediction unit 103 part shown in FIG. 10A and the intra prediction unit 203 part shown in FIG. 10B. That is, the embodiments of the disclosure may be applied to the encoder, or may be applied to the decoder, or may even be applied to both the encoder and the decoder, which is not specifically limited in the embodiments of the disclosure.

It should also be noted that when the methods are applied to the intra prediction unit 103, “current block” specifically refers to a coding block for which the intra prediction is to be preformed currently; when the methods are applied to the intra prediction unit 203 part, “current block” specifically refers to a decoding block for which the intra prediction is to be performed currently.

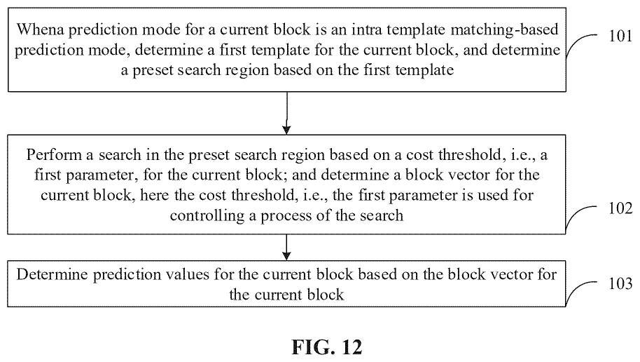

An embodiment of the disclosure proposes a method for decoding, the method for decoding is applied to a decoder. FIG. 12 is a schematic flowchart of a method for decoding according to an embodiment of the disclosure. As shown in FIG. 12, the method for the decoder to perform a decoding process may include the following operations 101 to 103.

In operation 101, when a prediction mode for a current block is an intra template matching-based prediction mode, a first template for the current block is determined, and a preset search region is determined based on the first template.

In the embodiment of the disclosure, when the prediction mode for the current block is the intra template matching-based prediction mode, the first template for the current block may be determined first. When acquiring the first template, a template type for the current block may be determined first, and then the first template for the current block may be further determined based on the template type.

It may be understood that in the embodiment of the disclosure, the intra template matching-based prediction mode may be a prediction mode using template matching, for example, the intra template matching-based prediction mode may be an Intra TMP mode.

Further, in the embodiment of the disclosure, after determining the first template for the current block, the preset search region corresponding to the current block may be further determined based on the first template.

It should be noted that the method for decoding according to the embodiment of the disclosure is applied to the decoder. Furthermore, the method for decoding may include an intra prediction method, more specifically, a method for predicting colour components. A video picture may be partitioned into multiple coding blocks, each coding block may include a first colour component, a second colour component and a third colour component. The current block in the embodiment of the disclosure refers to a coding block, for which the intra prediction is to be performed currently, in the video picture.

Here, when the first colour component needs to be predicted, a to-be-predicted component is the first colour component; when the second colour component needs to be predicted, the to-be-predicted component is the second colour component; when the third colour component needs to be predicted, the to-be-predicted component is the third colour component. Furthermore, assuming that the first colour component is predicted for the current block, and the first colour component is a luma component, that is, the to-be-predicted component is the luma component, then the current block may also be referred to as a luma block. Alternatively, assuming that the second colour component is predicted for the current block, and the second colour component is a chroma component, that is, the to-be-predicted component is the chroma component, then the current block may also be referred to as a chroma block.

It should also be noted that in the embodiment of the disclosure, reference samples of the current block may refer to reference sample points neighbouring to the current block. “neighbouring” here may be spatially neighbouring, but is not limited thereto. For example, “neighbouring” may also be temporally neighbouring or spatially and temporally neighbouring, or even the reference samples of the current block may be reference samples obtained by performing some processing on spatially neighbouring reference sample points, temporally neighbouring reference sample points, spatially and temporally neighbouring reference sample points, or the like, and the embodiment of the disclosure does not make any limitation thereto.

Further, in the embodiment of the disclosure, the template type for the current block may be determined based on indication information in a bitstream; or, the template type for the current block may be determined based on a size of the current block.

Further, in the embodiment of the disclosure, the template type for the current block may also be determined based on reference samples of the current block. The reference samples of the current block include at least one of: left neighbouring reference samples of the current block, top neighbouring reference samples of the current block, top-left neighbouring reference samples of the current block, bottom-left neighbouring reference samples of the current block, or top-right neighbouring reference samples of the current block.

It may be understood that in the embodiment of the disclosure, the reference samples of the current block may include neighbouring reconstructed samples of the current block, that is, the neighbouring reconstructed samples of the current block may be used as a template to search a matching template in a predefined search region.

It should be noted that in the embodiment of the disclosure, the reference samples of the current block (that is, the neighbouring reconstructed samples of the current block) may include top reference samples, top-left reference samples, top-right reference samples, left reference samples and bottom-left reference samples of the current block.

It may be understood that in the embodiment of the disclosure, when determining the template type for the current block by using the reference samples of the current block, the template types may be classified and determined based on availability of neighbouring reference samples.

It may be understood that in the embodiment of the disclosure, when determining the template type for the current block, the template types may also be classified and determined based on an indication in the bitstream.

Further, in the embodiment of the disclosure, when determining the template type for the current block based on the reference samples of the current block, if the left neighbouring reference samples of the current block, the top neighbouring reference samples of the current block and the top-left neighbouring reference samples of the current block are all available, it is determined that the template type for the current block is a first value; if the left neighbouring reference samples of the current block are available, it is determined that the template type for the current block is a second value; if the top neighbouring reference samples of the current block are available, it is determined that the template type for the current block is a third value; if both the left neighbouring reference samples and the top-left neighbouring reference samples of the current block are available, it is determined that the template type for the current block is a fourth value; if both the left neighbouring reference samples and the bottom-left neighbouring reference samples of the current block are available, it is determined that the template type for the current block is a fifth value; and if both the top neighbouring reference samples and the top-right neighbouring reference samples of the current block are available, it is determined that the template type for the current block is a sixth value.

It should be noted that in the embodiment of the disclosure, each of the first value, the second value, the third value, the fourth value, the fifth value and the sixth value may be any value, which is not specifically limited in the disclosure. For example, the first value, the second value, the third value, the fourth value, the fifth value and the sixth value may be sequentially set to 1, 2, 3, 4, 5 and 6.

Exemplarily, in the embodiment of the disclosure, the template type may be represented by refTemplateType. Correspondingly, as shown in the above FIG. 3, a block filled with grids is the current block, a neighbouring region of the current block is a template T, and six template types are shown here.

Exemplarily, the six template types are shown as follows: when the top-left reference samples, the top reference samples and the left reference samples are all available, refTemplateType has a value of 1, and the template shape is shown in (a) of FIG. 3; when only the left reference samples are available, refTemplateType has a value of 2, and the template shape is shown in (b) of FIG. 3; when only the top reference samples are available, refTemplateType has a value of 3, and the template shape is shown in (c) of FIG. 3; when only the left reference samples and the top-left reference samples are available, refTemplateType has a value of 4, and the template shape is shown in (d) of FIG. 3; when only the left reference samples and the bottom-left reference samples are available, refTemplateType has a value of 5, and the template shape is shown in (e) of FIG. 3; and when only the top reference samples and the top-right reference samples are available, refTemplateType has a value of 6, and the template shape is shown in (f) in FIG. 3.

In some embodiments, a template type for the Intra TMP may also be selected in combination with availability information of the above reference samples and the indication in the bitstream. For example, by assigning a sequence number to each template type, and sequence number information of an actually used template is transmitted in the bitstream, such that determination of the template type may be achieved at the decoding side.

That is, in the embodiment of the disclosure, the template type may be determined based on the availability information of the reference samples of the current block, or the template type may be determined based on the information indicated in the bitstream, or the template type may be determined based on both the availability information of the reference samples and the information indicated in the bitstream, which is not specifically limited in the disclosure.

Further, in the embodiment of the disclosure, when determining the first template for the current block based on the template type, template reference samples of the current block may be determined first based on the template type and a template size corresponding to the template type, and then the first template of the current block may be determined based on the template reference samples.

It should be noted that in the embodiment of the disclosure, the first template of the current block may include the template reference samples of the current block. The template reference samples of the current block may be determined based on the template type for the current block and the template size corresponding to the template type.

It should be noted that in the embodiment of the disclosure, the first template of the current block may consist of reconstructed samples in one or more regions of a top region, a top-right region, a left region, a bottom-left region and a top-left region of the current block, that is, the first template of the current block may consist of the reference samples of the current block.

It should be noted that in the embodiment of the disclosure, the template size corresponding to the template type may be preset, or may be indicated by using a syntax element in the bitstream, or may be adaptively selected based on a block size or other information. For example, when acquiring a left template, a template width templateW_size may be set to 4, and when acquiring a top template, a template height templateH_size may be set to 4.

Correspondingly, in the embodiment of the disclosure, it may determine to acquire which part of reconstructed samples as the template reference samples of the current block, based on the value of the template type refTemplateType of the current block and the template size corresponding to refTemplateType, and then the corresponding first template may be determined.

Exemplarily, in the embodiment of the disclosure, when refTemplateType has a value of 1, reconstructed samples at the left side, the top-left side and the top side of the current block may be acquired; when refTemplateType has a value of 2, only reconstructed samples on left four columns of the current block are acquired; and when refTemplateType has a value of 3, only reconstructed samples on top four rows of the current coding block are acquired.

Of course, a preset value of the template size may be any integer greater than 0 and is not limited to 4, which is not specifically limited in the disclosure.

It may be understood that in the embodiment of the disclosure, the template reference samples of the current block determined from the reference samples of the current block based on the template type for the current block and the corresponding template size, may be used as the first template for the current block.

It should be noted that in the embodiment of the disclosure, a search process of the block vector may include the following parts: an initialization process, a process of determining a search region (a preset search region) for the first template in a current picture, and a process of searching in the search region to determine one or more best block vectors. Therefore, initialization operations need to be completed before performing search process.

Exemplarily, as shown in the above FIG. 5, nTbW and nTbH represent a size of the current block, templateW_size and templateH_size represent a template size, and uiPatchWidth and uiPatchHeight represent a size of a block including the current block and the template of the current block.

Correspondingly, during initialization, uiPatchWidth may be initialized to nTbW+templateW_size, and uiPatchHeight may be initialized to nTbH+templateH_size. Here templateW_size and templateH_size may be fixed constants, or may be indicated by using syntax elements in the bitstream, or may be dynamically adjusted based on the size of the coding block or other information. templateW_size may be equal or unequal to templateH_size. For example, templateW_size=4, templateH_size=4; when the width of the coding block is greater than 8, templateW_size=4 is set; when the width of the coding block is less than or equal to 8, templateW_size=2 is set; when the height of the coding block is greater than 8, templateH_size=4 is set; when the height of the coding block is less than or equal to 8, templateH_size=2 is set.

Further, a cost threshold between templates that is represented by diffThreshold, is initialized. For example, when the cost function is SAD, the threshold may be as follows: diffThreshold=((1<<bitDepth)>>2)×(uiPatchHeight×uiPatchWidth−nTbH×nTbW). When a bit depth bitDepth of the picture is 10, diffThreshold represents that a distortion threshold of each sample point in the region of the template is 256.

Further, positions (ctbRsX, ctbRsY) of a CTB where the current block CB is located, are initialized.

Further, position offsets (offsetLCBY=yTbCmp−ctbRsY, offsetLCBX=xTbCmp−ctbRsX) of the current block coding block in the current CTB are initialized.

Further, iTemplateSizeH=templateH_size, iTemplateSizeW=templateW_size are initialized.

Further, iBvShift is initialized, here iBvShift is a precision of the BV. For example, the precision of the BV may be an integer sample precision, and iBvShift is 0 at this time. Alternatively, the precision of the BV may be a sub-sample precision, for example, when iBvShift is 1, it represents a ½ sample precision; and when iBvShift is 2, it represents a ¼ sample precision, which is not specifically limited here.

Further, a preset search range for the template is initialized, and the preset search range for the template may be set to a fixed size, or the search range may be dynamically adjusted based on the size of the coding block. For example, searchRangeWidth=TMP_SEARCH_RANGE_MULT_FACTOR×nTbW, searchRangeHeight=TMP_SEARCH_RANGE_MULT_FACTOR×nTbH; here value of TMP_SEARCH_RANGE_MULT_FACTOR may be a preset value, or may be indicated by using a syntax element in the bitstream, or may be adaptively adjusted based on the size of the coding block or other information, for example, it is set to 5.

It should be noted that in the embodiment of the disclosure, the preset search region is a reconstructed part in the current picture and is limited by the size of the search range. As shown in the above FIG. 6, a background region filled with dark colour is a reconstructed region, a background block filled with black is the current block, and a dashed box is a window of the search range. Therefore, in the Intra TMP technology, the preset search region is not larger than an overlapping part between the reconstructed region represented by dark background and a region marked by the dashed box.

It may be seen that the preset search region for the template of the current block may be a reconstructed part of the CTB where the current block is located, or may be other reconstructed regions in the CTB. The preset search region here is actually a set of all search points. Since the shape of this region may not be often represented by a single rectangular region, therefore during specific implementation, search may also be performed in multiple rectangular regions, and then a final best matching block and a best block vector may be obtained based on search results from different regions.

Exemplarily, with reference to the above FIG. 7, eight different partition modes of sub-regions are shown here. A background block filled with black is the current block; all of five partition modes (a), (b), (c), (d) and (f) partition the preset search region into four search sub-regions, and all of three partition modes (e), (g) and (h) partition the preset search region into three search sub-regions, here each of different filling patterns represents a respective one of search sub-regions.

In FIG. 7, (a), (b), (c) and (d) consider all available search ranges, and (e), (f), (g) and (h) do not search a directly top region and a directly left region.

Exemplarily, assuming that different search sub-regions are distinguished and represented by regionId, considering that samples of the template of the current block need to be obtained from a reconstructed region of the picture and samples of the reconstructed block corresponding to the template also need to be obtained from the reconstructed region, then it needs to further determine positions that may be searched in search sub-regions represented by different regionId, based on the position (xTbCmp, yTbCmp) of the current block, the size (nTbW, nTbH) of the current block, the size (picWidth, picHeight) of the current picture, the size (CtbSizeW, CtbSizeH) of the CTB where the current block is located, the preset search range (searchRangeWidth, searchRangeHeight) for the template and the position offset (offsetLCBY, offsetLCBX) of the current block in the current CTB, thereby determining the block vector BV. Specifically, iVerMin and iVerMax represent an absolute coordinate position that may be searched at least in a vertical direction and an absolute coordinate position that may be searched at most in the vertical direction respectively, and iHorMin and iHorMax represent an absolute coordinate position that may be searched at least in a horizontal direction and an absolute coordinate position that may be searched at most in the horizontal direction respectively. Values of iVerMin, iVerMax, iHorMin and iHorMax are different in search regions represented by different regionId.

In some embodiments, taking (f) in FIG. 7 as an example, the preset search region is partitioned into four search sub-regions, of which implementations are as follows.

When regionId is equal to 0, iVerMin, iVerMax, iHorMin and iHorMax may be calculated as follows:

$${iHorMax}_{0} = min ( ( xTbCmp + searchRangeWidth ) << iBvShift , ( ( picWidth - nTbW ) << iBvShift ) ) ; \\ {iHorMin}_{0} = max ( ( iTemplateSizeW ) << iBvShift , ( xTbCmp - searchRangeWidth ) << iBvShift ) ) ; \\ {iVerMax}_{0} = ( yTbCmp - nTbH - offsetLCBY ) << iBvShift ; \\ {iVerMin}_{0} = max ( ( ( iTemplateSizeH ) << iBvShift ) , ( ( yTbCmp - searchRangeHeight ) << iBvShift ) ) .$$

When regionId is equal to 1, iVerMin, iVerMax, iHorMin and iHorMax may be calculated as follows:

$${iHorMin}_{1} = max ( ( iTemplateSizeW ) << iBvShift , ( xTbCmp - searchRangeWidth ) << iBvShift ) ; \\ {iHorMax}_{1} = ( xTbCmp - offsetLCBX - nTbW ) << iBvShift ; \\ {iVerMin}_{1} = ( yTbCmp + 1 ) << iBvShift ; \\ {iVerMax}_{1} = min ( ( picHeight - nTbH ) << iBvShift , ( yTbCmp - offsetLCBY + CtbSizeH - nTbH ) << iBvShift ) .$$

When regionId is equal to 2, iVerMin, iVerMax, iHorMin and iHorMax may be calculated as follows:

$${iHorMin}_{3} = max ( ( iTemplateSizeW ) << iBvShift , ( xTbCmp - offsetLCBX - nTbW + 1 ) << iBvShift ) ; \\ {iHowMax}_{3} = ( xTbCmp - nTbW ) << iBvShift ; \\ {iVerMin}_{3} = max ( ( ( iTemplateSizeH ) << iBvShift ) , ( yTbCmp - offsetLCBY - nTbH + 1 ) << iBvShift ; \\ {iVerMax}_{3} = ( yTbCmp - nTbH ) << iBvShift .$$

When regionId is equal to 3, iVerMin, iVerMax, iHorMin and iHorMax may be calculated as follows:

$${iHorMin}_{3} = max ( ( iTemplateSizeW ) << iBvShift , ( xTbCmp - offsetLCBX - nTbW + 1 ) << iBvShift ) ; \\ {iHorMax}_{3} = ( xTbCmp - nTbW ) << iBvShift ; \\ {iVerMin}_{3} = max ( ( iTemplateSizeH ) << iBvShift ) , ( yTbCmp - offsetLCBY - nTbH + 1 ) << iBvShift ) ; \\ {iVerMax}_{3} = ( yTbCmp - nTbH ) << iBvShift .$$

It may be understood that in an actual application, iHorMin_{regionId}, iHorMax_{regionId}, iVerMin_{regionId} and iVerMax_{regionId} here represent a left edge, a right edge, a top edge and a bottom edge of each of different search sub-regions respectively.

In order to intuitively describe different search sub-regions corresponding to different regionId, with reference to FIG. 8, a schematic diagram of a process of determining a preset search region is shown here. As shown in FIG. 8, R1, R2, R3 and R4 represent four different search sub-regions. It should be noted that FIG. 8 is represented by sample ranges aligned to the top-left sample of each block.

It may be understood that in some embodiments, the preset search region may also be classified into two types, one type of search region is a region (referred to as a fully reconstructed search region) where it is sure that all sampling points in the region have been reconstructed; another type of search region is a region (referred to as an undetermined reconstructed search region) where it is not sure whether all sampling points in the region have been reconstructed, which is not specifically limited in the disclosure.

In operation 102, search is performed in the preset search region based on a first parameter for the current block, a block vector for the current block is determined, here the first parameter is used for controlling a process of the search.

In the embodiment of the disclosure, after determining the preset search region based on the first template, search may be further performed in the preset search region based on the first parameter for the current block, and the block vector for the current block is determined. The first parameter is used for controlling the search process.

It should be noted that in the embodiment of the disclosure, the first parameter may be used for controlling the search process. For example, it may choose to continue the search process or terminate the search process early, based on the first parameter.

Exemplarily, in the embodiment of the disclosure, the first parameter may be a matching cost threshold corresponding to a matching cost value. Correspondingly, when controlling the search process based on the first parameter, if the matching cost value and the first parameter (the matching cost threshold) meet a search termination condition, it may choose to terminate the search process early; otherwise, it may continue the search process.

It may be understood that in the embodiment of the disclosure, if the first parameter is the matching cost threshold corresponding to the matching cost value, the first parameter may be understood as a cost upper-limit threshold. Therefore, a corresponding search termination condition may be a magnitude relationship between the matching cost value and the first parameter.

Exemplarily, in the embodiment of the disclosure, if the matching cost value is less than or equal to the first parameter, it may be considered that the search termination condition is met, and then the search process may be terminated early; if the matching cost value is greater than the first parameter, it may be considered that the search termination condition is not met, and then the search process may continue.

It may be seen that in the embodiment of the disclosure, when the search is performed based on the first parameter, if a search point whose a matching cost value is less than or equal to the first parameter is obtained through the search, it may choose to terminate the search, thereby achieving the control for the search process.

That is, in the embodiment of the disclosure, since calculations of matching costs for all search points in the preset search region may greatly increase complexity, in order to balance the complexity while ensure encoding efficiency, the search process may be controlled by using a template matching cost threshold (i.e., the first parameter SADₜₕᵣₑ) corresponding to the current block, to terminate the search early.

Further, in the embodiment of the disclosure, the first parameter is used to impose a constraint on matching costs between different templates based on a preset matching criterion.

It should be noted that in the embodiment of the disclosure, the preset matching criterion includes any one of SAD, SATD, Sum of Squared Errors (SSE), MAD, Mean Absolute Error (MAE), MSE, or NCC.

Exemplarily, in some embodiments, when the preset matching criterion is SSE, MSE or SATD, the first parameter used for jumping out from the search early is also set to SSEthre, MSEthre or SATDthre correspondingly.

That is, in the disclosure, the first parameter corresponds to the preset matching criterion.

Further, in the embodiment of the disclosure, the preset matching criterion may further include a first matching criterion and a second matching criterion. The first matching criterion includes any one of SAD, SATD, SSE, MAD, MAE, MSE, or NCC. The second matching criterion includes any one of a vector length of the block vector, a sum of component lengths of the block vector, or a block vector cost parameter.

It may be understood that in the embodiment of the disclosure, the first matching criterion may be understood as including a cost function related to sample differences, and the second matching criterion may be understood as including a cost function related to a size of the BV.

It should be noted that in the embodiment of the disclosure, by combining to use the first matching criterion and the second matching criterion, it needs to refer to both the cost function related to the sample differences and the cost function related to the size of the BV in the process of determining the block vector for the current block. That is, a cost function related to both the sample differences and the size of the BV may be used.

It may be understood that in the embodiment of the disclosure, the block vector cost parameter included in the second matching criterion may be understood as a cost parameter related to the block vector.

Exemplarily, in some embodiments, the block vector cost parameter may include, but is not limited to any one of the following forms: multiplying the vector length of the block vector by a coefficient λ, or multiplying the sum of component lengths of the block vector by a coefficient λ.

It should be noted that in the embodiment of the disclosure, for the preset matching criterion including the first matching criterion and the second matching criterion, in the process of searching the block vector for the current block, a matching cost value determined for any search point may further include two parts correspondingly: a cost value corresponding to the first matching criterion and related to the sample differences, and a cost value corresponding to the second matching criterion and related to the size of the BV.

Exemplarily, in some embodiments, assuming that the cost value corresponding to the first matching criterion and related to the sample differences is represented by cost_{Dpel}, and the cost value corresponding to the second matching criterion and related to the size of the BV is represented by cost_{BV}, then a corresponding matching cost value (represent by cost) determined for a search point in the preset search region may be represented by: cost=cost_{BV}+cost_{Dpel}.

Here cost_{BV} is a quantity related to the size of the BV, such as the vector length of the BV, or the sum of component lengths of the BV, or a product of multiplying the vector length of the BV by a coefficient λ, or a product of multiplying the sum of component lengths of the BV by a coefficient λ; or, a relationship between the size of the BV and cost_{BV} is defined by using a table; or, different regions are defined, and there are different cost_{BV} in different regions, etc. For example, a diamond or square multi-layer region with a certain-value BV (such as a zero-value BV) as a center is defined, and a fixed cost_{BV} value is set for each region.

Exemplarily, in some embodiments, assuming that the cost value corresponding to the first matching criterion and related to the sample differences is represented by cost_{Dpel}, and the cost value corresponding to the second matching criterion and related to the size of the BV is represented by costFactor_{BV}, then a corresponding matching cost value (represented by cost) determined for a search point in the preset search region may be represented by: cost=cost_{Dpel}×costFactor_{BV}.

Here costFactor_{BV} is a quantity related to the size of the block vector, such as a product of multiplying the vector length of the BV by a coefficient λ, or a product of multiplying the sum of component lengths of the BV by a coefficient λ; or, a relationship between the size of the BV and costFactor_{BV} is defined by using a table; or, different regions are defined, and there are different costFactor_{BV} in different regions, etc. For example, a diamond or square multi-layer region with a certain-value BV (such as a zero-value BV) as a center is defined, and a fixed costFactor_{BV} value is set for each region.

Further, in the embodiment of the disclosure, an example that the preset matching criterion is SAD is taken, the first parameter SADₜₕᵣₑ corresponding to the current block may be determined first.

It should be noted that in the embodiment of the disclosure, the first parameter may be determined based on a bit depth information of a current picture and a sample parameter for the first template.

It may be understood that in the embodiment of the disclosure, when jumping out the search process early by using a first parameter SADₜₕᵣₑ, the first parameter SADₜₕᵣₑ may be determined based on the bit depth information of the current picture, here the first parameter determined based on the bit depth information of the current picture may be a predefined fixed threshold.

Exemplarily, in some embodiments, the first parameter SADₜₕᵣₑ=((1<bitDepth)>>3)×Num_{Temp} may be defined. Here bitDepth is the bit depth of the picture, that is, the bit depth information of the current picture, and Num_{Temp} is the number of samples of the reference template, that is, the sample parameter of the first template for the current block.

It should be noted that in the embodiment of the disclosure, if prediction modes for neighbouring reconstructed blocks corresponding to the current block are the intra template matching-based prediction mode, the first parameter may be determined based on the neighbouring reconstructed blocks.

It may be understood that in the embodiment of the disclosure, if the prediction modes of the neighbouring reconstructed blocks corresponding to the current block are the intra template matching-based prediction mode, when determining the first parameter based on the neighbouring reconstructed blocks, a first threshold may be determined first based on matching cost values corresponding to block vectors for the neighbouring reconstructed blocks and sample parameters of reference templates for the neighbouring reconstructed blocks; at the same time, a second threshold may be determined based on a sample parameter for the first template and a maximum average sample value difference between the current block and the neighbouring reconstructed blocks; and finally, the first parameter may be determined based on the first threshold and the second threshold.

It should be noted that in the embodiment of the disclosure, when the first parameter is determined based on the first threshold and the second threshold, if the first threshold is less than or equal to the second threshold, the first threshold is determined as the first parameter; and if the first threshold is greater than the second threshold, the second threshold is determined as the first parameter.

It may be understood that in the embodiment of the disclosure, when jumping out the search process early by using a first parameter SADₜₕᵣₑ, the first parameter SADₜₕᵣₑ may also be determined based on a best template matching cost of neighbouring Intra TMP coding blocks of the current block, here the first parameter determined based on the matching cost values corresponding to the neighbouring reconstructed blocks of the current block whose prediction modes are the intra template matching-based prediction mode, may be an adaptive threshold.

Exemplarily, in some embodiments, assuming that the Intra TMP is selected for a top neighbouring block of the current block as a coding mode for the top neighbouring block, that is, a prediction mode of the neighbouring reconstructed block at the top side of the current block is the intra template matching-based prediction mode, a block vector (a best block vector) for the neighbouring reconstructed block is BV_{neighbor}, a matching cost value (a best matching cost) corresponding to the block vector is Diff_{neighbor}, a sample parameter (the number of samples of the reference template of the neighbouring block) of a reference template corresponding to the neighbouring reconstructed block is Num_{TempNei}, and the sample parameter (the number of samples of the reference template) of the first template for the current block is Num_{Temp}, then the first threshold determined based on the matching cost value Diff_{neighbor} corresponding to the block vector for the neighbouring reconstructed block and the sample parameter Num_{TempNei} of the reference template corresponding to the neighbouring reconstructed block may be represented by Diff_{neighbor}/Num_{TempNei}×Num_{Temp}.

Exemplarily, in some embodiments, a maximum average sample-level SAD difference between the current block and the neighbouring reconstructed blocks on a sample may be denoted as offsetDiff_{regionId}, and a maximum average sample value difference on a sample may be represented by “a”. Here “a” may be a predefined fixed factor and may be transmitted through a high-level syntax. Correspondingly, the second threshold determined based on the sample parameter Num_{Temp} corresponding to the first template and the maximum average sample value difference “a” between the current block and the neighbouring reconstructed blocks may be represented by: a×Num_{Temp}.

Exemplarily, in some embodiments, when determining the first parameter based on the first threshold and the second threshold, a smaller one of the first threshold and the second threshold may be selected as the first parameter, that is, the first parameter SADₜₕᵣₑ=min(Diff_{neighbor}/Num_{TempNei}×Num_{Temp}, a×Num_{Temp}) is defined.

That is, in the embodiment of the disclosure, assuming that the Intra TMP is selected for a top neighbouring block of a current to-be-encoded unit as a coding mode for the top neighbouring block, a best block vector for the neighbouring block is BV_{neighbor}, a best matching cost corresponding to the best block vector is Diff_{neighbor}, Num_{TempNei} is a maximum offset based on the number of samples of the reference template of the neighbouring block, then the value of SADₜₕᵣₑ should not be greater than a×Num_{Temp}, here “a” is a maximum average sample value difference on a sample. At this time, a template matching threshold of the current to-be-encoded unit is set to SADₜₕᵣₑ=min(Diff_{neighbor}/Num_{TempNei}×Num_{Temp}, a×Num_{Temp}).

Further, in the embodiment of the disclosure, when determining the first parameter, if the prediction mode of at least one of the neighbouring reconstructed blocks corresponding to the current block is the intra template matching-based prediction mode, the first threshold is determined based on at least one matching cost value for the at least one of the neighbouring reconstructed blocks, at least one sample parameter for the at least one of the neighbouring reconstructed blocks, and the sample parameter for the first template; the second threshold is determined based on the sample parameter for the first template and the maximum average sample value difference between the current block and the neighbouring reconstructed blocks; and the first parameter is determined based on the first threshold and the second threshold.

It may be understood that in the embodiment of the disclosure, if the prediction mode of at least one of the neighbouring reconstructed blocks corresponding to the current block is the intra template matching-based prediction mode, when determining the first threshold, it needs to refer to at least one matching cost value for the at least one of the neighbouring reconstructed blocks, and it also needs to refer to at least one sample parameter for the at least one of the neighbouring reconstructed blocks.

Exemplarily, in some embodiments, if at least two neighbouring positions of multiple neighbouring positions of the current block are encoded by using the Intra TMP mode, that is, there are more than two neighbouring reconstructed blocks using the Intra TMP mode for the current block, here a matching cost value SAD of each of the neighbouring positions (the neighbouring reconstructed blocks) may be denoted as SAD_{Idx} (Idx=0, 1, . . . , N, N is equal to or greater than 1), then

$${Diff}_{neighbor} = \frac{1}{N} {\sum }_{Idx = 0}^{N} {SAD}_{Idx}$$

may be defined, and then the first parameter SADₜₕᵣₑ=min(Diff_{neighbor}/Num_{TempNei}×Num_{Temp}, a×Num_{Temp}) may be defined. Here Num_{TempNei} may be determined by at least one sample parameter corresponding to at least one of the neighbouring reconstructed blocks, for example, a sum of the at least one sample parameter for the at least one of the neighbouring reconstructed blocks is determined as Num_{TempNei}; or, an average value of the at least one sample parameter for the at least one of the neighbouring reconstructed blocks is determined as Num_{TempNei}; or, a sample parameter corresponding to one of the at least one of the neighbouring reconstructed blocks is determined as Num_{TempNei}.

Further, in the embodiment of the disclosure, the preset search region includes at least one search region (that is, at least one search sub-region), and correspondingly, different first parameters may be correspondingly set for different search regions.

That is, in the disclosure, at least one first parameter for the at least one search region may be determined. The first parameters corresponding to different search regions may be the same or different.

Further, in the embodiment of the disclosure, when determining the at least one first parameter for the at least one search region, if the neighbouring reconstructed block corresponding to the current block is present in a current search region of the at least one search region, and the prediction mode of the neighbouring reconstructed block is the intra template matching-based prediction mode, the first parameter for the current search region is determined based on the neighbouring reconstructed block.

Exemplarily, in some embodiments, different thresholds SADThre_{RegionId} (RegionId=0, 1, 2, 3, . . . ) are set for different search regions, and SADThre_{regionId} is derived through DiffNei_{regionId} of a corresponding region of a block encoded by using the neighbouring reconstructed blocks in the Intra TMP mode. The number of samples of the reference template of each of the neighbouring reconstructed blocks is Num_{TempNei}, the number of samples of the reference template of the current block is denoted as Num_{Temp}, and a maximum average sample-level SAD difference between the current block and the neighbouring reconstructed blocks on a sample is denoted as “a” (offsetDiff_{regionId}), then the first parameter SADₜₕᵣₑ=min(DiffNei_{regionId}/Num_{TempNei}×Num_{Temp}, a×Num_{Temp}) may be defined.

It may be understood that in the embodiment of the disclosure, if there are no neighbouring reconstructed blocks corresponding to the current block in one of the at least one search region, or if prediction modes of the neighbouring reconstructed blocks in this one search region are not the intra template matching-based prediction mode, a first parameter for this one search region may be determined based on a preset first parameter. For example, the first parameter for this one search region is determined based on the bit depth information of the current picture and the sample parameter for the first template.

Further, in the embodiment of the disclosure, when performing a search in the preset search region based on the first parameter for the current block, to determine the BV for the current block, search points in the preset search region may be sequentially traversed based on a preset scanning order, and a first matching cost value between a matching template corresponding to each of the search points in the preset search region and the first template is determined based on the preset matching criterion; and if the first matching cost value and the first parameter meet a search termination condition, the search in the preset search region is terminated, and a block vector corresponding to the first matching cost value is determined as the block vector for the current block.

It may be understood that in the embodiment of the disclosure, if the first parameter is the matching cost threshold corresponding to the matching cost value, the first parameter may be understood as a cost upper-limit threshold. Therefore, a corresponding search termination condition may be a magnitude relationship between the matching cost value and the first parameter.

Exemplarily, in the embodiment of the disclosure, meeting the search termination condition may include that the first matching cost value is less than or equal to the first parameter, while not meeting the search termination condition may include that the first matching cost value is greater than the first parameter.

Correspondingly, in the embodiment of the disclosure, if the first matching cost value is greater than the first parameter, a next search point in the preset search region may continue to be traversed sequentially based on the preset scanning order.

It should be noted that in the embodiment of the disclosure, for a block vector, bvXMins and bvXMaxs may represent a minimum offset and a maximum offset of the block vector in the horizontal direction respectively; bvYMins and bvYMaxs may represent a minimum offset and a maximum offset of the block vector in the vertical direction respectively.

bvXMins_{regionId}, bvXMaxs_{regionId}, bvYMins_{regionId} and bvYMaxs_{regionId} may be calculated by using the determined iVerMin_{regionId}, iVerMax_{regionId}, iHorMin_{regionId} and iHorMax_{regionId}:

$${bvXMins}_{regionId} = {iHorMin}_{regionId} - xTbCmp ; \\ {bvXMaxs}_{regionId} = {iHorMax}_{regionId} - xTbCmp ; \\ {bvYMins}_{regionId} = {iVerMin}_{regionId} - yTbCmp ; \\ {bvYMaxs}_{regionId} = {iVerMax}_{regionId} - yTbCmp .$$

bvXMins_{regionId}, bvXMaxs_{regionId}, bvYMins_{regionId} and bvYMaxs_{regionId} determine a range of horizontal and vertical offsets of the search point relative to the current block, that is, a range of the block vector.

It should also be noted that in the embodiment of the disclosure, through each search point (iPosHor, iPosVer) in each search region, that is, each block vector BV (which consists of a horizontal component and a vertical component: (pX, pY), where pX=iPosHor−xTbCmp, pY=iPosVer−yTbCmp, pX is between bvXMins and bvXMaxs, and pY is between bvYMins and bvYMaxs), a matching reconstructed block for the current block may be found in the reconstructed region, and neighbouring reconstructed samples of the matching reconstructed block are used as the matching template.

It may be understood that in the embodiment of the disclosure, when traversing the search points (iPosHor, iPosVer) in the current search range (the preset search region) based on the preset scanning order, for each of the search points, a matching reconstructed block for the current block may be found in the reconstructed region, and neighbouring reconstructed samples of the matching reconstructed block are used as the matching template.

Further, in the embodiment of the disclosure, a matching cost between a neighbouring template of the current block and a neighbouring template of the reconstructed block is denoted as pDiff. If pDiff for a current search point meets pDiff<=SADₜₕᵣₑ, that is, the first matching cost value between the matching template for the search point and the first template is less than or equal to the first parameter, it may be considered that the matching template obtained through the search is a reconstructed template meeting the condition, then it may choose to terminate the search, and a first matching cost pDiff for the search point is denoted as pDiff_BEST, a block vector BV for the search point is denoted as a best block vector BV_BEST (pX_BEST, pY_BEST), and a matching template corresponding to the search point is denoted as a best matching template T_BEST.

It should be noted that in the embodiment of the disclosure, when performing the search process, search strategies that may be adopted include, but are not limited to search modes based on different search step sizes, for example, a coarse search based on a first search step size and/or a fine search based on a second search step size, here the first search step size is greater than the second search step size.

Further, in the embodiment of the disclosure, the search points in the preset search region may be traversed based on the preset scanning order and a first search step size, to determine the block vector and candidate template. Alternatively, the search points in the preset search region may be traversed based on the preset scanning order and a second search step size, to determine the block vector and candidate template.

Further, in the embodiment of the disclosure, the search points in the preset search region may be traversed based on the preset scanning order and the first search step size, to determine an initial block vector and an initial matching template corresponding to the initial block vector; then a first search region is determined based on the initial matching template, here the first search region is smaller than the preset search region; and finally, search points in the first search region may be traversed based on the preset scanning order and the second search step size, to determine the block vector and the candidate template, here the first search step size is greater than the second search step size.

That is, in the embodiment of the disclosure, when searching for a best matching template in the search region, a search strategy of performing a coarse search first and then performing a fine search may be used, or only the fine search may be performed, or only the coarse search may be performed.

Exemplarily, in the embodiment of the disclosure, the coarse search may specifically include that: a best coarse matching template is determined in the search region with a first preset step size (i.e., the first search step size, such as 2, or 3, etc.), that is, a final candidate template is obtained. Alternatively, the best coarse matching template is determined in the search region by using a downsampled template (such as a downsampling factor of 2, or 3, etc.), that is, the final candidate template is obtained.

Exemplarily, in the embodiment of the disclosure, the fine search may specifically include that: a best fine matching template is determined in the search region with a second preset step size (i.e., the second search step size, such as 1, or ½, etc.), that is, a final candidate template is obtained. Alternatively, the best fine matching template is determined near the best coarse matching template after completing the coarse search, that is, the final candidate template is obtained.

Further, in the embodiment of the disclosure, the search points in the preset search region may be sequentially traversed based on the preset scanning order and a first search step size, and the first matching cost value between the matching template corresponding to each of the search points in the preset search region and the first template is determined based on the preset matching criterion. If the first matching cost value and the first parameter meet a search termination condition, the search in the preset search region is terminated, and a block vector corresponding to the first matching cost value is determined as the block vector for the current block.

It may be understood that in the embodiment of the disclosure, meeting the search termination condition may include that the first matching cost value is less than or equal to the first parameter, while not meeting the search termination condition may include that the first matching cost value is greater than the first parameter.

Exemplarily, in the embodiment of the disclosure, if the search strategy is to perform only the coarse search, the coarse search may be performed with a step size greater than 1 (such as a step size of 2 or 3) in a search range where pX is between bvXMins_{regionId} and bvXMaxs_{regionId} and pY is between bvYMins_{regionId} and bvYMaxs_{regionId} within each region. If pDiff for the current search point meets pDiff<=SADₜₕᵣₑ, that is, the first matching cost value between the matching template corresponding to the search point and the first template is less than or equal to the first parameter, it may be considered that the matching template obtained through the search is a reconstructed template meeting the condition, then it may choose to terminate the search, and a matching cost pDiff obtained through template matching is denoted as pDiff_BEST, a block vector corresponding to the search point is denoted as a best block vector BV_BEST, with each item representing a coordinate pair (pX_BEST, pY_BEST).

Further, in the embodiment of the disclosure, the search points in the preset search region may be sequentially traversed based on the preset scanning order and a second search step size, and the first matching cost value between the matching template corresponding to each of the search points in the preset search region and the first template is determined based on the preset matching criterion. If the first matching cost value and the first parameter meet a search termination condition, the search in the preset search region is terminated, and a block vector corresponding to the first matching cost value is determined as the block vector for the current block.

Exemplarily, in the embodiment of the disclosure, meeting the search termination condition may include that the first matching cost value is less than or equal to the first parameter, while not meeting the search termination condition may include that the first matching cost value is greater than the first parameter.

Exemplarily, in the embodiment of the disclosure, if the search strategy is to perform only the fine search, the fine search may be performed with a small step size (such as a step size of 1 or ½, when the step size is less than 1, sub-sample interpolation is required) in a search range where pX is between bvXMins_{regionId} and bvXMaxs_{regionId} and pY is between bvYMins_{regionId} and bvYMaxs_{regionId} within each region. If pDiff for the current search point meets pDiff<=SADₜₕᵣₑ, that is, the first matching cost value between the matching template corresponding to the search point and the first template is less than or equal to the first parameter, it may be considered that the matching template obtained through the search is a reconstructed template meeting the condition, then it may choose to terminate the search, and a matching cost pDiff obtained through template matching is denoted as pDiff_BEST, a block vector BV corresponding to the search point is denoted as a best block vector BV_BEST, with each item representing a coordinate pair (pX_BEST, pY_BEST).

Further, in the embodiment of the disclosure, search may be performed in the preset search region based on the preset scanning order and a first search step size, and a second matching cost value between the matching template corresponding to each of the search points in the preset search region and the first template is determined based on the preset matching criterion. If the second matching cost value and the first parameter meet the search termination condition, the search in the preset search region is terminated, and a block vector corresponding to the second matching cost value is determined as a reference block vector for the current block. A first search region is determined based on the matching reconstructed block corresponding to the reference block vector, here the first search region is smaller than the preset search region. Search is performed in the first search region based on the preset scanning order and a second search step size, and a third matching cost value between a matching template corresponding to each of search points in the first search region and the first template is determined based on the preset matching criterion, here the first search step size is greater than the second search step size. If the third matching cost value and the first parameter meet the search termination condition, the search in the first search region is terminated, and a block vector corresponding to the third matching cost value is determined as the block vector for the current block.

It may be understood that in the embodiment of the disclosure, if the first parameter is the matching cost threshold corresponding to the matching cost value, the first parameter may be understood as a cost upper-limit threshold. Therefore, a corresponding search termination condition may be a magnitude relationship between the matching cost value and the first parameter.

Exemplarily, in the embodiment of the disclosure, meeting the search termination condition may include that the second matching cost value is less than or equal to the first parameter, and not meeting the search termination condition may include that the second matching cost value is greater than the first parameter.

Exemplarily, in the embodiment of the disclosure, meeting the search termination condition may include that the third matching cost value is less than or equal to the first parameter, and not meeting the search termination condition may include that the third matching cost value is greater than the first parameter.

That is, in the embodiment of the disclosure, meeting the search termination condition includes that: the first matching cost value is less than or equal to the first parameter; and/or, the second matching cost value is less than or equal to the first parameter; and/or, the third matching cost value is less than or equal to the first parameter.

Exemplarily, in the embodiment of the disclosure, if the search strategy is to perform the coarse search first and then the fine search, the coarse search may be performed first with a step size of 2 (that is, the first search step size is 2), to record a best coarse matching template (initial matching template) obtained through template matching, and then a best fine matching template may be determined near the best coarse matching template with a step size of 1 (that is, the second search step size is 1), that is, the final candidate template is obtained.

During a coarse search stage, the coarse search may be performed with a step size greater than 1 in a search range where pX is between bvXMins_{regionId} and bvXMaxs_{regionId} and pY is between bvYMins_{regionId} and bvYMaxs_{regionId} within each region. For example, the coarse search is performed with a step size of 2. If pDiff for the current search point meets pDiff<=SADₜₕᵣₑ during traversal in the coarse search, that is, the second matching cost value between the matching template corresponding to the search point and the first template is less than or equal to the first parameter, it may be determined that the matching template obtained through the search is a reconstructed template meeting the condition, then the search is terminated, and a best matching cost obtained through template matching is recorded as pDiff1_BEST=pDiff_{refine}, a block vector corresponding to the search point is denoted as a best block vector BV1_BEST (pX1_BEST, pY1_BEST), i.e., the reference block vector, and a matching template corresponding to the search point is the initial matching template. At this time, a search region where a best matching search point is located is bestRegionId.

Next, during a fine search stage, search may be performed near the best block vector BV1_BEST (the reference block vector) obtained through the coarse search, that is, the search is performed in the first search region. Therefore, it needs to determine a refined search range TmpRefineRange first, that is, it needs to determine the first search region TmpRefineRange. The refined search range (the first search region TmpRefineRange) may be in a fixed size or related to the size of the current block, for example, it may be set to min(nTbW, nTbH)/2. Then, a position of a best matching reconstructed block obtained through the coarse search is calculated as a reference position of a fine search region: BestPosX=xTbCmp+pX1_BEST, BestPosY=yTbCmp+pY1_BEST.

In an embodiment, calculated values of iVerMinbest_{RegionId}, iVerMaxbest_{RegionId}, iHorMinbest_{RegionId} and iHorMaxbest_{RegionId} may be acquired first based on value of best_{RegionId}, and then new search range defined by iVerMin_{refine}, iVerMax_{refine}, iHorMin_{refine} and iHorMax_{refine} is acquired based on the position of a bset matching block obtained through the coarse search. The acquisition method is as follows:

$${iHorMin}_{refine} = max ( {iHorMinbest}_{RegionId} , BestPosX - TmpRefineRange ) ; \\ {iHorMax}_{refine} = max ( {iHorMaxbest}_{RegionId} , BestPosX + TmpRefineRange ) ; \\ {iVerMin}_{refine} = max ( {iVerMinbest}_{RegionId} , BestPosY - TmpRefineRange ) ; \\ {iVerMin}_{refine} = max ( {iHorMaxbest}_{RegionId} , BestPosY + TmpRefineRange ) .$$

Then, for the adjusted block vector BV, bvXMins, bvXMaxs, bvYMins and bvYMaxs may be calculated by iVerMin_{refine}, iVerMax_{refine}, iHorMin_{refine} and iHorMax_{refine}:

$$bvXMins = {iHorMin}_{refine} - xTbCmp ; \\ bvXMaxs = {iHorMin}_{refine} - xTbCmp ; \\ bvYMins = {iVerMin}_{refine} - yTbCmp ; \\ bvYMaxs = {iVerMin}_{refine} - yTbCmp .$$

The fine search is performed within a block vector range where pX is between bvXMins_{refine} and bvXMaxs_{refine} and pY is between bvYMins_{refine} and bvYMaxs_{refine}. For example, the search is performed with a step size of 1. If pDiff_{refine} for the current search point meets pDiff<=SADₜₕᵣₑ during traversal in the fine search, that is, the third matching cost value between the matching template corresponding to the search point and the first template is less than or equal to the first parameter, it may be determined that the matching template obtained through the search is a reconstructed template meeting the condition, then the search is terminated, and a best matching cost obtained through template matching is recorded as pDiff_BEST=pDiff_{refine}, a block vector BV corresponding to the search point is denoted as a best block vector BV_BEST (pX_BEST, pY_BEST), i.e., the block vector for the current block determined finally, and a matching template corresponding to the search point is a candidate template for the current block.

After completing the above operations, the best block vector BV_BEST (pX_BEST, pY_BEST) may be obtained, here pX_BEST and pY_BEST are offsets of the best matching template relative to the template of the current coding block in the horizontal direction and in the vertical direction respectively, and are also offsets of the best matching reconstructed block relative to the current coding block in the horizontal direction and in the vertical direction respectively.

It should be noted that in the embodiment of the disclosure, one or more best block vectors BV_BEST meeting different algorithm requirements may be obtained based on results of coarse and fine search processes (here the fine search process includes searching with one or more reference points), here BV_BEST represents a coordinate pair (pX_BEST, pY_BEST).

It may be seen that in the embodiment of the disclosure, three search strategies may be included in a process for searching in the search region to determine one or more block vectors: only performing the coarse search, only performing the fine search, and performing the coarse search first and then the fine search.

Further, in the embodiment of the disclosure, for at least one search region included in the preset search region, when performing a search in the preset search region based on the first parameter for the current block, to determine the block vector for the current block, a first search order for the at least one search region may be determined first based on a positional relationship between the current block and the at least one search region; and then the at least one search region is sequentially traversed based on the first search order, and the search is performed in the at least one search region based on the first parameter, to determine the block vector for the current block.

It should be noted that in the embodiment of the disclosure, the first search order may be a near to far order of distances from the current block. This is because when performing the search in multiple search sub-regions, the block vector for the current block can be determined more quickly in a search order from near to far.

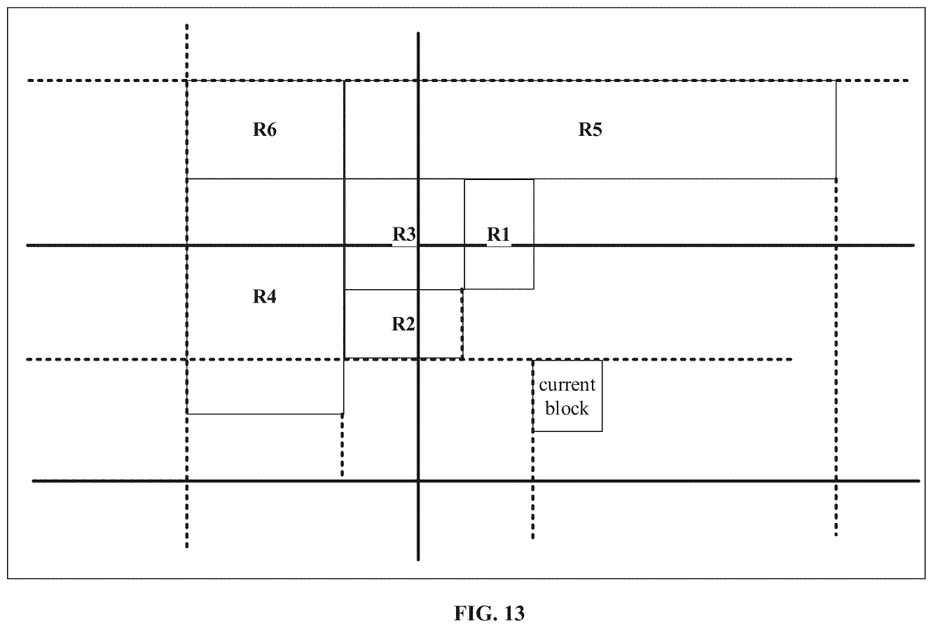

Exemplarily, in some embodiments, different search regions may also be defined in different manners. FIG. 13 is a first schematic diagram of at least one search region. As shown in FIG. 13, regions closer to the current block may be defined as R1, R2 and R3, and regions farthest away from the current block may be defined as R4, R5, R6, or the like, and search may be performed in an order of R1, R2, R3, and then R4, R5, R6.

That is, in the embodiment of the disclosure, the search order for different search regions may be determined based on positional relationships between the search regions and the current block.

It should be noted that in the embodiment of the disclosure, sequences of R1 and R2 may be exchanged, and sequences of R4 and R5 may be exchanged.

Further, in the embodiment of the disclosure, for at least one search region included in the preset search region, when performing the search in the preset search region based on the first parameter for the current block, to determine the block vector for the current block, the at least one search region may be merged based on a positional relationship between the current block and the at least one search region, to obtain at least one merged search region; then a second search order for the at least one merged search region is determined based on a positional relationship between the current block and the at least one merged search region; and the at least one merged search region is sequentially traversed based on the second search order, and search is performed in the at least one merged search region based on the first parameter, to determine the block vector for the current block.

It should be noted that in the embodiment of the disclosure, the second search order may be a near to far order of distances from the current block. This is because when performing the search in multiple search sub-regions, the block vector for the current block can be determined more quickly in a search order from near to far.

Exemplarily, in some embodiments, as shown in FIG. 13, R1 and R3 may be merged into a region; or, R2 and R3 may be merged into a region; or, R5 and R6 may be merged into a region; or, R4 and R6 may be merged into a region, etc.

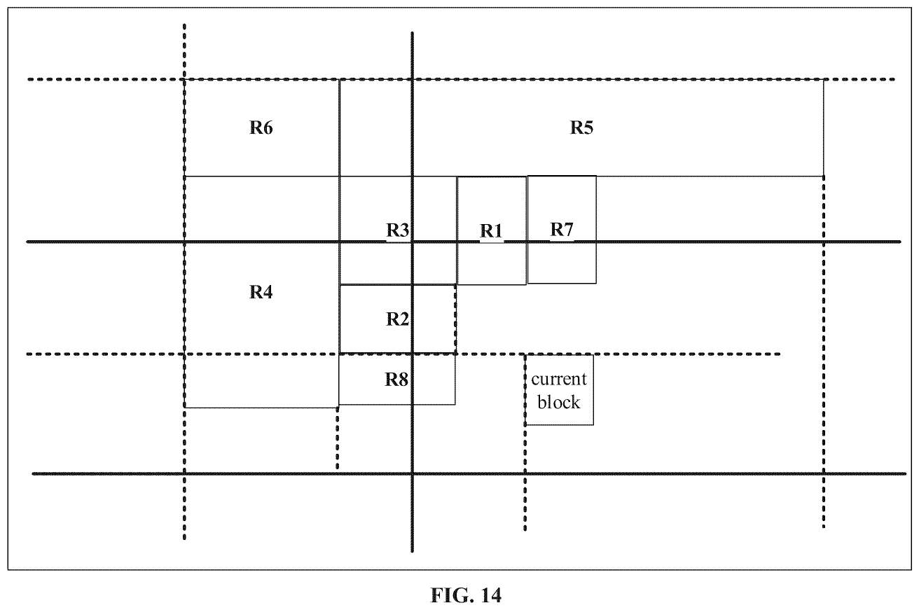

Exemplarily, in some embodiments, different search regions may also be defined in different manners. FIG. 14 is a second schematic diagram of at least one search region. As shown in FIG. 14, in case of the preset search region including an undetermined reconstructed region, the search may be performed in an order of R1, R2, R3, R7, R8, and then R4, R5, R6. Sequences of R1 and R2 may be exchanged, sequences of R7 and R8 may be exchanged, and sequences of R4 and R5 may be exchanged.

Further, in the embodiment of the disclosure, the preset scanning order includes any one of a raster scanning order, a longitudinal reverse raster scanning order, a lateral reverse raster scanning order, a full reverse raster scanning order, a diagonal scanning order, a horizontal scanning order, a vertical scanning order, or a zigzag scanning order.

That is, in the embodiment of the disclosure, when traversing the search points in the preset search region, a raster scanning order from top to bottom and from left to right may be used, or a longitudinal reverse raster scanning order from bottom to top and from left to right may be used, or a lateral reverse raster scanning order from top to bottom and from right to left may be used, or a full reverse raster scanning order from bottom to top and from right to left may be used, or a diagonal scanning order, a horizontal scanning order, a vertical scanning order, a zigzag scanning order, or other scanning orders may be used.

Further, in the embodiment of the disclosure, for at least one search region included in the preset search region, when sequentially traversing the at least one search region based on the first search order, for a current search region of the at least one search region, search points in the current search region are sequentially traversed based on the preset scanning order for the current search region, and the block vector for the current block is determined.

That is, the same scanning method and the same scanning order may be used for each search region, or different scanning methods may be used for each search region, or the same scanning method with different scanning orders may be used for each search region.

It should be noted that in the embodiment of the disclosure, for a first region located at a top side of the current block among the at least one search region, the longitudinal reverse raster scanning order is determined as the preset scanning order corresponding to the first region. For a second region located at a left side of the current block among the at least one search region, the lateral reverse raster scanning order is determined as the preset scanning order corresponding to the second region. For a third region located at a top-left side of the current block among the at least one search region, the full reverse raster scanning order is determined as the preset scanning order corresponding to the third region.

Exemplarily, in some embodiments, as shown in FIG. 14, search in R1 and R5 may be performed in the longitudinal reverse raster scanning order, search in R2 and R4 may be performed in the lateral reverse raster scanning order, and search in R3 and R6 may be performed in the full reverse raster scanning order.

It should be noted that in the embodiment of the disclosure, for a fourth region located at a top side and/or a top-right side of the current block among the at least one search region, the longitudinal reverse raster scanning order is determined as the preset scanning order corresponding to the fourth region. For a fifth region located at a left side and/or a bottom-left side of the current block among the at least one search region, the lateral reverse raster scanning order is determined as the preset scanning order corresponding to the fifth region. For a third region located at a top-left side of the current block among the at least one search region, the full reverse raster scanning order is determined as the preset scanning order corresponding to the third region.

Exemplarily, in some embodiments, as shown in FIG. 14, search in R1, R5 and R7 may be performed in the longitudinal reverse raster scanning order, search in R2, R4 and R8 may be performed in the lateral reverse raster scanning order, and search in R3 and R6 may be performed in the full reverse raster scanning order.

Further, in the embodiment of the disclosure, the first parameter for the current block may also be determined by decoding a bitstream. The first parameter may be transmitted through any one of following syntax information: sequence parameter set (SPS layer syntax information, picture parameter set (PPS) layer syntax information, adaptation parameter set (APS) layer syntax information, slice header (SH) layer syntax information, or coding unit (CU) layer syntax information.

That is, in the embodiment of the disclosure, a threshold condition (the first parameter) for early termination may be identified in an SPS layer, a PPS layer, an APS layer or an SH layer, to control complexity at the decoding side.

Further, in the embodiment of the disclosure, when performing search in the preset search region based on the first parameter for the current block, to determine the block vector for the current block, search points in the preset search region may also be traversed based on a preset search mode, and a first matching cost value between a matching template corresponding to each of the search points in the preset search region and the first template is determined based on the preset matching criterion; and if the first matching cost value and the first parameter meet a search termination condition, the search in the preset search region is terminated, and a block vector corresponding to the first matching cost value is determined as the block vector for the current block.

It should be noted that in the embodiment of the disclosure, the preset search mode includes any one of the following modes: a cross search mode, a square search mode, a diamond search mode, or a hash search mode.

That is, in the embodiment of the disclosure, it may choose to search in each region in the preset scanning order such as a raster order, for example, search from top to bottom and from left to right, or search from bottom to top and from right to left, etc. Alternatively, it may choose to perform a fast iterative search in the preset search region based on the preset search mode, here the preset search mode includes, but is not limited to a cross search, a square search, a diamond search, etc. Alternatively, a hash search mode similar to Intra Block Copy (IBC) may be adopted, which is not specifically limited in the disclosure.

Further, in the embodiment of the disclosure, when performing the search based on the preset search mode, search strategies that may be adopted include, but are not limited to search modes based on different search step sizes, for example, a coarse search based on a third search step size and/or a fine search based on a fourth search step size, here the third search step size is greater than the fourth search step size.

Exemplarily, in some embodiments, it may choose to traverse the search points in the preset search region based on the preset search mode and a third search step size, and the first matching cost value between the matching template corresponding to each of the search points in the preset search region and the first template is determined based on the preset matching criterion. Alternatively, the search points in the preset search region may be traversed based on the preset search mode and a fourth search step size, and the first matching cost value between the matching template corresponding to each of the search points in the preset search region and the first template is determined based on the preset matching criterion. The third search step size is greater than the fourth search step size.

Exemplarily, in some embodiments, it may choose to perform the search in the preset search region based on the preset search mode and a third search step size, and a second matching cost value between the matching template corresponding to each of the search points in the preset search region and the first template is determined based on the preset matching criterion. If the second matching cost value and the first parameter meet the search termination condition, search in the preset search region is terminated, and a block vector corresponding to the second matching cost value is determined as a reference block vector for the current block. A first search region is determined based on the matching reconstructed block corresponding to the reference block vector, here the first search region is smaller than the preset search region. Search is performed in the first search region based on the preset search mode and a fourth search step size, and finally, a third matching cost value between a matching template corresponding to each of search points in the first search region and the first template may be determined based on the preset matching criterion, here the third search step size is greater than the fourth search step size. If the third matching cost value and the first parameter meet the search termination condition, search in the first search region is terminated, and a block vector corresponding to the third matching cost value is determined as the block vector for the current block.

That is, in the embodiment of the disclosure, when searching for a best matching template in the search region based on the preset search mode, a search strategy of performing a coarse search first and then a fine search may be used, or only the fine search may be performed, or only the coarse search may be performed.

Further, in the embodiment of the disclosure, if a fast iterative search is performed based on the preset search mode, in addition to using a first parameter to control the search process, a second parameter may also be used to control the search process.

It should be noted that in the embodiment of the disclosure, the second parameter is used to impose a constraint on matching cost differences between different templates based on the preset matching criterion.

That is, in the embodiment of the disclosure, after determining the preset search region based on the first template, it may choose to perform the search in the preset search region based on the first parameter and/or the second parameter corresponding to the current block, to determine the block vector for the current block.

Further, in the embodiment of the disclosure, when performing the search in the preset search region based on the second parameter corresponding to the current block, iterative search may be performed on the search points in the preset search region based on the preset search mode, and an iterative cost difference between the matching template corresponding to each of the search points in the preset search region and the first template is determined based on the preset matching criterion; and if the iterative cost difference and a second parameter meet the search termination condition, iterative search in the preset search region is terminated, and a block vector corresponding to the iterative cost difference is determined as the block vector for the current block. The second parameter is used to impose a constraint on matching cost differences between different templates based on the preset matching criterion.

It should be noted that in the embodiment of the disclosure, the second parameter may be used for controlling the process of the search. For example, based on the second parameter, it may choose to continue the fast iterative search process or to terminate the fast iterative search process early.

Exemplarily, in the embodiment of the disclosure, the second parameter may be an iterative cost difference threshold corresponding to the iterative cost difference. Correspondingly, when controlling the search process based on the second parameter, if the iterative cost difference and the second parameter (the iterative cost difference threshold) meet the search termination condition, it may choose to terminate the fast iterative search process early; otherwise, it may choose to continue the fast iterative search process.

It may be understood that in the embodiment of the disclosure, if the second parameter is the iterative cost difference threshold corresponding to the iterative cost difference, the second parameter may be understood as a difference upper-limit threshold. Therefore, a corresponding search termination condition may be a magnitude relationship between the iterative cost difference and the second parameter.

Exemplarily, in the embodiment of the disclosure, if the iterative cost difference is less than or equal to a second parameter, it may be considered that the search termination condition is met, and then the fast iterative search process may be terminated early; if the matching cost value is greater than the second parameter, it may be considered that the search termination condition is not met, and then the fast iterative search process may be continue.

It may be seen that in the embodiment of the disclosure, when performing the search based on the second parameter, if a search point whose iterative cost difference before and after iteration is less than or equal to the second parameter is obtained through the search, it may choose to terminate the fast iterative search, thereby achieving the control on the search process.

That is, in the embodiment of the disclosure, in addition to a threshold (i.e., the first parameter) for the magnitude of the cost itself, the cost difference before and after iteration may also be taken as the threshold (i.e., the second parameter) for termination. If the cost difference (the iterative cost difference) before and after the iteration is less than a certain threshold (the second parameter), the iteration is stopped.

It should be noted that in the embodiment of the disclosure, during the search process, the first parameter and the second parameter may be simultaneously used to control the search process, or the first parameter or the second parameter may be selected to control the search process. That is, the iterative cost difference threshold (the second parameter) and the threshold (the first parameter) for the magnitude of the cost itself may be used independently or in combination.

Further, in the embodiment of the disclosure, iterative search may be performed in a first sub-region of the preset search region based on the preset search mode, and an iterative cost difference between a matching template corresponding to each of search points in the first sub-region and the first template is determined based on a preset matching criterion. If the iterative cost difference and the second parameter meet the search termination condition, iterative search in the first sub-region is terminated, and a current matching cost value between the matching template corresponding to each of the search points in the first sub-region and the first template is determined based on a preset matching criterion. If the current matching cost value and the first parameter meet the search termination condition, search in the preset search region is terminated, and a block vector corresponding to the first matching cost value is determined as the block vector for the current block.

Further, in the embodiment of the disclosure, iterative search may be performed in a first sub-region of the preset search region based on the preset search mode, and an iterative cost difference between a matching template corresponding to each of search points in the first sub-region and the first template is determined based on the preset matching criterion. If the iterative cost difference and the second parameter meet the search termination condition, iterative search in the first sub-region is terminated, and a current matching cost value between the matching template corresponding to each of the search points in the first sub-region and the first template is determined based on the preset matching criterion. If the current matching cost value and the first parameter do not meet the search termination condition, iterative search is continued in other sub-regions of the preset search region except the first sub-region based on the preset search mode.

Exemplarily, in some embodiments, for each sub-region of the preset search region, it may choose to perform a fast iterative search in each sub-region, and when the iterative cost difference (the iterative cost difference value) is less than a certain threshold (the second parameter), iterative search in this sub-region is terminated; if the current cost (the current matching cost value) is less than the threshold (the second parameter) for termination, it may choose to terminate the entire search process in the preset search region, that is, the search process in the preset search region is terminated early; otherwise, it may choose to continue iterative search process in other sub-regions.

Further, in the embodiment of the disclosure, the second parameter corresponding to the current block may also be determined by decoding a bitstream. The second parameter may be transmitted through any one of following syntax information: SPS layer syntax information, PPS layer syntax information, APS layer syntax information, SH layer syntax information, or CU layer syntax information.

That is, in the embodiment of the disclosure, a threshold condition (the second parameter) for early termination may be identified in an SPS layer, a PPS layer, an APS layer or an SH layer, to control complexity at the decoding side.

In operation 103, prediction values for the current block are determined based on the block vector for the current block.

In the embodiment of the disclosure, after searching in the preset search region based on the first parameter for the current block, to determine the block vector for the current block, prediction values for the current block may be further determined based on the block vector for the current block.

Further, in the embodiment of the disclosure, when determining the prediction values for the current block are determined based on the block vector for the current block, reference blocks for the current block may be determined first based on the block vector for the current block; and then the prediction values for the current block are determined based on the reference blocks for the current block.

Exemplarily, in the embodiment of the disclosure, determination of the reference blocks for the current block may be achieved by using simple translation copy. Specific operations are as follows. For x=0 . . . nTbW−1, y=0 . . . nTbH−1: reconstructed samples recSamples of the current picture (that is, the reference blocks for the current block) are determined by:

$${RefBlock}_{n} [ x ] [ y ] = recSamples [ x + {pX}_{n} ] [ y + {pY}_{n} ] .$$

It should be noted that in the embodiment of the disclosure, when determining the reference blocks for the current block based on the block vector for the current block, initial reconstructed blocks for the current block may be determined first based on the block vector for the current block; then the initial reconstructed blocks are refined, and the reference blocks for the current block are determined.

That is, in the embodiment of the disclosure, other manners may be used when acquiring candidate reconstructed blocks (reference blocks), for example, initial reconstructed blocks corresponding to the obtained candidate templates are refined first, and then corresponding reference blocks are determined.

It should be noted that in the embodiment of the disclosure, the prediction values determined through the block vector for the current block may be used as final prediction values, or may be further processed to obtain final prediction values for the current block.

Further, in the embodiment of the disclosure, when determining the prediction values for the current block based on the block vector for the current block, at least one reference block for the current block may be determined first based on the block vector for the current block; and then the prediction values for the current block are determined based on the at least one reference block.

It should be noted that in the embodiment of the disclosure, when determining the prediction values for the current block based on the at least one reference block, at least one prediction block corresponding to the at least one reference block may be determined first; and then weighted fusion is performed on the at least one prediction block, and the prediction values for the current block are determined.

Exemplarily, in some embodiments, after determining the block vector for the current block, multiple points may be taken around the block vector, that is, multiple reference blocks may be acquired, and then weighted fusion may be performed on prediction values for the multiple points, to obtain the prediction values for the current block.

Further, in the embodiment of the disclosure, when determining the prediction values for the current block based on the block vector for the current block, first prediction values for the current block may be determined first based on the block vector for the current block; then second prediction values for the current block are determined based on a preset prediction mode, here the preset prediction mode includes a planar mode and/or a directional mode; and finally, the prediction values for the current block may be determined based on the first prediction values and the second prediction values.

Exemplarily, in some embodiments, after determining the block vector for the current block, prediction values acquired by using the block vector and prediction values obtained in other Intra modes may be weighted and fused to obtain the final prediction values. The other Intra modes may be other prediction modes except the Intra TMP, such as a planar mode or a directional mode, etc. The directional mode may be derived from TIMD, or may be obtained by locating in an Intra candidate table by using an Index transmitted in a bitstream. This method may be referred to as an Intra TMP CIP mode.

It may be understood that in the Intra TMP mode, in addition to the basic copying method for acquiring the prediction values, a method for acquiring the prediction values by performing filtering fusion using positions corresponding to multiple BVs, as well as a method for fusion prediction in combination with a normal Intra mode may be used.

Further, in the embodiment of the disclosure, after determining the prediction values for the current block based on the block vector for the current block, reconstructed values for the current block may be further determined based on the prediction values for the current block.

It should be noted that in the embodiment of the disclosure, a bitstream may be decoded first, to determine prediction residuals for the current block. Then reconstructed values for the current block may be further determined based on the prediction residuals and the prediction values.

In summary, through the method for decoding proposed in the above operations 101 to 103, the information (such as the depth information) of the current picture or Diff information (such as the matching cost values corresponding to the neighbouring reconstructed blocks) of neighbouring positions of the current to-be-encoded block may be utilized effectively, to derive a first parameter for template matching; and during the search, if it is determined that a matching cost value corresponding to a search point meets the first parameter, the search process for the current coding block may be terminated early, thereby reducing search complexity of the Intra TMP to a certain extent.

It should be noted that in the embodiment of the disclosure, the first parameter determined through the information (such as the depth information) of the current picture may be a predefined fixed threshold, and the first parameter determined based on the neighbouring reference blocks using the Intra TMP mode may be an adaptive threshold. Different first parameters may be set for different search sub-regions of the preset search region, to control the search process.

Exemplarily, in some embodiments, a search scheme for early termination based on an SAD matching cost of a reference template may be proposed for the Intra TMP technology. According to the search scheme, the search process may be controlled by using a matching cost threshold (a first parameter) of a reference template, and the search can be terminated early in case that the first parameter is met, such that complexity can be balanced while algorithm effectiveness is ensured.

Exemplarily, in some embodiments, a template matching cost threshold (a first parameter) may be derived by using the information of the current picture or Diff information of neighbouring positions of the current to-be-encoded block. When a threshold for the current search point does not exceed this threshold, a block vector for the search point is denoted as a best block vector BV_BEST, and the search process is terminated early.

Inputs for acquiring the Intra TMP-BV: the position (xTbCmp, yTbCmp) of the current coding block (the current block), the width nTbW of the current coding block, and the height nTbH of the current coding block. Output for acquiring the Intra TMP-BV: the BV for the current block and the prediction values predSamples[x][y] for the prediction block corresponding to the BV, here x=0 . . . nTbW−1, y=0 . . . nTbH−1. The prediction values for the prediction block may be used as final prediction values, or may be further processed to obtain final prediction values for the current block.

It may be understood that a specific process of acquiring the Intra TMP-BV proposed in the embodiment of the disclosure is divided into three steps as follows: determining the type of the current template, acquiring reconstructed samples of the current template, and determining a block vector within a predefined search range. For each acquired block vector, a set of prediction values for the current block may be obtained.

The embodiment of the disclosure provides a method for decoding, in which when a prediction mode for a current block is an intra template matching-based prediction mode, the decoder determines a first template for the current block, and determines a preset search region based on the first template; the decoder performs a search in the preset search region based on a first parameter for the current block, and determines a block vector for the current block, here the first parameter is used for controlling a process of the search; the decoder determines prediction values of the current block based on the block vector for the current block. It can be seen that in the embodiment of the disclosure, based on an Intra TMP mode, the search process can be controlled by using a predetermined first parameter such as a matching cost threshold, such that it may choose to terminate the search process early or continue the search process based on the first parameter. That is, according to the method for encoding and the method for decoding proposed in the embodiments of the disclosure, a problem of high computational complexity caused by traversing all search points in the search region can be solved by introducing the first parameter used for controlling the process of the search, such that the efficiency and performance of encoding and decoding can be improved.

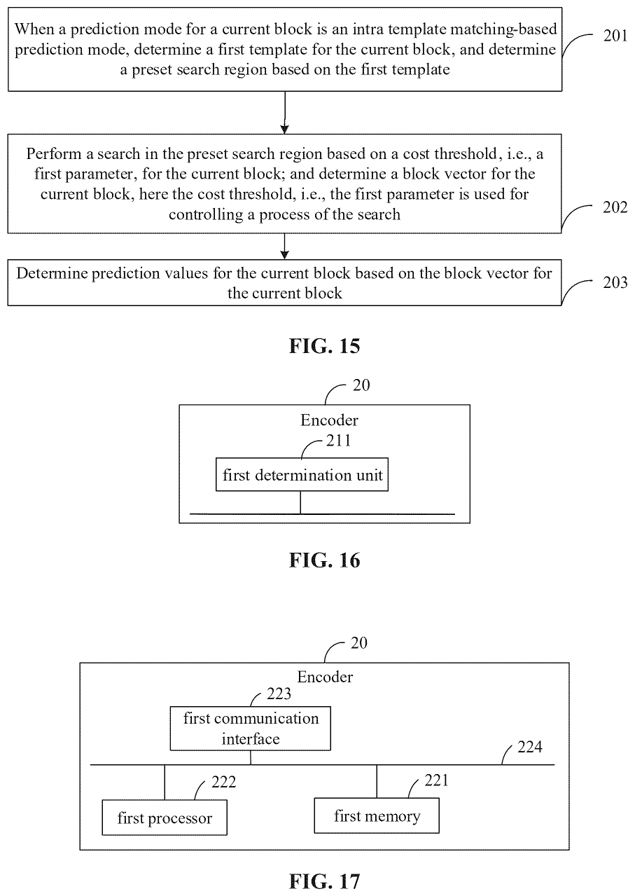

An embodiment of the disclosure proposes a method for encoding, the method for encoding is applied to an encoder. FIG. 15 is a schematic flowchart of a method for encoding proposed in an embodiment of the disclosure. As shown in FIG. 15, the method for the encoder to perform an encoding process may include the following operations 201 to 203.

In operation 201, when a prediction mode for a current block is an intra template matching-based prediction mode, a first template for the current block is determined, and a preset search region is determined based on the first template.

In the embodiment of the disclosure, when the prediction mode for the current block is the intra template matching-based prediction mode, the first template for the current block may be determined first. When acquiring the first template, a template type for the current block may be determined first, and then the first template for the current block may be further determined based on the template type.

It may be understood that in the embodiment of the disclosure, the intra template matching-based prediction mode may be a prediction mode using template matching, for example, the intra template matching-based prediction mode may be an Intra TMP mode.

Further, in the embodiment of the disclosure, after determining the first template for the current block, the preset search region corresponding to the current block may be further determined based on the first template.

It should be noted that the method for encoding according to the embodiment of the disclosure is applied to the encoder. Furthermore, the method for encoding may include an intra prediction method, more specifically, a method for predicting colour components. A video picture may be partitioned into multiple coding blocks, each coding block may include a first colour component, a second colour component and a third colour component. The current block in the embodiment of the disclosure refers to a coding block, for which the intra prediction is to be performed currently, in the video picture.

Here, when the first colour component needs to be predicted, a to-be-predicted component is the first colour component; when the second colour component needs to be predicted, the to-be-predicted component is the second colour component; when the third colour component needs to be predicted, the to-be-predicted component is the third colour component. Furthermore, assuming that the first colour component is predicted for the current block, and the first colour component is a luma component, that is, the to-be-predicted component is the luma component, then the current block may also be referred to as a luma block. Alternatively, assuming that the second colour component is predicted for the current block, and the second colour component is a chroma component, that is, the to-be-predicted component is the chroma component, then the current block may also be referred to as a chroma block.

It should also be noted that in the embodiment of the disclosure, reference samples (reference samples) of the current block may refer to reference sample points neighbouring to the current block. “neighbouring” here may be spatially neighbouring, but is not limited thereto. For example, “neighbouring” may also be temporally neighbouring or spatially and temporally neighbouring, or even the reference samples of the current block may be reference samples obtained by performing some processing on spatially neighbouring reference sample points, temporally neighbouring reference sample points, spatially and temporally neighbouring reference sample points, or the like, and the embodiment of the disclosure does not make any limitation thereto.

Further, in the embodiment of the disclosure, the template type for the current block may be determined based on indication information in a bitstream; or, the template type for the current block may be determined based on a size of the current block.

Further, in the embodiment of the disclosure, the template type for the current block may also be determined based on reference samples of the current block. The reference samples of the current block include at least one of: left neighbouring reference samples of the current block, top neighbouring reference samples of the current block, top-left neighbouring reference samples of the current block, bottom-left neighbouring reference samples of the current block, or top-right neighbouring reference samples of the current block.

It may be understood that in the embodiment of the disclosure, the reference samples of the current block may include neighbouring reconstructed samples of the current block, that is, the neighbouring reconstructed samples of the current block may be used as as a template to search a matching template in a predefined search region.

It should be noted that in the embodiment of the disclosure, the reference samples of the current block (that is, the neighbouring reconstructed samples of the current block) may include top reference samples, top-left reference samples, top-right reference samples, left reference samples and bottom-left reference samples of the current block.

It may be understood that in the embodiment of the disclosure, when determining the template type for the current block by using the reference samples of the current block, the template types may be classified and determined based on availability of neighbouring reference samples.

It may be understood that in the embodiment of the disclosure, when determining the template type for the current block, the template types may also be classified and determined based on an indication in the bitstream.

Further, in the embodiment of the disclosure, when determining the template type for the current block based on the reference samples of the current block, if the left neighbouring reference samples of the current block, the top neighbouring reference samples of the current block and the top-left neighbouring reference samples of the current block are all available, it is determined that the template type for the current block is a first value; if the left neighbouring reference samples of the current block are available, it is determined that the template type for the current block is a second value; if the top neighbouring reference samples of the current block are available, it is determined that the template type for the current block is a third value; if both the left neighbouring reference samples and the top-left neighbouring reference samples of the current block are available, it is determined that the template type for the current block is a fourth value; if both the left neighbouring reference samples and the bottom-left neighbouring reference samples of the current block are available, it is determined that the template type for the current block is a fifth value; and if both the top neighbouring reference samples and the top-right neighbouring reference samples of the current block are available, it is determined that the template type for the current block is a sixth value.

It should be noted that in the embodiment of the disclosure, each of the first value, the second value, the third value, the fourth value, the fifth value and the sixth value may be any value, which is not specifically limited in the disclosure. For example, the first value, the second value, the third value, the fourth value, the fifth value and the sixth value may be sequentially set to 1, 2, 3, 4, 5 and 6.

Exemplarily, in the embodiment of the disclosure, the template type may be represented by refTemplateType. Correspondingly, as shown in the above FIG. 3, a block filled with grids is the current block, a neighbouring region of the current block is a template T, and six template types are shown here.

Exemplarily, the six template types are shown as follows: when the top-left reference samples, the top reference samples and the left reference samples are all available, refTemplateType has a value of 1, and the template shape is shown in (a) of FIG. 3; when only the left reference samples are available, refTemplateType has a value of 2, and the template shape is shown in (b) of FIG. 3; when only the top reference samples are available, refTemplateType has a value of 3, and the template shape is shown in (c) of FIG. 3; when only the left reference samples and the top-left reference samples are available, refTemplateType has a value of 4, and the template shape is shown in (d) of FIG. 3; when only the left reference samples and the bottom-left reference samples are available, refTemplateType has a value of 5, and the template shape is shown in (e) of FIG. 3; and when only the top reference samples and the top-right reference samples are available, refTemplateType has a value of 6, and the template shape is shown in (f) in FIG. 3.

In some embodiments, a template type for the Intra TMP may also be selected in combination with availability information of the above reference samples and the indication in the bitstream. For example, by assigning a sequence number to each template type, and sequence number information of an actually used template is transmitted in the bitstream, such that determination of the template type may be achieved at the decoding side.

That is, in the embodiment of the disclosure, the template type may be determined based on the availability information of the reference samples of the current block, or the template type may be determined based on the information indicated in the bitstream, or the template type may be determined based on both the availability information of the reference samples and the information indicated in the bitstream, which is not specifically limited in the disclosure.

Further, in the embodiment of the disclosure, when determining the first template for the current block based on the template type, template reference samples of the current block may be determined first based on the template type and a template size corresponding to the template type, and then the first template of the current block may be determined based on the template reference samples.

It should be noted that in the embodiment of the disclosure, the first template of the current block may include the template reference samples of the current block. The template reference samples of the current block may be determined based on the template type for the current block and the template size corresponding to the template type.

It should be noted that in the embodiment of the disclosure, the first template of the current block may consist of reconstructed samples in one or more regions of a top region, a top-right region, a left region, a bottom-left region and a top-left region of the current block, that is, the first template of the current block may consist of the reference samples of the current block.

It should be noted that in the embodiment of the disclosure, the template size corresponding to the template type may be preset, or may be indicated by using a syntax element in the bitstream, or may be adaptively selected based on a block size or other information. For example, when acquiring a left template, a template width templateW_size may be set to 4, and when acquiring a top template, a template height templateH_size may be set to 4.

Correspondingly, in the embodiment of the disclosure, it may determine to acquire which part of reconstructed samples as the template reference samples of the current block, based on the value of the template type refTemplateType of the current block and the template size corresponding to refTemplateType, and then the corresponding first template may be determined.

Exemplarily, in the embodiment of the disclosure, when refTemplateType has a value of 1, reconstructed samples at the left side, the top-left side and the top side of the current block may be acquired; when refTemplateType has a value of 2, only reconstructed samples on left four columns of the current block are acquired; and when refTemplateType has a value of 3, only reconstructed samples on top four rows of the current coding block are acquired.

Of course, a preset value of the template size may be any integer greater than 0 and is not limited to 4, which is not specifically limited in the disclosure.

It may be understood that in the embodiment of the disclosure, the template reference samples of the current block determined from the reference samples of the current block based on the template type for the current block and the corresponding template size, may be used as the first template for the current block.

It should be noted that in the embodiment of the disclosure, a search process of the block vector may include the following parts: an initialization process, a process of determining a search region (a preset search region) for the first template in a current picture, and a process of searching in the search region to determine one or more best block vectors. Therefore, initialization operations need to be completed before performing search process.

Exemplarily, as shown in the above FIG. 5, nTbW and nTbH represent a size of the current block, templateW_size and templateH_size represent a template size, and uiPatchWidth and uiPatchHeight represent a size of a block including the current block and the template of the current block.

Correspondingly, during initialization, uiPatchWidth may be initialized to nTbW+templateW_size, and uiPatchHeight may be initialized to nTbH+templateH_size. Here templateW_size and templateH_size may be fixed constants, or may be indicated by using syntax elements in the bitstream, or may be dynamically adjusted based on the size of the CB or other information. templateW_size may be equal or unequal to templateH_size. For example, templateW_size=4, templateH_size=4; when the width of the coding block is greater than 8, templateW_size=4 is set; when the width of the coding block is less than or equal to 8, templateW_size=2 is set; when the height of the coding block is greater than 8, templateH_size=4 is set; when the height of the coding block is less than or equal to 8, templateH_size=2 is set.

Further, a cost threshold between templates that is represented by diffThreshold, is initialized. For example, when the cost function is SAD, the threshold may be as follows: diffThreshold=((1<<bitDepth)>>2)×(uiPatchHeight×uiPatchWidth−nTbH×nTbW). When a bit depth bitDepth of the picture is 10, diffThreshold represents that a distortion threshold of each sample point in the region of the template is 256.

Further, positions (ctbRsX, ctbRsY) of a CTB where the current block CB is located, are initialized.

Further, position offsets (offsetLCBY=yTbCmp−ctbRsY, offsetLCBX=xTbCmp−ctbRsX) of the current block coding block in the current CTB are initialized.

Further, iTemplateSizeH=templateH_size, iTemplateSizeW=templateW_size are initialized.

Further, iBvShift is initialized, here iBvShift is a precision of the BV. For example, the precision of the BV may be an integer sample precision, and iBvShift is 0 at this time. Alternatively, the precision of the BV may be a sub-sample precision, for example, when iBvShift is 1, it represents a ½ sample precision, and when iBvShift is 2, it represents a ¼ sample precision, which is not specifically limited here.

Further, a preset search range for the template is initialized, and the preset search range for the template may be set to a fixed size, or the search range may be dynamically adjusted based on the size of the coding block. For example, searchRangeWidth=TMP_SEARCH_RANGE_MULT_FACTOR×nTbW, searchRangeHeight=TMP_SEARCH_RANGE_MULT_FACTOR×nTbH; here value of TMP_SEARCH_RANGE_MULT_FACTOR may be a preset value, or may be indicated by using a syntax element in the bitstream, or may be adaptively adjusted based on the size of the coding block or other information, for example, it is set to 5.

It should be noted that in the embodiment of the disclosure, the preset search region is a reconstructed part in the current picture and is limited by the size of the search range. As shown in the above FIG. 6, a background region filled with dark colour is a reconstructed region, a background block filled with black is the current block, and a dashed box is a window of the search range. Therefore, in the Intra TMP technology, the preset search region is not larger than an overlapping part between the reconstructed region represented by dark background and a region marked by the dashed box.

It may be seen that the preset search region for the template of the current block may be a reconstructed part of the CTB where the current block is located, or may be other reconstructed regions in the CTB. The preset search region here is actually a set of all search points. Since the shape of this region may not be often represented by a single rectangular region, therefore during specific implementation, search may also be performed in multiple rectangular regions, and then a final best matching block and a best block vector may be obtained based on search results from different regions.

Exemplarily, with reference to the above FIG. 7, eight different partition modes of sub-regions are shown here. A background block filled with black is the current block; all of five partition modes (a), (b), (c), (d) and (f) partition the preset search region into four search sub-regions, and all of three partition modes (e), (g) and (h) partition the preset search region into three search sub-regions, here each of different filling patterns represents a respective one of search sub-regions.

In FIG. 7, (a), (b), (c) and (d) consider all available search ranges, and (e), (f), (g) and (h) do not search a directly top region and a directly left region.

Exemplarily, assuming that different search sub-regions are distinguished and represented by regionId, considering that samples of the template of the current block need to be obtained from a reconstructed region of the picture and samples of the reconstructed block corresponding to the template also need to be obtained from the reconstructed region, then it needs to further determine positions that may be searched in search sub-regions represented by different regionId, based on the position (xTbCmp, yTbCmp) of the current block, the size (nTbW, nTbH) of the current block, the size (picWidth, picHeight) of the current picture, the size (CtbSizeW, CtbSizeH) of the CTB where the current block is located, the preset search range (searchRangeWidth, searchRangeHeight) for the template and the position offset (offsetLCBY, offsetLCBX) of the current block in the current CTB, thereby determining the block vector BV. Specifically, iVerMin and iVerMax represent an absolute coordinate position that may be searched at least in a vertical direction and an absolute coordinate position that may be searched at most in the vertical direction respectively, and iHorMin and iHorMax represent an absolute coordinate position that may be searched at least in a horizontal direction and an absolute coordinate position that may be searched at most in the horizontal direction respectively. Values of iVerMin, iVerMax, iHorMin and iHorMax are different in search regions represented by different regionId.

In some embodiments, taking (f) in FIG. 7 as an example, the preset search region is partitioned into four search sub-regions, of which implementations are as follows.

When regionId is equal to 0, iVerMin, iVerMax, iHorMin and iHorMax may be calculated as follows:

$${iHorMax}_{0} = min ( ( xTbCmp + searchRangeWidth ) << iBvShift , ( ( picWidth - nTbW ) << iBvShift ) ) ; \\ {iHorMin}_{0} = max ( ( iTemplateSizeW ) << iBvShift , ( xTbCmp - searchRangeWidth ) << iBvShift ) ) ; \\ {iVerMax}_{0} = ( yTbCmp - nTbH - offsetLCBY ) << iBvShift ; \\ {iVerMin}_{0} = max ( ( iTemplateSizeH ) << iBvShift , ( yTbCmp - searchRangeHeight ) << iBvShift ) ) .$$

When regionId is equal to 1, iVerMin, iVerMax, iHorMin and iHorMax may be calculated as follows:

$${iHorMin}_{1} = max ( ( iTemplateSizeW ) << iBvShift , ( xTbCmp - searchRangeWidth ) << iBvShift ) ) ; \\ {iHorMax}_{1} = ( xTbCmp - offsetLCBX - nTbW ) << iBvShift ; \\ {iVerMin}_{1} = ( yTbCmp + 1 ) << iBvShift ; \\ {iVerMax}_{1} = max ( ( picHeight - nTbH ) << iBvShift , ( yTbCmp - offsetLCBY + CtbSizeH - nTbH ) << iBvShift ) ) .$$

When regionId is equal to 2, iVerMin, iVerMax, iHorMin and iHorMax may be calculated as follows:

$${iHorMax}_{2} = ( xTbCmp - offsetLCBX - nTbW ) << iBvShift ; \\ {iHorMin}_{2} = max ( iTemplateSizeW ) << iBvShift , ( xTbCmp - searchRangeWidth ) << iBvShift ) ; \\ {iVerMin}_{2} = max ( ( iTemplateSizeH ) << iBvShift , ( yTbCmp - nTbH - offsetLCBY ) ) << iBvShift ; \\ {iVerMax}_{2} = ( yTbCmp ) << iBvShift .$$

When regionId is equal to 3, iVerMin, iVerMax, iHorMin and iHorMax may be calculated as follows:

$${iHorMax}_{3} = max ( ( iTemplateSizeW ) << iBvShift , ( xTbCmp - offsetLCBX - mTbW + 1 ) << iBvShift ) ; \\ {iHorMax}_{3} = ( xTbCmp - nTbH ) << iBvShift ; \\ {iVerMin}_{3} = max ( ( iTemplateSizeH ) << iBvShift ) , ( yTbCmp - offsetLCBY - nTbH + 1 ) << iBvShift ) ; \\ {iVerMax}_{3} = ( yTbCmp - nTbH ) << iBvShift .$$

It may be understood that in an actual application, iHorMin_{regionId}, iHorMax_{regionId}, iVerMin_{regionId} and iVerMax_{regionId} here represent a left edge, a right edge, a top edge and a bottom edge of each of different search sub-regions respectively.

In order to intuitively describe different search sub-regions corresponding to different regionId, with reference to FIG. 8, a schematic diagram of a process of determining a preset search region is shown here. As shown in FIG. 8, R1, R2, R3 and R4 represent four different search sub-regions. It should be noted that FIG. 8 is represented by sample ranges aligned to the top-left sample of each block.

It may be understood that in some embodiments, the preset search region may also be classified into two types, one type of search region is a region (referred to as a fully reconstructed search region) where it is sure that all sampling points in the region have been reconstructed; another type of search region is a region (referred to as an undetermined reconstructed search region) where it is not sure whether all sampling points in the region have been reconstructed, which is not specifically limited in the disclosure.

In operation 202, search is performed in the preset search region based on a first parameter for the current block, to determine a block vector for the current block, here the first parameter is used for controlling a process of the search.

In the embodiment of the disclosure, after determining the preset search region based on the first template, search may be further performed in the preset search region based on the first parameter for the current block, to determine the block vector for the current block. The first parameter is used for controlling the search process.

It should be noted that in the embodiment of the disclosure, the first parameter may be used for controlling the search process. For example, it may choose to continue the search process or terminate the search process early, based on the first parameter.

Exemplarily, in the embodiment of the disclosure, the first parameter may be a matching cost threshold corresponding to a matching cost value. Correspondingly, when controlling the search process based on the first parameter, if the matching cost value and the first parameter (the matching cost threshold) meet a search termination condition, it may choose to terminate the search process early; otherwise, it may continue the search process.

It may be understood that in the embodiment of the disclosure, if the first parameter is the matching cost threshold corresponding to the matching cost value, the first parameter may be understood as a cost upper-limit threshold. Therefore, a corresponding search termination condition may be a magnitude relationship between the matching cost value and the first parameter.

Exemplarily, in the embodiment of the disclosure, if the matching cost value is less than or equal to the first parameter, it may be considered that the search termination condition is met, and then the search process may be terminated early; if the matching cost value is greater than the first parameter, it may be considered that the search termination condition is not met, and then the search process may continue.

It may be seen that in the embodiment of the disclosure, when the search is performed based on the first parameter, if a search point whose a matching cost value is less than or equal to the first parameter is obtained through the search, it may choose to terminate the search, thereby achieving the control for the search process.

That is, in the embodiment of the disclosure, since calculation of matching costs for all search points in the preset search region may greatly increase complexity, in order to balance the complexity while ensure encoding efficiency, the search process may be controlled by using a template matching cost threshold (i.e., the first parameter SADₜₕᵣₑ) corresponding to the current block, to terminate the search early.

Further, in the embodiment of the disclosure, the first parameter is used to impose a constraint on matching costs between different templates based on a preset matching criterion.

It should be noted that in the embodiment of the disclosure, the preset matching criterion includes any one of SAD, SATD, SSE, MAD, MAE, MSE, or NCC.

Exemplarily, in some embodiments, when the preset matching criterion is SSE, MSE or SATD, the first parameter used for jumping out from the search early is also set to SSEthre, MSEthre or SATDthre correspondingly.

That is, in the disclosure, the first parameter corresponds to the preset matching criterion.

Further, in the embodiment of the disclosure, the preset matching criterion may further include a first matching criterion and a second matching criterion. The first matching criterion includes any one of SAD, SATD, SSE, MAD, MAE, MSE, or NCC. The second matching criterion includes any one of a vector length of the block vector, a sum of component lengths of the block vector, or a block vector cost parameter.

It may be understood that in the embodiment of the disclosure, the first matching criterion may be understood as including a cost function related to sample differences, and the second matching criterion may be understood as including a cost function related to a size of the BV.

It should be noted that in the embodiment of the disclosure, by combining to use the first matching criterion and the second matching criterion, it needs to refer to both the cost function related to the sample differences and the cost function related to the size of the BV in the process of determining the block vector for the current block. That is, a cost function related to both the sample differences and the size of the block vector may be used.

It may be understood that in the embodiment of the disclosure, the block vector cost parameter included in the second matching criterion may be understood as a cost parameter related to the block vector.

Exemplarily, in some embodiments, the block vector cost parameter may include, but is not limited to any one of the following forms: multiplying the vector length of the block vector by a coefficient λ, or multiplying the sum of component lengths of the block vector by a coefficient λ.

It should be noted that in the embodiment of the disclosure, for the preset matching criterion including the first matching criterion and the second matching criterion, in the process of searching the block vector for the current block, a matching cost value determined for any search point may further include two parts correspondingly: a cost value corresponding to the first matching criterion and related to the sample differences, and a cost value corresponding to the second matching criterion and related to the size of the BV.

Exemplarily, in some embodiments, assuming that the cost value corresponding to the first matching criterion and related to the sample differences is represented by cost_{Dpel}, and the cost value corresponding to the second matching criterion and related to the size of the BV is represented by cost_{BV}, then a corresponding matching cost value (represent by cost) determined for a search point in the preset search region may be represented by: cost=cost_{BV}+cost_{Dpel}.

Here cost_{BV} is a quantity related to the size of the BV, such as the vector length of the BV, or the sum of component lengths of the BV, or a product of multiplying the vector length of the BV by a coefficient λ, or a product of multiplying the sum of component lengths of the BV by a coefficient λ; or, a relationship between the size of the BV and cost_{BV} is defined by using a table; or, different regions are defined, and there are different cost_{BV} in different regions, etc. For example, a diamond or square multi-layer region with a certain-value BV (such as a zero-value BV) as a center is defined, and a fixed cost_{BV} value is set for each region.

Exemplarily, in some embodiments, assuming that the cost value corresponding to the first matching criterion and related to the sample differences is represented by cost_{Dpel}, and the cost value corresponding to the second matching criterion and related to the size of the BV is represented by cost_{BV}, then a corresponding matching cost value (represented by cost) determined for a search point in the preset search region may be represented by: cost=cost_{Dpel}×costFactor_{BV}.

Here costFactor_{BV} is a quantity related to the size of the block vector, such as a product of multiplying the vector length of the BV by a coefficient λ, or a product of multiplying the sum of component lengths of the BV by a coefficient λ; or, a relationship between the size of the BV and costFactor_{BV} is defined by using a table; or, different regions are defined, and there are different costFactor_{BV} in different regions, etc. For example, a diamond or square multi-layer region with a certain-value BV (such as a zero-value BV) as a center is defined, and a fixed costFactor_{BV} value is set for each region.

Further, in the embodiment of the disclosure, an example that the preset matching criterion is SAD is taken, the first parameter SADₜₕᵣₑ corresponding to the current block may be determined first.

It should be noted that in the embodiment of the disclosure, the first parameter may be determined based on a bit depth information of a current picture and a sample parameter for the first template.

It may be understood that in the embodiment of the disclosure, when jumping out the search process early by using a first parameter SADₜₕᵣₑ, the first parameter SADₜₕᵣₑ may be determined based on the bit depth information of the current picture, here the first parameter determined based on the bit depth information of the current picture may be a predefined fixed threshold.

Exemplarily, in some embodiments, the first parameter SADₜₕᵣₑ=((1<<bitDepth)>>3)×Num_{Temp} may be defined. Here bitDepth is the bit depth of the picture, that is, the bit depth information of the current picture, and Num_{Temp} is the number of samples of the reference template, that is, the sample parameter of the first template for the current block.

It should be noted that in the embodiment of the disclosure, if prediction modes of neighbouring reconstructed blocks corresponding to the current block are the intra template matching-based prediction mode, the first parameter may be determined based on the neighbouring reconstructed blocks.

It may be understood that in the embodiment of the disclosure, if the prediction modes of the neighbouring reconstructed blocks corresponding to the current block are the intra template matching-based prediction mode, when determining the first parameter based on the neighbouring reconstructed blocks, a first threshold may be determined first based on matching cost values corresponding to block vectors for the neighbouring reconstructed blocks and sample parameters of reference templates for the neighbouring reconstructed blocks; at the same time, a second threshold may be determined based on a sample parameter for the first template and a maximum average sample value difference between the current block and the neighbouring reconstructed blocks; and finally, the first parameter may be determined based on the first threshold and the second threshold.

It should be noted that in the embodiment of the disclosure, when the first parameter is determined based on the first threshold and the second threshold, if the first threshold is less than or equal to the second threshold, the first threshold is determined as the first parameter; and if the first threshold is greater than the second threshold, the second threshold is determined as the first parameter.

It may be understood that in the embodiment of the disclosure, when jumping out the search process early by using a first parameter SADₜₕᵣₑ, the first parameter SADₜₕᵣₑ may also be determined based on a best template matching cost of neighbouring Intra TMP coding blocks of the current block, here the first parameter determined based on the matching cost values corresponding to the neighbouring reconstructed blocks of the current block whose prediction modes are the intra template matching-based prediction mode, may be an adaptive threshold.

Exemplarily, in some embodiments, assuming that the Intra TMP is selected for a top neighbouring block of the current block as a coding mode for the top neighbouring block, that is, a prediction mode of the neighbouring reconstructed block at the top side of the current block is the intra template matching-based prediction mode, a block vector (a best block vector) for the neighbouring reconstructed block is BV_{neighbor}, a matching cost value (a best matching cost) corresponding to the block vector is Diff_{neighbor}, a sample parameter (the number of samples of the reference template of the neighbouring block) of a reference template corresponding to the neighbouring reconstructed block is Num_{TempNei}, and the sample parameter (the number of samples of the reference template) of the first template for the current block is Num_{Temp}, then the first threshold determined based on the matching cost value Diff_{neighbor} corresponding to the block vector for the neighbouring reconstructed block and the sample parameter Num_{TempNei} of the reference template corresponding to the neighbouring reconstructed block may be represented by Diff_{neighbor}/Num_{TempNei}×Num_{Temp}.

Exemplarily, in some embodiments, a maximum average sample-level SAD difference between the current block and the neighbouring reconstructed blocks on a sample may be denoted as offsetDiff_{regionId}, and a maximum average sample value difference on a sample may be represented by “a”. Here “a” may be a predefined fixed factor and may be transmitted through a high-level syntax. Correspondingly, the second threshold determined based on the sample parameter Num_{Temp} corresponding to the first template and the maximum average sample value difference “a” between the current block and the neighbouring reconstructed blocks may be represented by: a×Num_{Temp}.

Exemplarily, in some embodiments, when determining the first parameter based on the first threshold and the second threshold, a smaller one of the first threshold and the second threshold may be selected as the first parameter, that is, the first parameter SADₜₕᵣₑ=min(Diff_{neighbor}/Num_{TempNei}×Num_{Temp}, a×Num_{Temp}) is defined.

That is, in the embodiment of the disclosure, assuming that the Intra TMP is selected for a top neighbouring block of a current to-be-encoded unit as a coding mode for the top neighbouring block, a best block vector for the neighbouring block is BV_{neighbor}, a best matching cost corresponding to the best block vector is Diff_{neighbor}, Num_{TempNei} is a maximum offset based on the number of samples of the reference template of the neighbouring block, then the value of SADₜₕᵣₑ should not be greater than a×Num_{Temp}, here “a” is a maximum average sample value difference on a sample. At this time, a template matching threshold of the current to-be-encoded unit is set to SADₜₕᵣₑ=min(Diff_{neighbor}/Num_{TempNei}×Num_{Temp}, a×Num_{Temp}).

Further, in the embodiment of the disclosure, when determining the first parameter, if the prediction mode of at least one of the neighbouring reconstructed blocks corresponding to the current block is the intra template matching-based prediction mode, the first threshold is determined based on at least one matching cost value for the at least one of the neighbouring reconstructed blocks, at least one sample parameter for the at least one of the neighbouring reconstructed blocks, and the sample parameter for the first template; the second threshold is determined based on the sample parameter for the first template and the maximum average sample value difference between the current block and the neighbouring reconstructed blocks; and the first parameter is determined based on the first threshold and the second threshold.

It may be understood that in the embodiment of the disclosure, if the prediction mode of at least one of the neighbouring reconstructed blocks corresponding to the current block is the intra template matching-based prediction mode, when determining the first threshold, it needs to refer to at least one matching cost value for the at least one of the neighbouring reconstructed blocks, and it also needs to refer to at least one sample parameter for the at least one of the neighbouring reconstructed blocks.

Exemplarily, in some embodiments, if at least two neighbouring positions of multiple neighbouring positions of the current block are encoded by using the Intra TMP mode, that is, there are more than two neighbouring reconstructed blocks using the Intra TMP mode for the current block, here a matching cost value SAD of each of the neighbouring positions (the neighbouring reconstructed blocks) may be denoted as SAD_{Idx} (Idx=0, 1, . . . , N, N is equal to or greater than 1), then

$${Diff}_{neighbor} = \frac{1}{N} {\sum }_{Idx = 0}^{N} {SAD}_{Idx}$$

may be defined, and then the first parameter SADₜₕᵣₑ=min(Diff_{neighbor}/Num_{TempNei}×Num_{Temp}, a×Num_{Temp}) may be defined. Here Num_{TempNei} may be determined by at least one sample parameter corresponding to at least one of the neighbouring reconstructed blocks, for example, a sum of the at least one sample parameter for the at least one of the neighbouring reconstructed blocks is determined as Num_{TempNei}; or, an average value of the at least one sample parameter for the at least one of the neighbouring reconstructed blocks is determined as Num_{TempNei}; or, a sample parameter corresponding to one of the at least one of the neighbouring reconstructed blocks is determined as Num_{TempNei}.

Further, in the embodiment of the disclosure, the preset search region includes at least one search region (that is, at least one search sub-region), and correspondingly, different first parameters may be correspondingly set for different search regions.

That is, in the disclosure, at least one first parameter for the at least one search region may be determined. The first parameters corresponding to different search regions may be the same or different.

Further, in the embodiment of the disclosure, when determining the at least one first parameter for the at least one search region, if the neighbouring reconstructed block corresponding to the current block is present in a current search region of the at least one search region, and the prediction mode of the neighbouring reconstructed block is the intra template matching-based prediction mode, the first parameter for the current search region is determined based on the neighbouring reconstructed block.

Exemplarily, in some embodiments, different thresholds SADThre_{RegionId} (RegionId=0, 1, 2, 3, . . . ) are set for different search regions, and SADThre_{regionId} is derived through using DiffNei_{regionId} of a corresponding region of a block encoded by using the neighbouring reconstructed blocks in the Intra TMP mode. The number of samples of the reference template of each of the neighbouring reconstructed blocks is Num_{TempNei}, the number of samples of the reference template of the current block is denoted as Num_{Temp}, and a maximum average sample SAD difference between the current block and the neighbouring reconstructed blocks on a sample is denoted as a(offsetDiff_{regionId}), then the first parameter SADₜₕᵣₑ=min(DiffNei_{regionId}/Num_{TempNei}×Num_{Temp}, a×Num_{Temp}) may be defined.

It may be understood that in the embodiment of the disclosure, if neighbouring reconstructed blocks corresponding to the current block are not present in one of the at least one search region, or if prediction modes of the neighbouring reconstructed blocks in this one search region are not the intra template matching-based prediction mode, a first parameter for this one search region may be determined based on a preset first parameter. For example, the first parameter for this one search region is determined based on the bit depth information of the current picture and the sample parameter for the first template.

Further, in the embodiment of the disclosure, when performing a search in the preset search region based on the first parameter for the current block, to determine the BV for the current block, search points in the preset search region may be sequentially traversed based on a preset scanning order, and a first matching cost value between a matching template corresponding to each of the search points in the preset search region and the first template is determined based on the preset matching criterion; and if the first matching cost value and the first parameter meet a search termination condition, the search in the preset search region is terminated, and a block vector corresponding to the first matching cost value is determined as the block vector for the current block.

It may be understood that in the embodiment of the disclosure, if the first parameter is the matching cost threshold corresponding to the matching cost value, the first parameter may be understood as a cost upper-limit threshold. Therefore, a corresponding search termination condition may be a magnitude relationship between the matching cost value and the first parameter.

Exemplarily, in the embodiment of the disclosure, meeting the search termination condition may include that the first matching cost value is less than or equal to the first parameter, and not meeting the search termination condition may include that the first matching cost value is greater than the first parameter.

Correspondingly, in the embodiment of the disclosure, if the first matching cost value is greater than the first parameter, a next search point in the preset search region may be continuously traversed based on the preset scanning order.

It should be noted that in the embodiment of the disclosure, for a block vector, bvXMins and bvXMaxs may represent a minimum offset and a maximum offset of the block vector in the horizontal direction respectively; bvYMins and bvYMaxs may represent a minimum offset and a maximum offset of the block vector in the vertical direction respectively.

bvXMins_{regionId}, bvXMaxs_{regionId}, bvYMins_{regionId} and bvYMaxs_{regionId} may be calculated by using the determined iVerMin_{regionId}, iVerMax_{regionId}, iHorMin_{regionId} and iHorMax_{regionId}:

$${bvXMins}_{regionId} = {iHorMin}_{regionId} - xTbCmp ; \\ {bvXMaxs}_{regionId} = {iHorMaxn}_{regionId} - xTbCmp ; \\ {bvYMins}_{regionId} = {iVerMin}_{regionId} - yTbCmp ; \\ {bvYMaxs}_{regionId} = {iVerMax}_{regionId} - yTbCmp .$$

bvXMins_{regionId}, bvXMaxs_{regionId}, bvYMins_{regionId} and bvYMaxs_{regionId} determine a range of horizontal and vertical offsets of the search point relative to the current block, that is, a range of the block vector.

It should also be noted that in the embodiment of the disclosure, through each search point (iPosHor, iPosVer) in each search region, that is, each block vector BV (which consists of a horizontal component and a vertical component: (pX, pY), where pX=iPosHor−xTbCmp, pY=iPosVer−yTbCmp, pX is between bvXMins and bvXMaxs, and pY is between bvYMins and bvYMaxs), a matching reconstructed block for the current block may be found in the reconstructed region, and neighbouring reconstructed samples of the matching reconstructed block are used as the matching template.

It may be understood that in the embodiment of the disclosure, when traversing the search points (iPosHor, iPosVer) in the current search range (the preset search region) based on the preset scanning order, for each of the search points, a matching reconstructed block for the current block may be found in the reconstructed region, and neighbouring reconstructed samples of the matching reconstructed block are used as the matching template.

Further, in the embodiment of the disclosure, a matching cost between a neighbouring template of the current block and a neighbouring template of the reconstructed block is denoted as pDiff. If pDiff for the current search point meets pDiff<=SADₜₕᵣₑ, that is, the first matching cost value between the matching template for the search point and the first template is less than or equal to the first parameter, it may be considered that the matching template obtained through the search is a reconstructed template meeting the condition, then it may choose to terminate the search, and a first matching cost pDiff for the search point is denoted as pDiff_BEST, a block vector BV for the search point is denoted as a best block vector BV_BEST (pX_BEST, pY_BEST), and a matching template corresponding to the search point is denoted as a best matching template T_BEST.

It should be noted that in the embodiment of the disclosure, when performing the search process, search strategies that may be adopted include, but are not limited to search modes based on different search step sizes, for example, a coarse search based on a first search step size and/or a fine search based on a second search step size, here the first search step size is greater than the second search step size.

Further, in the embodiment of the disclosure, the search points in the preset search region may be traversed based on the preset scanning order and a first search step size, to determine the block vector and candidate template. Alternatively, the search points in the preset search region may be traversed based on the preset scanning order and a second search step size, to determine the block vector and candidate template.

Further, in the embodiment of the disclosure, the search points in the preset search region may be traversed based on the preset scanning order and the first search step size, to determine an initial block vector and an initial matching template corresponding to the initial block vector; then a first search region is determined based on the initial matching template, here the first search region is smaller than the preset search region; and finally, search points in the first search region may be traversed based on the preset scanning order and the second search step size, to determine the block vector and the candidate template, here the first search step size is greater than the second search step size.

That is, in the embodiment of the disclosure, when searching for a best matching template in the search region, a search strategy of performing a coarse search first and then performing a fine search may be used, or only the fine search may be performed, or only the coarse search may be performed.

Exemplarily, in the embodiment of the disclosure, the coarse search may specifically include that: a best coarse matching template is determined in the search region with a first preset step size (i.e., the first search step size, such as 2, or 3, etc.), that is, a final candidate template is obtained. Alternatively, the best coarse matching template is determined in the search region by using a downsampled template (such as a downsampling factor of 2, or 3, etc.), that is, the final candidate template is obtained.

Exemplarily, in the embodiment of the disclosure, the fine search may specifically include that: a best fine matching template is determined in the search region with a second preset step size (i.e., the second search step size, such as 1, or ½, etc.), that is, a final candidate template is obtained. Alternatively, the best fine matching template is determined near the best coarse matching template after completing the coarse search, that is, the final candidate template is obtained.

Further, in the embodiment of the disclosure, the search points in the preset search region may be sequentially traversed based on the preset scanning order and a first search step size, and the first matching cost value between the matching template corresponding to each of the search points in the preset search region and the first template is determined based on the preset matching criterion. If the first matching cost value and the first parameter meet a search termination condition, the search in the preset search region is terminated, and a block vector corresponding to the first matching cost value is determined as the block vector for the current block.

It may be understood that in the embodiment of the disclosure, meeting the search termination condition may include that the first matching cost value is less than or equal to the first parameter, and not meeting the search termination condition may include that the first matching cost value is greater than the first parameter.

Exemplarily, in the embodiment of the disclosure, if the search strategy is to perform only the coarse search, the coarse search may be performed with a step size greater than 1 (such as a step size of 2 or 3) in a search range where pX is between bvXMins_{regionId} and bvXMaxs_{regionId} and pY is between bvYMins_{regionId} and bvYMaxs_{regionId} within each region. If pDiff for the current search point meets pDiff<=SADₜₕᵣₑ, that is, the first matching cost value between the matching template corresponding to the search point and the first template is less than or equal to the first parameter, it may be considered that the matching template obtained through the search is a reconstructed template meeting the condition, then it may choose to terminate the search, and a matching cost pDiff obtained through template matching is denoted as pDiff_BEST, a block vector corresponding to the search point is denoted as a best block vector BV_BEST, here each item represents a coordinate pair (pX_BEST, pY_BEST).

Further, in the embodiment of the disclosure, the search points in the preset search region may be sequentially traversed based on the preset scanning order and a second search step size, and the first matching cost value between the matching template corresponding to each of the search points in the preset search region and the first template is determined based on the preset matching criterion. If the first matching cost value and the first parameter meet a search termination condition, the search in the preset search region is terminated, and a block vector corresponding to the first matching cost value is determined as the block vector for the current block.

Exemplarily, in the embodiment of the disclosure, meeting the search termination condition may include that the first matching cost value is less than or equal to the first parameter, and not meeting the search termination condition may include that the first matching cost value is greater than the first parameter.

Exemplarily, in the embodiment of the disclosure, if the search strategy is to perform only the fine search, the fine search may be performed with a small step size (such as a step size of 1 or ½, when the step size is less than 1, sub sample interpolation is required) in a search range where pX is between bvXMins_{regionId} and bvXMaxs_{regionId} and pY is between bvYMins_{regionId} and bvYMaxs_{regionId} within each region. If pDiff for the current search point meets pDiff<=SADₜₕᵣₑ, that is, the first matching cost value between the matching template corresponding to the search point and the first template is less than or equal to the first parameter, it may be considered that the matching template obtained through the search is a reconstructed template meeting the condition, then it may choose to terminate the search, and a matching cost pDiff obtained through template matching is denoted as pDiff_BEST, a block vector BV corresponding to the search point is denoted as a best block vector BV_BEST, here each item represents a coordinate pair (pX_BEST, pY_BEST).

Further, in the embodiment of the disclosure, search may be performed in the preset search region based on the preset scanning order and a first search step size, and a second matching cost value between the matching template corresponding to each of the search points in the preset search region and the first template is determined based on the preset matching criterion. If the second matching cost value and the first parameter meet the search termination condition, the search in the preset search region is terminated, and a block vector corresponding to the second matching cost value is determined as a reference block vector for the current block. A first search region is determined based on the matching reconstructed block corresponding to the reference block vector, here the first search region is smaller than the preset search region. Search is performed in the first search region based on the preset scanning order and a second search step size, and a third matching cost value between a matching template corresponding to each of search points in the first search region and the first template is determined based on the preset matching criterion, here the first search step size is greater than the second search step size. If the third matching cost value and the first parameter meet the search termination condition, the search in the first search region is terminated, and a block vector corresponding to the third matching cost value is determined as the block vector for the current block.

It may be understood that in the embodiment of the disclosure, if the first parameter is the matching cost threshold corresponding to the matching cost value, the first parameter may be understood as a cost upper-limit threshold. Therefore, a corresponding search termination condition may be a magnitude relationship between the matching cost value and the first parameter.

Exemplarily, in the embodiment of the disclosure, meeting the search termination condition may include that the second matching cost value is less than or equal to the first parameter, and not meeting the search termination condition may include that the second matching cost value is greater than the first parameter.

Exemplarily, in the embodiment of the disclosure, meeting the search termination condition may include that the third matching cost value is less than or equal to the first parameter, and not meeting the search termination condition may include that the third matching cost value is greater than the first parameter.

That is, in the embodiment of the disclosure, meeting the search termination condition includes that: the first matching cost value is less than or equal to the first parameter; and/or, the second matching cost value is less than or equal to the first parameter; and/or, the third matching cost value is less than or equal to the first parameter.

Exemplarily, in the embodiment of the disclosure, if the search strategy is to perform the coarse search first and then the fine search is performed, the coarse search may be performed first with a step size of 2 (that is, the first search step size is 2), to record a best coarse matching template (an initial matching template) obtained through template matching, and then a best fine matching template may be determined near the best coarse matching template with a step size of 1 (that is, the second search step size is 1), that is, the final candidate template is obtained.

During a coarse search stage, the coarse search may be performed with a step size greater than 1 in a search range where pX is between bvXMins_{regionId} and bvXMaxs_{regionId} and pY is between bvYMins_{regionId} and bvYMaxs_{regionId} within each region. For example, the coarse search is performed with a step size of 2. If pDiff for the current search point meets pDiff<=SADₜₕᵣₑ during traversal in the coarse search, that is, the second matching cost value between the matching template corresponding to the search point and the first template is less than or equal to the first parameter, it may be determined that the matching template obtained through the search is a reconstructed template meeting the condition, then the search is terminated, and a best matching cost obtained through template matching is recorded as pDiff1_BEST=pDiff_{refine}, a block vector corresponding to the search point is denoted as a best block vector BV1_BEST (pX1_BEST, pY1_BEST), i.e., the reference block vector, and a matching template corresponding to the search point is the initial matching template. At this time, a search region where a best matching search point is located is bestRegionId.

Next, during a fine search stage, search may be performed near the best block vector, BV1_BEST (the reference block vector) obtained through the coarse search, that is, the search is performed in the first search region. Therefore, it needs to determine a refined search range TmpRefineRange first, that is, it needs to determine the first search region TmpRefineRange. The refined search range (the first search region TmpRefineRange) may be in a fixed size or related to the size of the current block, for example, it may be set to min(nTbW, nTbH)/2. Then, a position of a best matching reconstructed block obtained through the coarse search is calculated as a reference position of a fine search region: BestPosX=xTbCmp+pX1_BEST, BestPosY=yTbCmp+pY1_BEST.

In an embodiment, calculated values of iVerMinbest_{RegionId}, iVerMaxbest_{RegionId}, iHorMinbest_{RegionId} and iHorMaxbest_{RegionId} may be acquired first based on a value of bestRegionId, and then new search range defined by iVerMin_{refine}, iVerMax_{refine}, iHorMin_{refine} and iHorMax_{refine} is acquired based on the position of a bset matching block obtained through the coarse search. The acquisition method is as follows:

$${iHorMin}_{refine} = max ( {iHorMinbest}_{RegionId} , BestPosX - TmpRefineRange ) ; \\ {iHorMax}_{refine} = max ( {iHorMaxbest}_{RegionId} , BestPosX + TmpRefineRange ) ; \\ {iVerMin}_{refine} = max ( {iVerMinbest}_{RegionId} , BestPosY - TmpRefineRange ) ; \\ {iVerMin}_{refine} = max ( {iHorMaxbest}_{RegionId} , BestPosY + TmpRefineRange ) .$$

Then, for the adjusted block vector BV, bvXMins, bvXMaxs, bvYMins and bvYMaxs may be calculated by iVerMin_{refine}, iVerMax_{refine}, iHorMin_{refine} and iHorMax_{refine}:

$$bvXMins = {iHorMin}_{refine} - xTbCmp ; \\ bvXMaxs = {iHorMin}_{refine} - xTbCmp ; \\ bvYMins = {iVerMin}_{refine} - yTbCmp ; \\ bvYMaxs = {iVerMin}_{refine} - yTbCmp .$$

The fine search is performed within a block vector range where pX is between bvXMins_{refine} and bvXMaxs_{refine} and pY is between bvYMins_{refine} and bvYMaxs_{refine}. For example, the search is performed with a step size of 1. If pDiff_{refine} for the current search point meets pDiff<=SADₜₕᵣₑ during traversal in the fine search, that is, the third matching cost value between the matching template corresponding to the search point and the first template is less than or equal to the first parameter, it may be determined that the matching template obtained through the search is a reconstructed template meeting the condition, then the search is terminated, and a best matching cost obtained through template matching is recorded as pDiff_BEST=pDiff_{refine}, a block vector BV corresponding to the search point is denoted as a best block vector BV_BEST (pX_BEST, pY_BEST), i.e., the block vector for the current block determined finally, and a matching template corresponding to the search point is a candidate template for the current block.

After completing the above operations, the best block vector BV_BEST (pX_BEST, pY_BEST) may be obtained, here pX_BEST and pY_BEST are offsets of the best matching template relative to the template of the current coding block in the horizontal direction and in the vertical direction respectively, and are also offsets of the best matching reconstructed block relative to the current coding block in the horizontal direction and in the vertical direction respectively.

It should be noted that in the embodiment of the disclosure, one or more best block vectors BV_BEST meeting different algorithm requirements may be obtained based on results of coarse and fine search processes (here the fine search process includes searching with one or more reference points), here BV_BEST represents a coordinate pair (pX_BEST, pY_BEST).

It may be seen that in the embodiment of the disclosure, three search strategies may be included in a process for searching in the search region to determine one or more block vectors: only performing the coarse search, only performing the fine search, and performing the coarse search first and then the fine search.

Further, in the embodiment of the disclosure, for at least one search region included in the preset search region, when performing a search in the preset search region based on the first parameter for the current block, to determine the block vector for the current block, a first search order for the at least one search region may be determined first based on a positional relationship between the current block and the at least one search region; and then the at least one search region is sequentially traversed based on the first search order, and the search is performed in the at least one search region based on the first parameter, to determine the block vector for the current block.

It should be noted that in the embodiment of the disclosure, the first search order may be a near to far order of distances from the current block. This is because when performing the search in multiple search sub-regions, the block vector for the current block can be determined more quickly in a search order from near to far.

Exemplarily, in some embodiments, different search regions may also be defined in different manners. FIG. 13 is a first schematic diagram of at least one search region. As shown in FIG. 13, regions closer to the current block may be defined as R1, R2 and R3, and regions farthest away from the current block may be defined as R4, R5 and R6, or the like, and search may be performed in an order of R1, R2, R3, and then R4, R5, R6.

That is, in the embodiment of the disclosure, the search order for different search regions may be determined based on positional relationships between the search regions and the current block.

It should be noted that in the embodiment of the disclosure, sequences of R1 and R2 may be exchanged, and sequences of R4 and R5 may be exchanged.

Further, in the embodiment of the disclosure, for at least one search region included in the preset search region, when performing the search in the preset search region based on the first parameter for the current block, to determine the block vector for the current block, the at least one search region may be merged based on a positional relationship between the current block and the at least one search region, to obtain at least one merged search region; then a second search order for the at least one merged search region is determined based on a positional relationship between the current block and the at least one merged search region; and the at least one merged search region is sequentially traversed based on the second search order, and search is performed in the at least one merged search region based on the first parameter, to determine the block vector for the current block.

It should be noted that in the embodiment of the disclosure, the second search order may be a near to far order of distances from the current block. This is because when performing the search in multiple search sub-regions, the block vector for the current block can be determined more quickly in a search order from near to far.

Exemplarily, in some embodiments, as shown in FIG. 13, R1 and R3 may be merged into a region; or, R2 and R3 may be merged into a region; or, R5 and R6 may be merged into a region; or, R4 and R6 may be merged into a region, etc.

Exemplarily, in some embodiments, different search regions may also be defined in different manners. FIG. 14 is a second schematic diagram of at least one search region. As shown in FIG. 14, in case of the preset search region including an undetermined reconstructed region, the search may be performed in an order of R1, R2, R3, R7, R8, and then R4, R5, R6. Sequences of R1 and R2 may be exchanged, sequences of R7 and R8 may be exchanged, and sequences of R4 and R5 may be exchanged.

Further, in the embodiment of the disclosure, the preset scanning order includes any one of a raster scanning order, a longitudinal reverse raster scanning order, a lateral reverse raster scanning order, a full reverse raster scanning order, a diagonal scanning order, a horizontal scanning order, a vertical scanning order, or a zigzag scanning order.

That is, in the embodiment of the disclosure, when traversing the search points in the preset search region, a raster scanning order from top to bottom and from left to right may be used, or a longitudinal reverse raster scanning order from bottom to top and from left to right may be used, or a lateral reverse raster scanning order from top to bottom and from right to left may be used, or a full reverse raster scanning order from bottom to top and from right to left may be used, or a diagonal scanning order, a horizontal scanning order, a vertical scanning order, a zigzag scanning order, or other scanning orders may be used.

Further, in the embodiment of the disclosure, for at least one search region included in the preset search region, when sequentially traversing the at least one search region based on the first search order, for a current search region of the at least one search region, search points in the current search region are sequentially traversed based on the preset scanning order for the current search region, the block vector for the current block is determined.

That is, the same scanning method and the same scanning order may be used for each search region, or different scanning methods may be used for each search region, or the same scanning method with different scanning orders may be used for each search region.

It should be noted that in the embodiment of the disclosure, for a first region located at a top side of the current block among the at least one search region, the longitudinal reverse raster scanning order is determined as the preset scanning order corresponding to the first region. For a second region located at a left side of the current block among the at least one search region, the lateral reverse raster scanning order is determined as the preset scanning order corresponding to the second region. For a third region located at a top-left side of the current block among the at least one search region, the full reverse raster scanning order is determined as the preset scanning order corresponding to the third region.

Exemplarily, in some embodiments, as shown in FIG. 14, search in R1 and R5 may be performed in the longitudinal reverse raster scanning order, search in R2 and R4 may be performed in the lateral reverse raster scanning order, and search in R3 and R6 may be performed in the full reverse raster scanning order.

It should be noted that in the embodiment of the disclosure, for a fourth region located at a top side and/or a top-right side of the current block among the at least one search region, the longitudinal reverse raster scanning order is determined as the preset scanning order corresponding to the fourth region. For a fifth region located at a left side and/or a bottom-left side of the current block among the at least one search region, the lateral reverse raster scanning order is determined as the preset scanning order corresponding to the fifth region. For a third region located at a top-left side of the current block among the at least one search region, the full reverse raster scanning order is determined as the preset scanning order corresponding to the third region.

Exemplarily, in some embodiments, as shown in FIG. 14, search in R1, R5 and R7 may be performed in the longitudinal reverse raster scanning order, search in R2, R4 and R8 may be performed in the lateral reverse raster scanning order, and search in R3 and R6 may be performed in the full reverse raster scanning order.

Further, in the embodiment of the disclosure, after determining the first parameter for the current block, the first parameter may be signalled into a bitstream, to be transmitted to the decoding side. The first parameter may be transmitted through any one of following syntax information: SPS layer syntax information, PPS layer syntax information, APS layer syntax information, SH layer syntax information, or CU layer syntax information.

That is, in the embodiment of the disclosure, a threshold condition (the first parameter) for early termination may be identified in an SPS layer, a PPS layer, an APS layer or an SH layer, to control complexity at the decoding side.

Further, in the embodiment of the disclosure, when performing search in the preset search region based on the first parameter for the current block, to determine the block vector for the current block, search points in the preset search region may also be traversed based on a preset search mode, and a first matching cost value between a matching template corresponding to each of the search points in the preset search region and the first template is determined based on the preset matching criterion; and if the first matching cost value and the first parameter meet a search termination condition, the search in the preset search region is terminated, and a block vector corresponding to the first matching cost value is determined as the block vector for the current block.

It should be noted that in the embodiment of the disclosure, the preset search mode includes any one of the following modes: a cross search mode, a square search mode, a diamond search mode, or a hash search mode.

That is, in the embodiment of the disclosure, it may choose to search in each region in the preset scanning order such as a raster order, for example, search from top to bottom and from left to right, or search from bottom to top and from right to left, etc. Alternatively, it may choose to perform a fast iterative search in the preset search region based on the preset search mode, here the preset search mode includes, but is not limited to a cross search, a square search, a diamond search, etc. Alternatively, a hash search mode similar to IBC may be adopted, which is not specifically limited in the disclosure.

Further, in the embodiment of the disclosure, when performing the search based on the preset search mode, search strategies that may be adopted include, but are not limited to search modes based on different search step sizes, for example, a coarse search based on a third search step size and/or a fine search based on a fourth search step size, here the third search step size is greater than the fourth search step size.

Exemplarily, in some embodiments, It may choose to traverse the search points in the preset search region based on the preset search mode and a third search step size, and the first matching cost value between the matching template corresponding to each of the search points in the preset search region and the first template is determined based on the preset matching criterion. Alternatively, the search points in the preset search region may be traversed based on the preset search mode and a fourth search step size, and the first matching cost value between the matching template corresponding to each of the search points in the preset search region and the first template is determined based on the preset matching criterion. The third search step size is greater than the fourth search step size.

Exemplarily, in some embodiments, it may choose to perform the in the preset search region based on the preset search mode and a third search step size, and a second matching cost value between the matching template corresponding to each of the search points in the preset search region and the first template is determined based on the preset matching criterion. If the second matching cost value and the first parameter meet the search termination condition, search in the preset search region is terminated, and a block vector corresponding to the second matching cost value is determined as a reference block vector for the current block. A first search region is determined based on the matching reconstructed block corresponding to the reference block vector, here the first search region is smaller than the preset search region. Search is performed in the first search region based on the preset search mode and a fourth search step size, and finally, a third matching cost value between a matching template corresponding to each of search points in the first search region and the first template may be determined based on the preset matching criterion, here the third search step size is greater than the fourth search step size. If the third matching cost value and the first parameter meet the search termination condition, search in the first search region is terminated, and a block vector corresponding to the third matching cost value is determined as the block vector for the current block.

That is, in the embodiment of the disclosure, when searching for a best matching template in the search region based on the preset search mode, a search strategy of performing a coarse search first and then a fine search may be used, or only the fine search may be performed, or only the coarse search may be performed.

Further, in the embodiment of the disclosure, if a fast iterative search is performed based on the preset search mode, in addition to using a first parameter to control the search process, a second parameter may also be used to control the search process.

It should be noted that in the embodiment of the disclosure, the second parameter is used to impose a constraint on matching cost differences between different templates based on the preset matching criterion.

That is, in the embodiment of the disclosure, after determining the preset search region based on the first template, it may choose to perform the in the preset search region based on the first parameter and/or the second parameter corresponding to the current block, to determine the block vector for the current block.

Further, in the embodiment of the disclosure, when performing the search in the preset search region based on the second parameter corresponding to the current block, iterative search may be performed on the search points in the preset search region based on the preset search mode, and an iterative cost difference between the matching template corresponding to each of the search points in the preset search region and the first template is determined based on the preset matching criterion; and if the iterative cost difference and a second parameter meet the search termination condition, iterative search in the preset search region is terminated, and a block vector corresponding to the iterative cost difference is determined as the block vector for the current block. The second parameter is used to impose a constraint on matching cost differences between different templates based on the preset matching criterion.

It should be noted that in the embodiment of the disclosure, the second parameter may be used for controlling the search process. For example, based on the second parameter, it may choose to continue the fast iterative search process or to terminate the fast iterative search process early.

Exemplarily, in the embodiment of the disclosure, the second parameter may be an iterative cost difference threshold corresponding to the iterative cost difference. Correspondingly, when controlling the search process based on the second parameter, if the iterative cost difference and the second parameter (the iterative cost difference threshold) meet the search termination condition, it may choose to terminate the fast iterative search process early; otherwise, it may choose to continue the fast iterative search process.

It may be understood that in the embodiment of the disclosure, if the second parameter is the iterative cost difference threshold corresponding to the iterative cost difference, the second parameter may be understood as a difference upper-limit threshold. Therefore, a corresponding search termination condition may be a magnitude relationship between the iterative cost difference and the second parameter.

Exemplarily, in the embodiment of the disclosure, if the iterative cost difference is less than or equal to a second parameter, it may be considered that the search termination condition is met, and then the fast iterative search process may be terminated early; if the matching cost value is greater than the second parameter, it may be considered that the search termination condition is not met, and then the fast iterative search process may be continue.

It may be seen that in the embodiment of the disclosure, when performing the search based on the second parameter, if a search point whose iterative cost difference before and after iteration is less than or equal to the second parameter is obtained through the search, it may choose to terminate the fast iterative search, thereby achieving the control on the search process.

That is, in the embodiment of the disclosure, in addition to a threshold (i.e., the first parameter) for the magnitude of the cost itself, the cost difference before and after iteration may also be taken as the threshold (i.e., the second parameter) for termination. If the cost difference (the iterative cost difference) before and after the iteration is less than a certain threshold (the second parameter), the iteration is stopped.

It should be noted that in the embodiment of the disclosure, during the search process, the first parameter and the second parameter may be simultaneously used to control the search process, or the first parameter or the second parameter may be selected to control the search process. That is, the iterative cost difference threshold (the second parameter) and the threshold (the first parameter) for the magnitude of the cost itself may be used independently or in combination.

Further, in the embodiment of the disclosure, iterative search may be performed in a first sub-region of the preset search region based on the preset search mode, and an iterative cost difference between a matching template corresponding to each of search points in the first sub-region and the first template is determined based on a preset matching criterion. If the iterative cost difference and the second parameter meet the search termination condition, iterative search in the first sub-region is terminated, and a current matching cost value between the matching template corresponding to each of the search points in the first sub-region and the first template is determined based on a preset matching criterion. If the current matching cost value and the first parameter meet the search termination condition, search in the preset search region is terminated, and a block vector corresponding to the first matching cost value is determined as the block vector for the current block.

Further, in the embodiment of the disclosure, iterative search may be performed in a first sub-region of the preset search region based on the preset search mode, and an iterative cost difference between a matching template corresponding to each of search points in the first sub-region and the first template is determined based on the preset matching criterion. If the iterative cost difference and the second parameter meet the search termination condition, iterative search in the first sub-region is terminated, and a current matching cost value between the matching template corresponding to each of the search points in the first sub-region and the first template is determined based on the preset matching criterion. If the current matching cost value and the first parameter do not meet the search termination condition, iterative search is continued in other sub-regions of the preset search region except the first sub-region based on the preset search mode.

Exemplarily, in some embodiments, for each sub-region of the preset search region, it may choose to perform a fast iterative search in each sub-region, and when the iterative cost difference (the iterative cost difference value) is less than a certain threshold (the second parameter), iterative search in this sub-region is terminated; if the current cost (the current matching cost value) is less than the threshold (the second parameter) for termination, it may choose to terminate the entire search process in the preset search region, that is, the search process in the preset search region is terminated early; otherwise, it may choose to continue iterative search process in other sub-regions.

Further, in the embodiment of the disclosure, after determining the second parameter for the current block, the first parameter may be signalled into a bitstream, to be transmitted to the decoding side. The second parameter may be transmitted through any one of following syntax information: SPS layer syntax information, PPS layer syntax information, APS layer syntax information, SH layer syntax information, or CU layer syntax information.

That is, in the embodiment of the disclosure, a threshold condition (the second parameter) for early termination may be identified in an SPS layer, a PPS layer, an APS layer or an SH layer, to control complexity at the decoding side.

In operation 203, prediction values for the current block are determined based on the block vector for the current block.

In the embodiment of the disclosure, after searching in the preset search region based on the first parameter for the current block, to determine the block vector for the current block, prediction values for the current block may be further determined based on the block vector for the current block.

Further, in the embodiment of the disclosure, when determining the prediction values for the current block are determined based on the block vector for the current block, reference blocks for the current block may be determined first based on the block vector for the current block; and then the prediction values for the current block are determined based on the reference blocks for the current block.

Exemplarily, in the embodiment of the disclosure, determination of the reference blocks for the current block may be achieved by using simple translation copy. Specific operations are as follows. For x=0 . . . nTbW−1, y=0 . . . nTbH−1: reconstructed samples recSamples of the current picture (that is, the reference blocks for the current block) are determined by:

$${RefBlock}_{n} [ x ] [ y ] = recSamples [ x + {pX}_{n} ] [ y + {pY}_{n} ] .$$

It should be noted that in the embodiment of the disclosure, when determining the reference blocks for the current block based on the block vector for the current block, initial reconstructed blocks for the current block may be determined first based on the block vector for the current block; and then the initial reconstructed blocks are refined, to determine the reference blocks for the current block.

That is, in the embodiment of the disclosure, other manners may be used when acquiring candidate reconstructed blocks (reference blocks), for example, initial reconstructed blocks corresponding to the obtained candidate templates are refined first, and then corresponding reference blocks are determined.

It should be noted that in the embodiment of the disclosure, the prediction values determined through the block vector for the current block may be used as final prediction values, or may be further processed to obtain final prediction values for the current block.

Further, in the embodiment of the disclosure, when determining the prediction values for the current block based on the block vector for the current block, at least one reference block for the current block may be determined first based on the block vector for the current block; and then the prediction values for the current block are determined based on the at least one reference block.

It should be noted that in the embodiment of the disclosure, when determining the prediction values for the current block based on the at least one reference block, at least one prediction block corresponding to the at least one reference block may be determined first; and then weighted fusion is performed on the at least one prediction block, to determine the prediction values for the current block.

Exemplarily, in some embodiments, after determining the block vector for the current block, multiple points may be taken around the block vector, that is, multiple reference blocks may be acquired, and then weighted fusion may be performed on prediction values for the multiple points, to obtain the prediction values for the current block.

Further, in the embodiment of the disclosure, when determining the prediction values for the current block based on the block vector for the current block, first prediction values for the current block may be determined first based on the block vector for the current block; then second prediction values for the current block are determined based on a preset prediction mode, here the preset prediction mode includes a planar mode and/or a directional mode; and finally, the prediction values for the current block may be determined based on the first prediction values and the second prediction values.

Exemplarily, in some embodiments, after determining the block vector for the current block, prediction values acquired by using the block vector and prediction values obtained in other Intra modes may be weighted and fused to obtain the final prediction values. The other Intra modes may be other prediction modes except the Intra TMP, such as a planar mode or a directional mode, etc. The directional mode may be derived from TIMD, or may be obtained by locating in an Intra candidate table by using an Index transmitted in a bitstream. This method may be referred to as an Intra TMP CIP mode.

It may be understood that in the Intra TMP mode, in addition to the basic copying method for acquiring the prediction values, a method for acquiring the prediction values by performing filtering fusion using positions corresponding to multiple BVs, as well as a method for fusion prediction in combination with a normal Intra mode may be used.

Further, in the embodiment of the disclosure, after determining the prediction values for the current block based on the block vector for the current block, reconstructed values for the current block may be further determined based on the prediction values for the current block.

It should be noted that in the embodiment of the disclosure, prediction residuals for the current block may be determined first. Then reconstructed values of the current block may be further determined based on the prediction residuals and the prediction values.

In summary, through the method for encoding proposed in the above operations 201 to 203, the information (such as the depth information) of the current picture or Diff information (such as the matching cost values corresponding to the neighbouring reconstructed blocks) of neighbouring positions of the current to-be-encoded block may be utilized effectively, to derive a first parameter for template matching; and during the search, if it is determined that a matching cost value corresponding to a search point meets the first parameter, the search process for the current coding block may be terminated early, thereby reducing search complexity of the Intra TMP to a certain extent.

It should be noted that in the embodiment of the disclosure, the first parameter determined through the information (such as the depth information) of the current picture may be a predefined fixed threshold, and the first parameter determined based on the neighbouring reference blocks using the Intra TMP mode may be an adaptive threshold. Different first parameters may be set for different search sub-regions of the preset search region, to control the search process.

Exemplarily, in some embodiments, a search scheme for early termination based on an SAD matching cost of a reference template may be proposed for the Intra TMP technology. According to the search scheme, the search process may be controlled by using a matching cost threshold (a first parameter) of a reference template, and the search can be terminated early in case that the first parameter is met, such that complexity can be balanced while algorithm effectiveness is ensured.

Exemplarily, in some embodiments, a template matching cost threshold (a first parameter) may be derived by using the information of the current picture or Diff information of neighbouring positions of the current to-be-encoded block. When a threshold for the current search point does not exceed this threshold, a block vector for the search point is denoted as a best block vector BV_BEST, and the search process is terminated early.

Inputs for acquiring the Intra TMP-BV: the position (xTbCmp, yTbCmp) of the current coding block (the current block), the width nTbW of the current coding block, and the height nTbH of the current coding block. Output for acquiring the Intra TMP-BV: the BV for the current block and the prediction values predSamples[x][y] for the prediction block corresponding to the BV, here x=0 . . . nTbW−1, y=0 . . . nTbH−1. The prediction values for the prediction block may be used as final prediction values, or may be further processed to obtain final prediction values for the current block.

It may be understood that a specific process of acquiring the Intra TMP-BV proposed in the embodiment of the disclosure is divided into three steps as follows: determining the type of the current template, acquiring reconstructed samples of the current template, and determining a block vector within a predefined search range. For each acquired block vector, a set of prediction values for the current block may be obtained.

The embodiment of the disclosure provides a method for encoding, in which when a prediction mode for a current block is an intra template matching-based prediction mode, the encoder determines a first template for the current block, and determines a preset search region based on the first template; the encoder performs a search in the preset search region based on a first parameter for the current block, and determines a block vector for the current block, here the first parameter is used for controlling a process of the search; the encoder determines prediction values for the current block based on the block vector for the current block. It can be seen that in the embodiment of the disclosure, based on an Intra TMP mode, the search process can be controlled by using a predetermined first parameter such as a matching cost threshold, such that it may choose to terminate the search process early or continue the search process based on the first parameter. That is, according to the method for encoding and the method for decoding proposed in the embodiments of the disclosure, a problem of high computational complexity caused by traversing all search points in the search region can be solved by introducing the first parameter used for controlling the search process, such that the efficiency and performance of encoding and decoding can be improved.

In another embodiment of the disclosure, with reference to FIG. 16, a schematic diagram of a composition structure of an encoder according to an embodiment of the disclosure is shown. As shown in FIG. 16, the encoder 20 may include a first determination unit 211.

The first determination unit 211 is configured to: when a prediction mode for a current block is an intra template matching-based prediction mode, determine a first template for the current block, and determine a preset search region based on the first template; perform a search in the preset search region based on a first parameter for the current block, and determine a block vector for the current block, here the first parameter is used for controlling a process of the search; and determine prediction values for the current block based on the block vector for the current block.

It may be understood that in the embodiment of the disclosure, the “unit” may be a part of a circuit, a part of a processor, a part of a program or software, etc. Or, the “unit” may be a module, or may be non-modular. Furthermore, various components in the embodiment may be integrated into a processing unit, or each unit may physically exist separately, or two or more than two units may be integrated into a unit. The above integrated unit may be implemented in a form of hardware or in a form of software functional module.

If the integrated unit is implemented in a form of software functional module and is not sold or used as an independent product, the integrated unit may be stored in a computer-readable storage medium. Based on such understanding, the technical solutions in the embodiments, in essence or the part that contributes to the related art or all or part of the technical solutions may be embodied in the form of a software product. The computer software product is stored in a storage medium and includes several instructions to make a computer device (which may be a personal computer, a server, or a network device, etc.) or a processor to execute all or part of the operations of the method described in the embodiments. The foregoing storage medium includes various media capable of storing program codes, such as a U disk, a mobile hard disk, a Read Only Memory (ROM), a Random Access Memory (RAM), a magnetic disk, or an optical disk, etc.

Therefore, an embodiment of the disclosure provides a computer-readable storage medium, the computer-readable storage medium is applied to the encoder 20. The computer-readable storage medium has stored thereon a computer program that when executed by a first processor, implements the method described in any one of the foregoing embodiments.

Based on the composition of the encoder 20 and the computer-readable storage medium, with reference to FIG. 17, a schematic diagram of a specific hardware structure of the encoder 20 according to an embodiment of the disclosure is shown. As shown in FIG. 17, the encoder 20 may include a first memory 221, a first processor 222, a first communication interface 223, and a first bus system 224. The first memory 221, the first processor 222 and the first communication interface 223 are coupled together through the first bus system 224. It may be understood that the first bus system 224 is configured to achieve connection and communication between these components. The first bus system 224 includes a power bus, a control bus and a status signal bus, besides a data bus. However, for the sake of clear explanations, various buses are marked as the first bus system 224.

The first communication interface 223 is configured to receive and transmit signals during the process of transmitting and receiving information with other external network elements.

The first memory 221 is configured to store a computer program executable on the first processor.

The first processor 222 is configured to execute the computer program, to perform operations of: when a prediction mode for a current block is an intra template matching-based prediction mode, determining a first template for the current block, and determining a preset search region based on the first template; performing a search in the preset search region based on a first parameter for the current block, and determining a block vector for the current block, here the first parameter is used for controlling a process of the search; and determining prediction values for the current block based on the block vector for the current block.

It may be understood that the first memory 221 in the embodiment of the disclosure may be a volatile memory or a non-volatile memory, or may include both volatile and non-volatile memories. The non-volatile memory may be a ROM, a Programmable ROM (PROM), an Erasable PROM (EPROM), an electrically EPROM (EEPROM), or a flash memory. The volatile memory may be a RAM, which is used as an external cache. Through an exemplary rather than limiting description, many forms of RAMs are available, such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The first memory 221 of the system and method described in the disclosure is intended to include, but is not limited to these memories and any other suitable types of memories.

The first processor 222 may be an integrated circuit chip with a signal processing capability. During implementation, each operation of the above methods may be completed by an integrated logical circuit in a form of hardware in the first processor 222 or instructions in a form of software. The above first processor 222 may be a general purpose processor, a Digital Signal Processor (DSP), an Application Specific Integrated Circuit (ASIC), a Field Programmable Gate Array (FPGA) or other programmable logical devices, a discrete gate or transistor logical device, a discrete hardware component, etc. The methods, operations and logic block diagrams disclosed in the embodiments of the disclosure may be implemented or performed. The general purpose processor may be a microprocessor, or the processor may be any conventional processor, etc. Operations in the methods disclosed according to the embodiments of the disclosure may be directly embodied as being performed and completed by a hardware decoding processor, or performed and completed by a combination of hardware in the decoding processor and a software module. The software module may be located in a mature storage medium in this field such as a RAM, a flash memory, a ROM, a PROM or an EEPROM, a register, etc. The storage medium is located in the first memory 221, and the first processor 222 reads information in the first memory 221, and completes the operations in the above methods in combination with the hardware thereof.

It may be understood that these embodiments described in the disclosure may be implemented in hardware, software, firmware, middleware, microcode or a combination thereof. For implementation in hardware, the processing unit may be implemented in one or more ASICs, DSPs, DSP Devices (DSPDs), Programmable Logic Devices (PLDs), FPGAs, general purpose processors, controllers, microcontrollers, microprocessors, other electronic units configured to perform functions described in the disclosure, or combinations thereof. For implementation in software, technologies described in the disclosure may be implemented by modules (such as processes, functions, etc.) performing the functions described in the disclosure. Software codes may be stored in a memory and executed by a processor. The memory may be implemented in or out of the processor.

Optionally, as another embodiment, the first processor 222 is further configured to execute the computer program to perform the method described in any one of the foregoing embodiments.

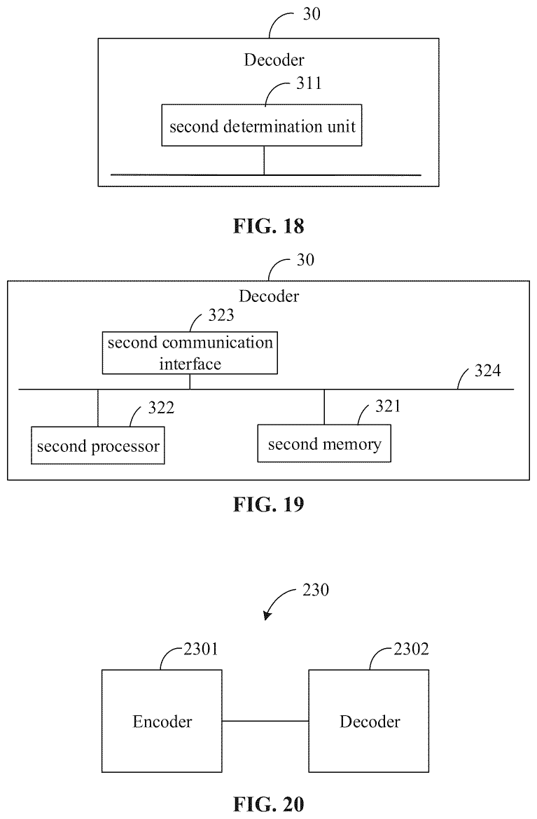

In yet another embodiment of the disclosure, with reference to FIG. 18, a schematic diagram of a composition structure of a decoder according to an embodiment of the disclosure is shown. As shown in FIG. 18, the decoder 30 may include a second determination unit 311.

The second determination unit 311 is configured to: when a prediction mode for a current block is an intra template matching-based prediction mode, determine a first template for the current block, and determine a preset search region based on the first template; perform a search in the preset search region based on a first parameter for the current block, and determine a block vector for the current block, here the first parameter is used for controlling a search process; and determine prediction values for the current block based on the block vector for the current block.

It may be understood that in the embodiment of the disclosure, the “unit” may be a part of a circuit, a part of a processor, a part of a program or software, etc. Or, the “unit” may be a module, or may be non-modular. Furthermore, various components in the embodiment may be integrated into a processing unit, or each unit may physically exist separately, or two or more than two units may be integrated into a unit. The above integrated unit may be implemented in a form of hardware or in a form of software functional module.

If the integrated unit is implemented in a form of software functional module and is not sold or used as an independent product, the integrated unit may be stored in a computer-readable storage medium. Based on such understanding, the embodiment provides a computer-readable storage medium, the computer-readable storage medium is applied to the decoder 30. The computer-readable storage medium has stored thereon a computer program that when executed by a second processor, implements the method described in any one of the foregoing embodiments.

Based on the composition of the decoder 30 and the computer-readable storage medium, with reference to FIG. 19, a schematic diagram of a specific hardware structure of the decoder 30 according to an embodiment of the disclosure is shown. As shown in FIG. 19, the decoder 30 may include a second memory 321, a second processor 322, a second communication interface 323, and a second bus system 324. The second memory 321, the second processor 322 and the second communication interface 323 are coupled together through the second bus system 324. It may be understood that the second bus system 324 is configured to achieve connection and communication between these components. The second bus system 324 includes a power bus, a control bus and a status signal bus, besides a data bus. However, for the sake of clear explanations, various buses are marked as the second bus system 324.

The second communication interface 323 is configured to receive and transmit signals during the process of transmitting and receiving information with other external network elements.

The second memory 321 is configured to store a computer program executable on the second processor.

The second processor 322 is configured to execute the computer program, to perform operations of: when a prediction mode for a current block is an intra template matching-based prediction mode, determining a first template for the current block, and determining a preset search region based on the first template; performing a search in the preset search region based on a first parameter for the current block, and determining a block vector for the current block, here the first parameter is used for controlling a search process; and determining prediction values for the current block based on the block vector for the current block.

Optionally, as another embodiment, the second processor 322 is further configured to execute the computer program to perform the method described in any one of the foregoing embodiments.

It may be understood that hardware functions of the second memory 321 are similar to those of the first memory 221, and hardware functions of the second processor 322 are similar to those of the first processor 222, which will not be described in detail here.

The embodiments provide a codec, when a prediction mode for a current block is an intra template matching-based prediction mode, the codec determines a first template for the current block, and determines a preset search region based on the first template; performs a search in the preset search region based on a first parameter for the current block, and determines a block vector for the current block, here the first parameter is used for controlling a search process; and determines prediction values for the current block based on the block vector for the current block. It can be seen that in the embodiment of the disclosure, based on an Intra TMP mode, the search process can be controlled by using a predetermined first parameter such as a matching cost threshold, such that it may choose to terminate the search process early or continue the search process based on the first parameter. That is, according to the method for encoding and the method for decoding proposed in the embodiments of the disclosure, a problem of high computational complexity caused by traversing all search points in the search region can be solved by introducing the first parameter used for controlling the search process, such that the efficiency and performance of encoding and decoding can be improved.

In yet another embodiment of the disclosure, with reference to FIG. 20, a schematic diagram of a composition structure of an encoding and decoding system according to an embodiment of the disclosure is shown. As shown in FIG. 20, the encoding and decoding system 230 may include an encoder 2301 and a decoder 2302.

In the embodiment of the disclosure, the encoder 2301 may be the encoder described in any one of the foregoing embodiments, and the decoder 2302 may be the decoder described in any one of the foregoing embodiments.

Further, an embodiment of the disclosure further provides a bitstream, the bitstream is generated by bit encoding according to to-be-encoded information, here the to-be-encoded information includes at least one of: prediction residuals for a current block, a first parameter, a second parameter, a template size, or indication information of a template type.

It should be noted that in the disclosure, terms “including”, “include” or any other variants thereof are intended to encompass a non-exclusive inclusion, such that a process, method, article or apparatus including a series of elements includes not only those elements, but also other elements which are not explicitly listed, or elements inherent to such process, method, article or apparatus. Without further limitation, an element defined by a statement “including a . . . ” does not preclude presence of additional identical elements in a process, method, article or apparatus including the element.

The above sequence numbers of the embodiments of the disclosure are only for the purpose of descriptions, and do not represent advantages and disadvantages of the embodiments.

The methods disclosed in several method embodiments provided in the disclosure may be arbitrarily combined without conflict, to obtain new method embodiments.

The features disclosed in several product embodiments provided in the disclosure may be arbitrarily combined without conflict, to obtain new product embodiments.

The features disclosed in several method or device embodiments provided in the disclosure may be arbitrarily combined without conflict, to obtain new method or device embodiments.

The above descriptions are only specific implementations of the disclosure, but the scope of protection of the disclosure is not limited thereto. Variation or replacement easily conceived by any technician skilled in the art within the technical scope disclosed in the disclosure, should fall within the scope of protection of the disclosure. Therefore, the scope of protection of the disclosure should be subject to the scope of protection of the claims.

### INDUSTRIAL APPLICABILITY

The embodiments of the disclosure provide a method for encoding, a method for decoding, a bitstream, an encoder, a decoder, and a storage medium. When a prediction mode for a current block is an intra template matching-based prediction mode, both the encoder and the decoder determine a first template for the current block, and determine a preset search region based on the first template; perform a search in the preset search region based on a first parameter for the current block, and determine a block vector for the current block, here the first parameter is used for controlling a search process; and determine prediction values for the current block based on the block vector for the current block. It can be seen that in the embodiment of the disclosure, based on an Intra TMP mode, the search process can be controlled by using a predetermined first parameter such as a matching cost threshold, such that it may choose to terminate the search process early or continue the search process based on the first parameter. That is, according to the method for encoding and the method for decoding proposed in the embodiments of the disclosure, a problem of high computational complexity caused by traversing all search points in the search region can be solved by introducing the first parameter used for controlling the search process, such that the efficiency and performance of encoding and decoding can be improved.

1. A method for decoding, applied to a decoder, comprising:
determining a first template for a current block, and determining a preset search region based on the first template;
performing a search in the preset search region based on a first parameter for the current block, and determining a block vector for the current block, wherein the first parameter is used for controlling a process of the search; and
determining prediction values for the current block based on the block vector for the current block.

2. The method of claim 1, further comprising:
determining the first parameter based on a bit depth information of a current picture and a sample parameter for the first template.

3. The method of claim 1, further comprising:
determining the first parameter based on neighbouring reconstructed blocks.

4. The method of claim 3, wherein determining the first parameter based on the neighbouring reconstructed blocks comprises:
determining a first threshold based on matching cost values corresponding to block vectors for the neighbouring reconstructed blocks and sample parameters of reference templates for the neighbouring reconstructed blocks;
determining a second threshold based on a sample parameter for the first template and a maximum average sample value difference between the current block and the neighbouring reconstructed blocks; and
determining the first parameter based on the first threshold and the second threshold.

5. The method of claim 4, wherein determining the first parameter based on the first threshold and the second threshold comprises:
if the first threshold is less than or equal to the second threshold, determining the first threshold as the first parameter; and
if the first threshold is greater than the second threshold, determining the second threshold as the first parameter.

6. The method of claim 5, further comprising:
determining the first threshold based on at least one matching cost value for at least one of the neighbouring reconstructed blocks, at least one sample parameter for the at least one of the neighbouring reconstructed blocks, and the sample parameter for the first template;
determining the second threshold based on the sample parameter for the first template and the maximum average sample value difference between the current block and the neighbouring reconstructed blocks; and
determining the first parameter based on the first threshold and the second threshold.

7. The method of claim 3, wherein the preset search region comprises at least one search region, and the method further comprises:
determining at least one first parameter for the at least one search region.

8. The method of claim 1, wherein performing the search in the preset search region based on the first parameter for the current block, and determining the block vector for the current block comprises:
sequentially traversing search points in the preset search region based on a preset scanning order, and determining a first matching cost value between a matching template corresponding to each of the search points in the preset search region and the first template based on the preset matching criterion; and
if the first matching cost value and the first parameter meet a search termination condition, terminating the search in the preset search region, and determining a block vector corresponding to the first matching cost value as the block vector for the current block.

9. The method of claim 8, further comprising:
sequentially traversing the search points in the preset search region based on the preset scanning order and a first search step size, and determining the first matching cost value between the matching template corresponding to each of the search points in the preset search region and the first template based on the preset matching criterion; or
sequentially traversing the search points in the preset search region based on the preset scanning order and a second search step size, and determining the first matching cost value between the matching template corresponding to each of the search points in the preset search region and the first template based on the preset matching criterion, wherein the first search step size is greater than the second search step size.

10. The method of claim 8, further comprising:
performing the search in the preset search region based on the preset scanning order and a first search step size, and determining a second matching cost value between the matching template corresponding to each of the search points in the preset search region and the first template based on the preset matching criterion;
if the second matching cost value and the first parameter meet the search termination condition, terminating the search in the preset search region, and determining a block vector corresponding to the second matching cost value as a reference block vector for the current block;
determining a first search region based on matching reconstructed blocks corresponding to the reference block vector, wherein the first search region is smaller than the preset search region;
performing a search in the first search region based on the preset scanning order and a second search step size, and determining a third matching cost value between a matching template corresponding to each of search points in the first search region and the first template based on the preset matching criterion, wherein the first search step size is greater than the second search step size; and
if the third matching cost value and the first parameter meet the search termination condition, terminating the search in the first search region, and determining a block vector corresponding to the third matching cost value as the block vector for the current block.

11. The method of claim 1, wherein the preset search region comprises at least one search region, and performing the search in the preset search region based on the first parameter for the current block, and determining the block vector for the current block comprises:
determining a first search order for the at least one search region, based on a positional relationship between the current block and the at least one search region; and
sequentially traversing the at least one search region based on the first search order, performing a search in the at least one search region based on the first parameter, and determining the block vector for the current block.

12. The method of claim 1, further comprising:
decoding a bitstream, and determine the first parameter;
wherein the first parameter is transmitted through any one of following syntax information: sequence parameter set (SPS) layer syntax information, picture parameter set (PPS) layer syntax information, adaptation parameter set (APS) layer syntax information, slice header (SH) layer syntax information, or coding unit (CU) layer syntax information.

13. The method of claim 1, wherein determining the prediction values for the current block based on the block vector for the current block comprises:
determining reference blocks for the current block based on the block vector for the current block; and
determining the prediction values for the current block based on the reference blocks for the current block.

14. The method of claim 13, wherein determining the reference blocks for the current block based on the block vector for the current block comprises:
determining initial reconstructed blocks for the current block based on the block vector for the current block; and
refining the initial reconstructed blocks, and determining the reference blocks for the current block.

15. The method of claim 1, wherein determining the prediction values for the current block based on the block vector for the current block comprises:
determining at least one reference block for the current block based on the block vector for the current block; and
determining the prediction values for the current block based on the at least one reference block, comprising:
determining at least one prediction block based on the at least one reference block; and
performing weighted fusion on the at least one prediction block, and determining the prediction values for the current block.

16. The method of claim 1, wherein determining the first template for the current block comprises:
determining a template type for the current block, and determining the first template for the current block based on the template type;
wherein determining the template type for the current block comprises:
determining the template type for the current block based on reference samples of the current block; or
determining the template type for the current block based on indication information in a bitstream; or
determining the template type for the current block based on a size of the current block,
wherein the reference samples of the current block comprise at least one of: left neighbouring reference samples of the current block, top neighbouring reference samples of the current block, top-left neighbouring reference samples of the current block, bottom-left neighbouring reference samples of the current block, or top-right neighbouring reference samples of the current block.

17. A method for encoding, applied to an encoder, comprising:
determining a first template for a current block, and determining a preset search region based on the first template;
performing a search in the preset search region based on a first parameter for the current block, and determining a block vector for the current block, wherein the first parameter is used for controlling a process of the search; and
determining prediction values for the current block based on the block vector for the current block.

18. The method of claim 17, further comprising:
determining the first parameter based on a bit depth information of a current picture and a sample parameter for the first template.

19. The method of claim 17, further comprising:
determining the first parameter based on neighbouring reconstructed blocks.

20. A non-transitory computer-readable storage medium, having stored thereon a computer program and a bitstream, wherein the computer program, when executed by a first processor, enables the first processor to perform the steps of the encoding method of claim 17 to generate the bitstream.
